(19) United States
(12) Patent Application Publication
(10) Pub. No.: US 2023/0235216 A1
(43) Pub. Date: Jul. 27, 2023

(54) ENGINEERED SELF-HEALING HYDRAULIC-CEMENT CONCRETE BY BIOMIMICRY

(71) Applicants: Feipeng Liu, Spring, TX (US); YUNING LAI, Spring, TX (US)

(72) Inventors: Feipeng Liu, Spring, TX (US); YUNING LAI, Spring, TX (US)

(21) Appl. No.: 18/120,998

(22) Filed: Mar. 13, 2023

Related U.S. Application Data
(63) Continuation-in-part of application No. 17/434,968, filed on Jan. 1, 0001.
Application No. 17/434,968 is a continuation-in-part of application No. 17/492,565, filed on Oct. 2, 2021.
Application No. 17/492,565 is a continuation of application No. 17/190,533, filed on Mar. 30, 2021.
Application No. 17/190,533 is a continuation of application No. 16/600,278, filed on Oct. 11, 2019.
(60) Provisional application No. 63/320,623, filed on Mar. 16, 2022.

(30) Foreign Application Priority Data
Feb. 25, 2022 (WO) PCT/US2022/178816

(51) Int. Cl. C04B 24/14; C04B 24/32; C04B 7/19; C04B 28/04; C04B 14/06

(52) U.S. Cl. CPC C04B 24/14; C04B 24/32; C04B 7/19; C04B 28/04; C04B 14/06; C04B 2201/50; C04B 2103/40

(57) ABSTRACT

Bioinspired chemical additives, coating, and chemical solution useful for enhancing the strength of self-healing hydraulic-cement concrete, comprising of micro/nano/textured dual phobic dot domains, hydrogel polymer, water, mineral oil, and surfactants assembled into micelle emulsion, mixed with cement, water, sand, and aggregates by weight percentage at a mix ratio of from 0.00001/99.9999 to 10.0/90, of which the ratio of water to cement from 0.10 to 0.80 (W/C), the volume fraction of cement for total volume of concrete from 5 to 50%, sand 40% to 90%, and aggregate 40% to 90%, a replacement of cement with cementitious materials from 0.01% to 75%, having an early age of compressive strength over more than 4000 (PSI) within 24 hour, ultimate compressive strength >7500 (PSI) after exposed over one year, gaining a self-healing efficiency over 80(%), contributed to dispersive, hydrogen, ionic chelating interactions, and activated with self-assembling thiol/disulfide plant-based protein fibril's crosslinking bonds.

### CROSS REFERENCE TO RELATED APPLICATION

This application is a continuation of previous U.S. provincial application of 63/320,623 filed on Mar. 16, 2022, which is hereby incorporated by reference in its entity.

### REFERENCE AND LITERATURE CITED

Aizenberg, J., P. Kim, G. K. Paink, 2017, U.S. 2017/0088472, Robust cementitious materials with mobile liquid-infused barrier layer.
Almabrok, M. H., R. G. McLaughlin, K. Vessalas, P. Thomas, 2019, Effect of oil contaminated aggregates on cement hydration. American Journal of Engineering Research. 8(5): pp 81-91.
Adachi, M., H. Chunying, and S. Utsumi, 2004, Effects of designed sulfhydryl groups and disulfide bonds into soybean proglycinin on its structural stability and heat-induced gelation, J. Agric. Food Chem., 52, 18, 5717-5723.
Berke, N. S., S. G. Eugene, R. J. Elliot, U.S. Pat. No. 8,784,558, Admixtures for shrink crack reduction of Portland cement-based mortars and concretes.
Biswas M., S. Majumdai, T. Chowdhury, B. Chattopadhyay, 2010, Bioremediate a unique protein from a novel bacterium BHH1, ushering a new hope in concrete technology. Enzyme and Microbial Technology, 46 (381-587)
Boesel, F. L., H. S. Azevedo, and R. L. Reis, 2006, Incorporation of a-amylase enzyme and bio-active fillers into hydrophilic partially degradable, and bioactive cements (HDBCs) as a new approach to tailor simultaneous) their degradation and bioactive behavior, Biomacromolecules, 7, pp: 2600-2609.
Berger, O. C., Battistiella, Y. Chen, J. Oktawiec, Z., E. Swicka, D. T. Ercek, M. Wang, and. C. Gianneschi, 2022, Mussel adhesive-inspired proteomimetic polymer, J. Am. Chem. Soc., 144, 10, 4383-4392.
Chen, J., H. Park, and K. Park, 1999, Synthesis of super porous hydrogels: hydrogels with fast swelling and superabsorbent properties.
Dang, J., J. Zhao, and Z. Du, 2017, Effects of superabsorbent polymer on the properties of concrete, Polymers, 9, https://www.mdp/9672/Journal/polymers.
Davies, R., O. Teall, M. Pilegis, A. Kanelapaulas, T. Sharma, A. Jefferson, D. Gardner, A. A. Tabbaa, K. Paine, and R. Lark, 2019, Large scale applications of self-healing concrete: Design, Construction, and Testing, Frontiers in Materials, www.frontiersnt.org
Danish, A., M. A. Mosaberpanah, M. U. Salim, 2020, Past and present techniques of self-healing in cementitious materials: A critical review on efficiency of implemented treatments, J. of Materials Research and Technology, 9(3), 6895-6899.
Gardner D., A. Jefferson, A. Hoffman, R. Lark, 2014, Simulation of the capillary flow of an automatic holding agent in discrete cracks in cementitious materials. Cement and Concrete Research, 59(35-44).
Henkel, J., M. A. Woodruff, D. R. Epari, R. Steck, V. Glatt, L. C., Dickinson, P. F. M. Choong, N. A. Schuetz, D. W. Hutmacher, 2013, A Review: Bone Regeneration based on tissue engineering conceptions—A 21^{st} Century Perspective. Bone Research, 3: 216-248.
Hirschler, B., 2007, Plant goo waves insect's goodbye, ABC Sciences, News in Science, (https://www.abc.net.au/science/articles/2007/11212097145.htm),
Hu, Y. W., Liu, Q. Zhang, X. Hu, X. Hu, 2022, Investigation of cement prepared with micro-capsulated microorganisms, https://doi.rog/10.1021/acsomega.1c05971.
Junkers, H. M., 2013, U.S. Pat. No. 8,460,458 B2, granted on Jun. 11, 2013.
Jonkers, H. M., A. Thijssen, G. Muyzer, O. Copuroglu, E. Schlangen, 2010, Application of bacteria as self-healing agent for the development of sustainable concrete, Ecological Engineering, 36: 230-235.
Jordan, G. K., 2022, Self-healing concrete substitute sucks carbon out of air.
Construction Dive, https://constructiondive.com/news/self-healing-concete-ecm-enzymatic-substitute-sucks-carbon-out-of-air/620368.
Jonkers, H. M. and R. Maria, U.S. Pat. No. 10,093,579, Process for producing cementitious material, granted on Oct. 9, 2018.
Kamali, M. and Ali Ghahremaninezhad, 2018. Effect of biomolecules on the nanostructure and nanomechanical property of calcium silicate hydrate, Scientific Reports. Published online 22, June.
Karmada, Ayaka, M. Rodriguez-Garcia, F. S. Ruggeri, Y. Shen, A., L. & T. P. J. Knowles, 2021, Controlled self-assembly of plant proteins into high-performance multifunctional nanostructured films. Nature Communications, 12(3529), pp: 1-9.
Kyoshi, M. et al, U.S. Patent Application 2002/0055558, filed on May 9, 2002, Permeable waterproofing agent, waterproofing material, concrete or mortar composition, and method for preventing water leaks.
Khattab, I. M. A., H. Shekha, M. A. Abdi, 2019, Study on self-healing concrete types-A review, Sustainable Structure and Materials, vol. 2, NO. 1: 76-87.
Lan, Q., L. Li, H. Dong, D. Wu, H. Chen, D. Lin, W. Qing W. Yang, T. Vasathan, and Q. Zhang, 2019, Effect of Soybean soluble polysaccharide on the formation of glucono-δ-Lactone-induced soybean protein isolate gel. Polymers, 11(1997) pp: 1-15.
Li, C. V, and E. H. Yang, 2007, Self-healing in Concrete, in Self-healing Materials: An alternative approach to 20 centuries of material science, Spring Series in Materials Science, 100 edited by Irisybrand Van Der Zwaag.
Li, W., J. Wu., W. J., H. Y., Zheng, Y, N Zhao, Z. Y. Wei, 2013, Self-healing efficiency of cementitious materials containing microcapsules filled with healing adhesive: mechanical restoration and healing process monitored by water absorption. http:/www/plosone.org, November, vol 8, e81616.
Lee, H., N. F. Scherer, and P. B. Messersmith, 2006, Single molecule mechanics of mussel adhesion, PNAS vol. 193, 12999-13009.
Mdsalih, N. U. Hashim, N. Nafarizal, C. F. Soon, M. Sandan, 2012, Surface tension analysis of cost-effective paraffin wax and water flow simulation for microfluidic device. Advanced Materials Research, ISSN 1662-8985, Vol. 832, pp 773-777. Online 2013-11-21
Moehle, J., 2019, Introducing ACI 318-19: Building code requirements for structural concrete.
Ma, H., E. Herbert, M. Ohno, V. C. Li, 2019, Scale-linking model of self-healing and stiffness recovery in engineered cementitious composites (ECC). Cement and Concrete Composites. 95:1-9.
Ma W. B. Qi, R. Sami, L. Jiang, Y. Li, and h. Wang, 2018, Conformational and functional properties of soybean proteins produced by extrusion-hydrolysis approach, International J. of Analytical Chemistry, article ID: 9142508, 1-11.
Ou, K., B. Xue, Y. Lao, Y. Wutthimitikomkit, R. Tian, A. Zow, L. Yang, W. Wang, Y. Cao, J. Li, 2020, Structure and sequence features of mussel adhesive protein lead to its salt-tolerant adhesion ability, Sci. Adv. 9(25):1-11.
Poole, L. J., K. A. Riding, K. J. Folliard, M. C. G. Juenger, and A. K. Schindler, 2007, Methods for calculating activation energy for Portland cement, ACI Materials Journal/January-February 303-310.
Rodriguez V. J. F., N. E. Villareal, L. H. Veraslegui, A. M. A. Tovar, J. F. Lopez-Perrales, J. E. Contrexas De., Leon, C. G. Rodriguez. D. F. Gonzalez, L. F. Verdeja, L. V. Garcia-Quilhomez, and E. A. R. Castellanon. 2020, Effect of mineral aggregates and chemical admixtures as internal curing agents on the mechanical properties and durability of high-performance concrete. Materials, 23(2090).
Rosewitz, J. A., S. Wang, S. F. Scarlata, N. Rahbar, 2021, An enzymatic self-healing cementitious material. Applied Materials Today, 23 (101015).
Shim, Y., G. Hong and S. Choi, 2018, Autogenous healing of early-age cementitious materials incorporating superabsorbent polymers exposed to wet/dry cycles. Materials, 11: 2476, doi:10,3390/mal11122476.
Shingh, R. N. and A. G. Pathan, 1988, Fracture toughness of some British rocks by diametral loading of discs, vol. 6, pp: 179-190.
Shaheen, N., R. A. Khushnood, and S. U. Din, 2018, Bio immobilized limestone powder for autonomous healing of cementitious systems: A feasibility study, Advances in Materials Science and Engineering, Vol: 2018 (https://doi.org/10.1150/2018/7049121).
Shimada, K. J. C. Chefiel, 1988, Determination of sulfhydryl groups and disulfide bonds in heat-induced gels of soy protein isolate, J. Agric. Food Chem., 36, 1, 147-153.
Saurin, A. T., H. Neubert, J. P. Brennan, P. Eaton, 2004, Widespread sulfenic acid formation in tissues in response to hydrogen peroxide, PNAS December 28, 17982-17987.
https://en.wik.pedia.org/wiki/carnaubia_wax.
Tae-H. & T. Kishn, 2010, Cementitious composites incorporating various mineral admixtures. J. of Advanced Concrete Technology, Vol. 8(2), 171-186.
Tang, C. H. and C. S. Wang, 2010, Formation and characterization of amyloid-like fibrils from soy β-conglycinin and glycinin. J. Agric Food Chem., 58:11058-11066.
Trivedi, M. V., J. S. Laurence, T. J. Siehaan, 2009, The role of thiols and disulfides in protein chemical and physical stability, Current Protein Pept. Sci. 10(6):614-625.
Wang, X., S. Cheng, and J. C. C. Chan, 2007, Propylsulfonic acid-functionalized mesoporous silica synthesized by in situ oxidation of thiol groups under template-free condition, J. Phys. Chem. 111, 2156-2164.
Wu, Q., T. Becherer, S. Angioletti-Uberti, J. Dzubiella, C. Wischke, A. T. Neffe, A. Lendlein, M. Ballauff, R., 2014, Huang, Protein interactions with polymer coatings and biomaterials. Angew. Chem. Int. Ed, 8004-8091.
Wiktor, V., H. M. Jonkers, 2011, Quantification of crack-healing in novel bacteria-based self-healing concrete. Cement and Concrete Composites 33(763-776).
Wu, C., Y. Hua, Y. Cha, X. K. Wang, and C. Zhang, 2016, Effect of 7s/11s ratio on the network structure of heat-induced soy protein gels: A study of probe release. RSC Advances Issue 104, 10 pp: 1981-1987.
Wu, S., G. Liu. Q. Liu, P. Liu, J. Yang, 2020, Sustainable High-ductility concrete with rapid self-healing characteristic by adding Magnesium oxide and superabsorbent polymer. Advances in Materials Science and Engineering, Volume 2020, ID5395602, https://doi.org/10.1155/2020/5395602.
Yang, Y., M. D. Lepech, E. H. Yang, V. C. Li, 2009, Autogenous healing of engineered cementitious composites under wet-dry cycles. Cement and Concrete Research 39: 382-390.
Yang, F., B. Zhang, Q. Ma, 2010, Study of sticky rice-lime mortar technology for the restoration of Historical masonry construction. Accounts of Chemical Research, ACS. 10.1021/ar9001944.
Yang, L., D. Gao, Y. Zhang, J. Tang, and Y. Li, 2019, Relationship between sorptivity for water absorption of cement-based materials: Theory analysis and experiment. Royal Soc. Open Sci. 6: 190112.
Yang, S., F. Aldakheel, A. Cagginno, P. Wrigghers, and E. Koenders, 2020, A review on cementitious self-healing and the potential of phase field methods for modeling crack-closing and fracture recovery. Materials, 13, 5265.
Yue, Y., Yin, and Z. Zhong, 2006, shape effects in the Brazilian tensile strength test and a 3D FEM correction. International J. of Rock Mechanisms and Mining Sciences, vol. 43 (4), pp 623-627.
Yaphary, L. Y., R. H. W. Lam, D. Lau, 2020, Reduction in cement content of normal strength concrete with used engine oil (UEO) as chemical admixture. Construction and Building Materials. 261(119967).
Zena, K., A., 2015, Effect of kerosene and gas oil products on different types of concrete. International Journal of Science and Research 6(12): 2319-7064.

### STATEMENT OF REGARDING FEDERAL SPONSORED

None

### INCORPORATION BY REFERENCE

None

### INCORPORATION BY REFERENCE THE NAMES OF PARTIERS OF JOINTED RESEARCH AGREEMENT

None

### DISCLOSURE

None

### FIELD OF INVENTION

The invention is related with a chemical additive and technical solution useful for enhancing the early age strength and the durability of concrete materials in infrastructural industry and long-life span service of hydraulic-cement concrete products, inspired by biological bone fracture recovery and biomineralization, the disclosed status of art practice demonstrates that the chemical additives and solution, functionalized as hydro-dual phobic domains, can effectively fill the micro-cracking fracture with reduced brittleness and enhanced viscoelasticity and viscous plasticity of the concrete materials. A self-activated healing with adjustable polymer molecular tannable orientation is proposed as the mechanism, activated by phase transitional hydration of gel polymers, stimulated by water and mineral oil, resulting in a hydraulic-cement concrete product useful for both energy and industrial applications, more specially identified as modified biomineralized fillers for painting and coating components and 3D printing extrusion materials for investing cast, accelerated by pre and post heating treatment of mixed concrete composites.

### BACKGROUND OF THE INVENTION

Concrete is the most widely used construction material in the world, meanwhile, it is also one of the biggest contributors to global warming. The carbon dioxide (CO₂) emissions from the production of Portland cement account approximately 7(%) of global anthropogenic emissions. In general, one tonnage of clickers used in cement products produces about one tonnage of CO₂. In addition, up to 75(%) fly ashes added as replacement of cements originated from coal mining need alternatives due to the phaseout of coal mining industry. Less use of cements and replacements of fly ashes with other geo-polymeric materials are desirable in view of global carbon net zero goal of 2050. The huge damage of recent floods in European, China, and many of forest fires in California and the strong Hurricane of Ida in USA create urgent calls and demand on curbing the global warming.

In term of product performance, seeking other self-healing materials to meet concrete performance requirements is urgent. The compressive strength (CS) of concrete has been considered as the most important, listed as the 1^{st} criteria per ACI design manual, determined by structural engineer, attained, and verified by properly evaluated test results as specified in practices. A mean of minimum 2500 (PSI) compressive strength is required for structural applications. A summary of the general requirements per ACI 318 building code of chapter 1 is listed in Table 1. Concrete tends to have poor tensile strength and brittle with wide cracking failure in the product. An enhancement in tensile is needed.

TABLE 1
Specification of Concrete Products Performance Per ACI 318
Building Code

| | | Compressive |
|---|---|---|
| | | Strength |
| Items | Description of Concrete Application | (PSI) |
| 1 | Concrete filling | Below |
| | | 2000 |
| | Basement and foundation, walk, and slabs | |
| 2 | Patios, steps, and stairs | 2500 to 3500 |
| 3 | Driveways, garage, and industrial floor slabs | 3000 to 4000 |
| | Reinforced concrete beam, slubs, columns | |
| 4 | Walls | 3000 to 7000 |
| 5 | Precast and prestressed concrete | 4000 to 7000 |
| 6 | High-rise building (column) | 10,000 to 15,000 |

Inspired by nature, the previous research has been centered around a self-healing concept of concrete products that can mitigate the occurrence of cracking failure of concretes. Reviews for developing effective self-healing products include mixing superabsorbent polymers with Portland cement, incorporating tine amounts of bio-enzymatic materials for in situ curing of cementitious materials, and fabricating special scaffolds of reinforced steel bars or polymeric fibers to reduce the stress concentration of concrete, addition of nanomaterials to enhance the concrete product's performance (Junkers, et al. 2010, 2013, 2018, Davies, et al. 2018, Khattab, et al. 2019, Danish, et al. 2020, Rosewitz, et al. 2021).

Super absorbent polymer (SAP) material has been used as curing additives in concrete. It can supply plenty of water as a water reservoir by swelling and release water slowly in dry air as an autogenous self-healing agent for enhancing the performance of engineered cement composites (ECC) products (Li, et al. 2007). It is also effective in enhancing the self-healing performance of cementitious materials by supplying water to cracked concrete in wet/drying cycling environmental conditions (Chen, 1999, Kyoshi, et al. 2002, Shim, et al., 2018, Ma, et al. 2019). A high efficiency of self-healing was claimed by utilizing a mobile infused hydrophobic layer with hydrophobic films (Aizenberg, et al. 2017). The success of SAP is limited due to the softness of hydrogel polymers (Dang, J., et al. 2017). Inorganic metal oxide materials such as magnesium oxide and superabsorbent hydrogel polymers have been used for developing sustainable high-ductility concrete with rapid self-healing (Wu, et al. 2020).

Bacterium and enzymatic self-healing agents for autogenous curing and cement cracking repairment have been studied extensively. A novel hot spring bacteria strain selected can increase the compressive strength of cement materials more than 23(%). For examples, U.S. Pat. No. 10,093,579 disclosed a process for making self-healing concrete products by which a bacterium and biodegradable fibers were blended to achieve the desirable objectives. More recently, the enzymatic proteins were claimed to catalyze chemical reactions at an extremely rapid rate, by which, the carbonic hydrase enzyme (CA) catalyzes the reaction between water, calcium ions (Ca²⁺) and CO₂ to produce calcium carbonate (CacO₃) (Rosawitz, et al. 2021). The pre-cut cracks in concrete as width as 400 (micron) can be healed, however, it has a high price tag of 33(%) higher than control products (Joran, G. K. 2022). Simulation of the capillary flow of an automatic healing agent in discrete cracks in the cementitious materials demonstrates that the stick-slip parameter decreases from 0.12 for the 7 days old specimen to 0.01 for the 28-day specimens due to the changes of mortar microstructure via the continuous hydration. As hydrogel is dried up, the adhesive adhesion becomes strong (Gardner D, et al. 2014). Cements prepared with microencapsulated micro-organisms have been reported for underground cement applications (Hu, et al. 2022).

In addition, hollow and brittle glass tubes filled with superglue have been explored as a healing agent released into the cracks of the cementitious matrix once cementitious matrix reached over certain loads and glass tubes were broken. UV-fluorescent curable epoxy resin was also used to study the biomimetic. Other healing agents such as dicyclopentadiene, polyether-amine, NaSiO₃ gel, etc., have been encapsulated into micro-spherical shells with urea-formaldehyde, melamine formaldehyde, isocyanate, and poly(methylene methacrylate) (PMMA), however, some of these healing agents might be not environmentally friendly (Li, 2007).

Different from the above self-healing system, the nature has provided us much delicate self-healing mechanisms. Composed of water, mineralized collagen fibril bundles, and non-collagen proteins, for example, natural bone is a bio-composite of a collagen matrix reinforced with hydroxyapatite. Collagen transfers the load in tissues and provides a highly biocompatible environments for cell. More recently, in situ crystallization of hydroxyapatite on carboxymethyl cellulose without proteins is claimed to play a critical role in controlling the formation of bio-mineral hybrid crystalline structure with cationic bonds.

Another example of bio-mass binding with mineral surface is the Mussel protein attachment on the rock surface. A gene sequence and structural analysis indicated that the protein, mainly consisted of tyrosine residues, is encoded to be converted to 3,4-believed to dihydroxyphenyl-alanine (DOPA) near c and n terminal (Inoue, et al. 1996). Triplets of DOPA segments conjugated to each other are key for strong adhesions of mussels (Lee, et al. 2006). Also, the protein is tightly anchored to underwater surfaces characterized as tough, durable, resistant to enzymatic degradation, present an excellent salt tolerance, strong adhesives from paired conjugation of DOPA/tyrosine plus positive base pairs were confirmed (Ou, et al. 2020). Recently, proteinase inhibitors, including lysozyme and lectins, were claimed to have a critical protein for its durability that promotes the collagen helix formation. The adhesive bonds of engineered mussel protein/polymeric adhesives were claimed to enhance the immobilization of live cells for wound healing application (Berger, et al. 2022).

U.S. patent publication of 2022/0064521 disclosed chemical additives useful for enhancing the self-healing concrete, in which, plant-based soy protein isolate (SPI) was used as a multifunctional key component without adding any enzymatic materials and without a demand for post-heating the blended bio-cement and injecting CO₂ into the carbonic anhydride proteins to deliver the high early strength of bio-cement concrete. By adding less than 0.1(%) of chemical additives by solid wt. (%) into the mixed hydraulic-cement concrete, the concrete products prepared demonstrate superior early strength, potentially with the binding mechanisms: 1) C—S—H bonds, 2) dispersive & hydrophobic interactions, 3) hydrogen bonds, 4) chelating bonds of Ca²⁺ and other ions, however, the patent application did not disclose how the activated multifunctional coatings will affect the surface of coated minerals and its blend of sand, aggregates, and cement components to the concrete product performance under different environmental conditions of pre- and/or post-heating treatments, high or freezing temperature and describes in detail of how the dispersive and hydrophobic interaction are related with thiol/disulfide functional groups in the plant-based proteins.

Currently, characterizing the surface physical chemical behavior of self-healing concretes with self-healing multifunctional chemical additives has largely been negligible. Surface treatment of silica or silica sand materials have been extensively studied with silane coupling agents, however, not with soy plant based protein treatment, a common view in the industries is that a heated concrete curing system is not recommended since the strength of compressed concrete blocks is believed to be inferior to that of these cured under regular curing cycles when the mixed concrete components are required to have self-healing capabilities under the special application conditions such as hot geothermal energy, deep water oil well sealing and plugging, wrapping of oil and gas pipelines with anodic functional protections to the steel materials, 3d-printing extrusion to deliver industrial products parts with concrete types of materials. As such, there is an urgent need for determining how the sand or aggregate surface coated with the multifunctional coatings disclosed in the U.S. patent publication of 2022/0064521 will be affected under special environmental conditions such as pre- or post-treatment of the coated minerals and mixed concrete components.

### BRIED DESCRIPTION OF THE INVENTION

It is disclosed further by this invention that cysteine or/and disulfide bonds of encapsulated in the disclosed state of art technology in the USPTO Publication of 2022/0064521 were reactivated and/or involved in a re-generation and re-alignment of the unfolding/folding of the protein's amino acid's sequence in primary loci, secondary, and tertiary structure after being modified and activated in the neutral or alkaline conditions under special defined thermal conditions. Without pre-heating or acid/base treatments, these free cysteine groups or disulfide bonds are locked insides the soy protein globulins. Also, disclosed in this invention that a procedure of pre-heating surface of sands and aggregates could enhance the mixed component surface appearance with enhanced whiting of coated white sands. A post-treatment of the mixed concrete components after being molded or extruded could potentially accelerate the hydraulic curing reaction of cementitious materials with early age of enhanced concrete performance, including, but not limiting to utilizing the following components by wt. %:

a) a hydro-dual phobic domain as core layer from 0.001 to 40.0%,

b) b hydrogel polymer as suspending agent as shell from 0.001 to 35.0%,

c) mineral oil as hydrophobic solution ranged from 0.01 to 50.0%

d) surfactant/emulsifier as intermediate agent from 0.0001 to 20.00(%)

e) water from 1.0 to 99.0(%),

f) the combined weight percentage of (a)+(b)+(c)+(d)+(e) is 100(%).

In some of disclosed embodiments of hydro-dual phobic domains, the hydrophobic domains are buried on the interior of a folded globular protein. Denaturation occurs, which refers to the unfolding of the globular folded structure. That is, the tertiary structure, and frequently the secondary structure of the soy proteins is lost, at least in part, through denaturation. Free thiol/cysteine functional groups, disulfide bonds, and their interaction with other components in the chemical additives are essential for the self-healing performance of the bioinspired and biomimicking concrete. The encapsulated hydro-dual phobic domains as core layer such as soy protein isolates are likely participating the enzymatic reactions of proteins as nucleophile, also, susceptible to oxidation, converts it selves to the disulfide derivatives of cystine (-s-s-). Under the neutral or basic conditions, these proteins are assumed to experience a degradation following three mechanisms: a) direct attack on sulfur atom by hydroxyl anions; b) β-elimination; c) α-elimination. The broken disulfide bonds are recombined together with other functional amine groups, left some portions of free thiol reaction sites (Trivedi, et al. 2009, and Tang, et al. 2014). For examples, β-lactoglobulin (BLG) is a protein from cow or sheep milk. Per protein chains, it contains three free groups and one disulfide bond. The disulfide bond on cys 121 is inaccessible. In plant-based protein such as soy protein, glycinin in the 11s contains a disulfide bond, while none of disulfide bond exists in 7s components based upon the sedimentation test classification.

in the embodiment of disclosed plant-based soy protein molecules materials, all of thiol groups originated from its proteins are in a form of disulfide bonds, un-accessible except special treatments and procedures applied to modify the tertiary structure of soy proteins under intensive heating and hydraulic conditions.

In some embodiment, the manufacturing processes for preparing the polymer materials include charging the hydrophobic solvent, such as single chain and mineral oil, into a container, then, adding the chemical additives and solution into the cement as mix simultaneously, or the sand or aggregated materials coated with the chemical additives, or alternatively, the chemical additives mixed with cement materials on site directly.

In some embodiment, the formulated coatings have a static contact angle from 30 to 90 (degree); and tilted contact angle (pinning angle and depinning angle) larger than 30 (degree) as slippery and/or hydrophobic/hydrophilic dual domain coatings, measured by depositing a water droplet on the coated flatten solid surface at a total weight of from 0.1 (mg) to 500 (mg).

In some embodiment, a blend of invented chemical additives or solution with cement, water, fine sand, and aggregates can create concrete blocking products useful for both residential or/and commercial building materials. It was discovered that the products manufactured with the developed recipes have excellent early age compressive strength and high toughness for high long-term ultimate compressive strength initialized by a self-activation, driven by micro-capillary action, originated from not only the hydrated calcium-silicate-hydrate (CSH) bonds, but also hydrogen bonds from the β-sheet of soy proteins and polymeric material's phase transitions in response to the exothermic hydration of the coating material's phase transition from −25° C. to 90° C. The ratio of total weight of the coatings to the total weight of cement, fine sand, and aggregates, and water is ranged from 0.0001/99.9999 to 5.0/95.

In some embodiment, it can be applied as a regular solution with mixing action or coatings sprayed on the solid surface of sand or aggregate products to create coated sands or aggregate products. The dosage level of the coatings sprayed on the sand is ranged from 0.01% to 10.0%, preferred less than 3.0% over the total weight of cement, fine sands, and aggregates. The coated granular particles can suppress the respirable microcrystalline silica dust concentration by more than 95.0% in comparison with untreated specimens, preferred by 97.0%, 99.0%, 99.5%, 99.95%.

In some embodiment, the chemical additives can be mixed with cements to create cement paste and/or cement mortar agents in the mix as admixture in the construction field onsite directly. Mixing water can be used to first dilute the chemical additives, then, add all the leftover water right before counting the mixing time. The dosage level of mixed chemical additives' ingredient portion to the total weight of concrete materials including cement, fine sand, and supplementary cementitious materials, ranged from 0.01(%) to 15.0% by weight percentage, preferred lees than 5.0%, or 0.5%.

In some embodiment, the core materials of the coated chemical additives comprising of modified soy protein, sweet rice, or waxy amine, oxidized paraffin wax, hydrogel polymer in powder, or their blending with the isocyanate or epoxy resin, are moved from the swollen hydrogel slippery layer to the crack or fissure of concrete structure. The dosage level of these hydro dual phobic materials ranged from 0.1(%) to 40.0% of the total coating materials by weight percentage.

In some embodiment, both the hydrogel polymers and soy protein isolate or its modification with their dual phobic domains in their structure could be adjusted/tuned in their molecular orientation. The solution concentration can be in a range from 0.001% to 50%. The formulated solution can be sprayed on sand and aggregate surface or directly blended into cement matrix within a 3 to 15 (minutes) shearing mixed into.

In some embodiment, the mixed cement paste and/or mortar, and masonry mix have an excellent workability with a working time from 10 to 120 (min.). The water to cement ratio can be within a range from 0.20 to 0.80, preferred 0.44 or less, or 0.40, 0.36.

In some embodiment, reinforced fiber elements including steel whiskers, glass fibers, polyvinyl alcohol fibers, etc. can be added to mitigate the crack for enhanced self-healing besides the chemical additives used here. The ratio of fiber length to diameter can be in a range from 10 to 100. The percent volume fraction of the reinforcement element such as steel bars, and fiber glass to the total volume of sand and cement, fine sand, and aggregates can be ranged from 0.0001/99.9999 to 5.0/95 by volume fraction of the total volume of concrete members.

In some embodiment, cementitious materials, such as fly ash, micro silica, silica gel, southern clays, water glass (sodium silicate), and abrasive particles, sand or proppant materials granular particles, selected for hydraulic fracking application in a size partition of 100 mesh, 40/70, 30/50, and 20/40, or specified by contract negotiation, could be added in a range from 0.001 to 75% by weight percentage over the total weight of cements to partially replace the cement materials or added as raw sand materials to partially replace the fine sand or aggregates over the total weight of fine sand, aggregates, and plus cements.

In some embodiment, the minimum ultimate compressive strength of the tested samples per ASTM C 39 or/and test standard such as ASTM C109 (2″×2″ Block) is larger than 2500 (PSI), more preferred 4000 (PSI) measured after being molded at 28 day's setting time, especially more than 7000 (PSI) for high performance concrete structural application, the Brazilian splitting tensile strength is larger than 600 (PSI), especially larger than 1000 (PSI). The products are useful in residential and commercial market, concrete slabs for highway and as high strength concrete mix for high rising construction.

In some embodiment, the percentage recovery of the tested samples for self-healing can be more than 80(%) determined by self-healing efficiency (SHE) and measured by the Brazilian splitting tensile strength test method, more than 100(%) by water permeability test.

In some embodiment, the toughness of disclosed hydraulic-cement concrete products has a value of 9 times more than that of its virgin products, and 13 times more in the modulus of resilience, also called as the flexibility of the materials.

In some embodiment, the density of the tested samples has a value larger than 1.90 (g/cm³), specially more than 2.20, 2.40 (g/cm³), and 2.55 (g/cm³), porosity less than 0.15, more specially less than 0.07.

In some embodiment, the chemical additives have a phase transition temperature from 30° F. above and 200° F. below after being blended with other cement components and cured in an adiabatic or isothermal condition.

To have a better description of the disclosed invention. The figures and drawings are used in the following section.

### BRIEF DESCRIPTION OF FIGURES AND DRAWINGS

FIG. 1a. A proposed schematic of a self-activated healing mechanism of chemical additives and solution with cement and sand/aggregate materials: 100—Chemical solution/coating emulsion; 101—solid surface from cement, fine sand, aggregate, and cementitious materials such as fly ash, micro silica, silica gel; 102—light density solvent (mineral oil); 103—hydrated hydrogel polymer; 104—SPI core layer particles in spherical shape; 105—SPI in sheet or disk shape. The chemical additives are interacted with other components with the following processing steps: 1) breakup of emulsion after being sheared intensively with core layers exposed into air or water in the hydrated environmental condition; 2) SPI and hydrogel polymers by the self-activated non-polar solvent tailored toward an intimate contact with cement surface under different temperature and osmosis pressure; Step 3: Tight interface of chemical additives with cement elements involved in various molecular bonding mechanisms including CSH cationic bond, chelating, amination, hydrophobic and dispersive, hydrogen bonds of potential intercalation within CSH; Step 4: formation of immobilized interface with hardened concrete structure (adapted from us. patent publication of 2022/0064521)

FIG. 1b. Proposed schematic of interaction of C—S—H cationic bonds, hydrophobic & dispersive force, and hydrogen bonds in the steps of 4 shown in FIG. 1a. It is comprised of hydro-dual phobic domain of activated SPI 1b-1, including functional groups of amino acid and also attached thiol and disulfide functional groups; organic compounds, including organic compounds and polymeric materials 1b-2, mineral materials 1b-3, and solvent/water 1b-4 (further disclosure based upon previous application of Ser. No. 17/492,565).

FIG. 2. Schematics of proposed self-healing processes of concretes with disclosed chemical solution and additives: 201—solid surface of cement, sand, aggregates, or other cementitious particles; 202—coating layer; 203—crack of concrete structure; 204—self healing agent filled in the crack of concrete; 205—SPI/sweet rice core layer.

FIG. 3. A plot of both the compressive stress and strain in % as a function of registered sampling time for the tested cylindrical sample of example 3.

FIG. 4. A plot of compressive strength in the selected examples of 3, 4, 5 specimens as a function of strain for selected cylindrical testing samples.

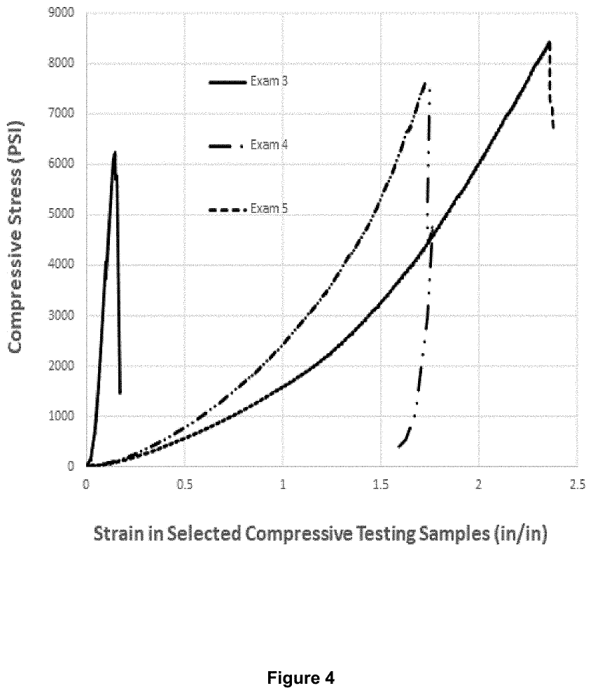

FIG. 5. Specimen geometry for a modified diametrical tensile test adapted directly from publication (Singh and Pathan 1988).

FIG. 6. The image of water seeping out of the created micro-crack of the samples originated from examples 8a and 8c after both were immersed in a water tanker for about 15 (minutes). All edges were sealed with wax except that the up-side-down surface contacted with tap water in the water tanker (referred to ASTM C 1585-04 experimental settings).

FIG. 7. Plot of water permeability of tested samples prepared from samples labeled as exam 8a, 8b, 8c, 8d, and 8e.

FIG. 8. Plot of measured water microdroplet's static contact angles and tilted contact angles placed on a solid surface of flatten glass plate after being coated with the disclosed thin coating of example 1.

FIG. 9. Plot of ultimate compressive strength (UCS) and Brazilian splitting tensile strength (BSTS) as a function of sample aging in natural log according to the selected data from Table 15.

FIG. 10. Imaging photo of water marks after the specimens were soaked in water tanker for one hour. Partial ingress of water blocked from seeping out can be clearly observed. Both specimens of 9a and 9b were soaked in water tanker for one month before taken out for repeating water soaking test.

FIG. 11. Plot of water permeability in the self-healed specimens of exam 9a and 9b as a function of square root plot of sampling time.

FIG. 12. Plot of cement curing temperature in the vacuumed coffee cups under the adiabatic condition with different chemical additives blends: example 19: notebook ID: 11102019-1(wax), exam 20:notebook ID:11102019-2(SPI/Wax/SR), Exam 21: 11102019-3(control); Exam 22:11102019-4(Rapid setting).

FIG. 13. Plots of weight percentage reduction on selected tested concrete prism bar samples from blending of examples 19, 20, 21, and 22 as a function of sampling time at an ambient temperature of 70° F.

FIG. 14. Plot of mixed concrete components of cement, sand, aggregates, multifunctional chemical additives, water mixed in a slurry as a function of sampling time under different environmental conditions in the sealed coffee cups: T-A: at 200° F. in oven for two-hour before cooling down the tested samples; T-B: at ambient room temperature; T-D: in a freezer below the freezing point of 32° F.

FIG. 15. Photo image of concrete slurry samples packed in plastic cups initially packed in the double vacuum cups after 7 days under different conditions. All these samples have been consolidated into rock solid rock products: a) Sample A—under 200° F. for two-hour in the oven before cooling down; b) Sample B—at ambient temperature; c) Sample C in freezer for over 7 days before taken out of freezer.

### DETAILED DESCRIPTION OF THE INVENTION

Carbonization and C—S—H Bonding: Cracking often occurs in concrete structure. As the tensile strains created from restrained thermal contraction or temperature differential surpass the tensile strain capacity of concrete structures, cracking will initiate. When concrete is still soft in the first several hours of curing, autogenous shrinkage is limited to chemical changes driven by cement hydration, but, in later stage after the first 24 hours, there are high risks of autogenous shrinkage. High water evaporation rate and subsequent high magnitudes of shrinkage are the most common cause of cracking. Self-healing such as autogenous self-healing has been considered as one promising solution to address the cracking issue of concrete. The main cause of autogenous self-healing is attributed to the formation of calcium carbonate, expressed by the following two simple chemical reactions:

CO₂+H₂→HCO₃⁻+H⁺ (1)

Cₐ²⁺+HCO₃⁻→CₐCO₃↓+H⁺ (2)

As shown in equations (1), the carbon dioxide is absorbed from environment of air or from a dissolved chemical reactant, an anionic hydroxide bicarbonate ion is generated in the equation right side. The hydroxide bicarbonate ion can further react with the Calcium cations, resulting in the precipitation of calcium carbonate recrystallization (equation 2). Observation on old cement concrete construction suggests that some cracks are self-evidence of these white crystalline materials attributed to the formation of calcium oxide crystallinity.

In addition to the above CaCO₃ cationic bonds, silica can also have a cationic covalent bond connected with calcium defined as CSH bonds occurring at calcium oxide and silicon oxide interface widely distributed in the earth. The CS is attached with hydroxyl group on its top surface of the interface that creates the hydrated bonds with —OH in CSH bonds.

Similarly, bone, as a highly specialized organic inorganic architecture, which can be classified as micro- and nano-composite tissue in its mineralized matrix, consists of an organic phase (mainly comprising of collagen, 35% dry weight, reinforced with calcium phosphate in a liquid crystalline structure), responsible for its rigidity, viscoelasticity, and toughness, 65% dry wt. of carbonated hydroxyapatite for structural reinforcement stiffness and mineral homogeneity. Other non-collagenous proteins that form a microenvironment stimulate cellular functions. In comparison with other human tissue, bone tissue is capable of true generation, i.e., healing without the formation of fibrotic scare tissue (Henkel, J., 2013). In our disclosed additives, the applicants believe that the SPI and its modification can be considered as a plant-based collagen (proteins) that can be swollen and intercalated into cement matrix structure through physically intercalating and non-covalent hydrogen bonds after being modified with crosslinking agents such as isocyanate or epoxy polymers. The hydrogel polymer of the shell layers in the emulsion can be considered as a soft gel that provides needed protection against damage to the inside core layer of SPI and modified SPI. Mineral oil and water can be considered as plasma and wetting agents as a self-activated catalyst or potential sensing agent.

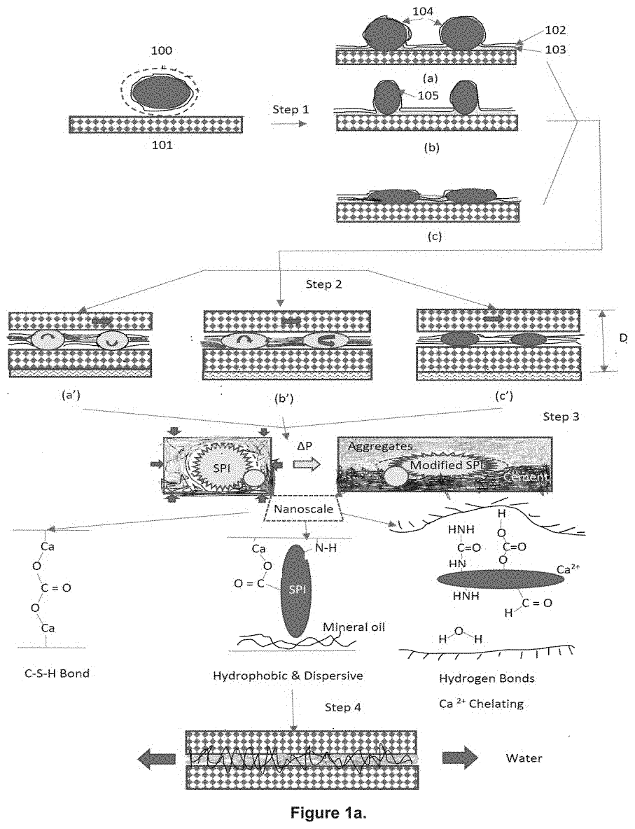

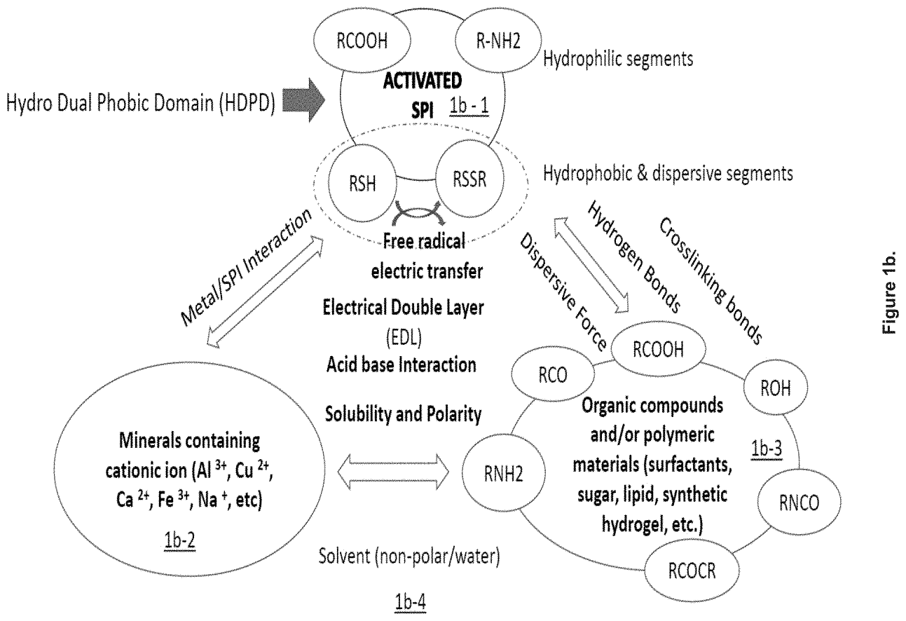

Like the biomineralization, in this disclosure as shown in FIG. 1a, it is self-evident that an emulsion, or chemical additives particle 101 is in contact with cement matrix surface 102. In step 1, millions of similar emulsion particles and cement/sand/aggregates are engaging intimate contacts through collision, shearing from each other, and bouncing in front and back from each other. Light density solvents (102) such as mineral oil or low carbon alkyl molecules are squeezed out from the hydrogel polymer network that covers the top surface of the coating layer, resulting in a slippery mixed layer of solvent/water/hydrogel polymer system, more specially, the hydrogel polymer (103) containing hydrated water, leading to a much less friction force to the sheared particles, which makes the whole mixed components fluffy without sticking. It can be defined as wet, however, not sticky phenomenon in term of soft material's behavior.

Similar scenario exists in carnivorous pitcher plants. The surface of pitcher plant's leaves is sticky with a clever slimy fluid like mucus as a super hydrophilic material; however, it is also slippery when the coating is sheared (Hirscher, 2007), characterized as super hydrophobic materials. Different from Lotus leaf, liquid or water droplet having an intimate contact with the pitcher surface will not be rolled down their leaf surface. it will have a breakup contact angle larger than 90 (degree) pinning on the leaf surface without falling. Water and mineral oil as dual solvent systems are soaked in the hydrogel network and SPI core layers, pending upon the attractive force between the absorbed liquid on the leaf surface. The emulsion containing in the liquid fluids will make a smart choice in the disclosed liquid on how the functionalized soy proteins in the core layers interact with other components to make a choice. The applicants believe that the core layer particles 104 such as soy protein isolate (SPI) and modified hydrogel polymer in powder, or sweet rice modified with isocyanate, etc., are exposing their hydrophobic groups toward airside conditions in response. SPI in the scenario (a) has a spherical shape, while SPI in the scenario (b) disc like structure potentially originated from soy protein secondary structure of 3-conglycinin 7S (19-20%). On the downside, the SPI will have hydrophobic groups toward the sand side with siloxane groups. Alternatively, Ca²⁺ and/or magnums is partially attached with the SPI surface. This kinds of molecular configuration of SPI or modified SPI makes the controlled self-assembly of soy proteins into high performance multifunctional nanostructured film on the solid surface become a reality.

As SPI is heated to 90° C., the proteins would have showed low content of intermolecular β-sheet structure and high content of random coiled and a helical secondary structure. Upon cooling down the soy protein down to 20° C., the content of intermolecular β-sheets will gradually increase by 25% determined if the protein is dissolved in appropriate solvent. Heating of SPI components can alternate its solubility with its denatured characters greatly between temperature of 20° C. to 90° C. (Lan Q., et al. 2019). The applicants believe that as both core layers and surface layers of the emulsions are heated or placed in different solvents, the secondary intermolecular structure is varied in response to enhance the interaction of SPI and hydrogel polymers with cement and aggregates not only in ionic bonds as CSH bonds, but also in hydrogen bonds, chelating bonds (Ca²⁺), leading to an intercalation of protein molecules into CSH interface.

In step 2, imaging that the SPI particle might change its configuration through rotational or/and translational modes in the micro channel of cement matrices, the soy protein spherical particles are rotated by 90 (degree) in angle, from perfect spherical shapes into elliptical shapes in FIG. 1 (a′). In item of (b′), the disc types of soy protein macro/nano particles are not only rotated by 90 (degree) in angle, but also become elliptical and flattened. Fundamentally, the configuration angles are tunable in response to the environmental conditions. The intimate contact surface area in scenario (b′) are much higher than in (a′). The applicants believe that the frequency of occurring in non-covalent bonds in scenario (b′) is much higher than in (a′). in the case of scenario (c′), the increased hydraulic pressure can potentially increase the opportunities of interfacial adhesion of α-helical coiling protein or/and β-sheet proteins with the cement elements. The ideas and fabricating strategies present here are to illustrate that the soy proteins or and sweet rice are potentially aligned together as fibrinogen or collagen served as clotting proteins to enhance the bonds of organic-inorganic interphase across the solid surface of hydraulic-cement concrete particles.

In step 3, a complex interpenetrated networking scenario might present herein. Different from current widely accepted CSH bond's description, chelating, deamination, amination from polyurea and polyurethane, and hydrophobic, dispersive bonds of mineral oil with alkyl functional group from soy proteins, sweet rice, or hydrogel polymers, especially extensive non-covalent hydrogen bonds among the polyurethane, amine, and carboxylic, and hydroxyl functional groups might be involved in the interface, resulting in a potential intercalation of soy proteins and other organic intermolecular polymers with the cement matrix or —OSIO— inorganic surface. The applicants believe that dendritic, finger printing, and/or stitching types of bond line might present between the interface of the organic polymers and inorganic geo-materials of sand, aggregates, and cement matrix as micro-capillary pressure driving action and compression or tensile force placed on the interface of the spherical particles as shown in FIG. 1a (a″) and (b″) in a nanoscale.

In step 4, the SPI, hydrogel polymers, mineral oil, surfactants/emulsifiers, and water are completely packed together with, or without entrapped air bubbles within. The driving force for liquid and coated particles out of the micro-channels of cement matrix is the ratio of surface tension to viscosity of the mixed liquid fluid, which determines the penetrating rate of fluid from one side to others. Due to the micro-capillary action of micro-channels, the thickness of the bonding line between adjacent solid surface is narrowed down further as the water or/and mineral oil are driven out of the interface bonding lines by evaporation versus versa condensation. The porosity of components (ε) is reduced further. The density of the concrete blocks increased with further consolidation. Also, it is noticed that since the porosity (ε) is not zero for hydrogel polymer and soy protein isolate, the SPI as gel particles in the micro-channels travel in a much complex manner if the gel inertia and variation of channel radius are considered. The applicants believe that the adhesion of inorganic-organic particles is primarily dominated by these non-covalent bonds instead of calcium silicate hydrate (CSH) bonds. The reduced porosity might further consolidate the concrete with superior durability.

Contributions of Free Thiol and Disulfide Bonds to the Binding Mechanism: As shown in FIG. 1b, the interaction of SPI with mineral such as sand and other aggregates, and polymeric materials related to the interaction schematic in FIG. 1a can be further demonstrated in detail. 11S from soy protein is believed to be a key component for activating the SPI for self-healing cross-linking interactions although the amino acids consisting of cysteine/disulfide bonds are minor components in comparison with other protein components, however, free thiol functional group is an important factor that controls the SPI performance. The formation of non-native intramolecular disulfide bonds from free thiol groups may cause protein refolding, potentially leading to aggregation and precipitation as an indication of structural variation of the material's conformation and configuration. A random coil might occur until it becomes highly aligned in soy proteins. Hydrogel polymers and silica nanoparticles were proposed to induce the amyloid fibrillation of lysozyme in solution. Potentially, the random coil, originated from β-conglycinin of degraded soy protein, converts it selves into a flexible nano-network that grips the reactive sites of adjacent cements or silica particles together, resulting in a flexible self-healing interface, especially, the encapsulated hydrogel polymers (polyacrylamide acrylate) or its modification with isocyanate and/or epoxy reactive sites may participate the cross-linking reaction during the self-healing processes of concrete. Instead of utilizing the collagen as nano-fiber reinforced components, regenerated soy protein short chains with regenerated polysulfide and/or sulfide chains of polymeric materials might play essential roles in regenerating the flexibilities of concrete with the extended self-healing behavior of products.

Redox imbalance leading to oxidative stress due to free thiol/disulfide bonds has been widely investigated as a causative mechanism in the pathogenesis of many protein mutant's diseases, although a definitive role for this mode of damage remains elusive. Overproduction of oxidants, including hydrogen peroxide (H₂O₂), may lead to the aberrant oxidation of cellular components resulting in mutants of live cells. Meanwhile, H₂O₂ is also produced in healthy cells and tissues that is rapidly produced at defined cellular locations and undergoes controlled breakdown by reaction with specific cellular targets, antioxidant molecules, and peroxidase enzymes. These characteristics of H₂O₂ allow it to act as a signaling molecules. A principal product of the reaction between a soy protein thiol and H₂O₂ is the protein sulfenic acid (RSOH) although protein sulfinic acid (RSO₂H) can also be formed. Most protein sulfenic acid forms are unstable and preferentially react with local thiols to form disulfides or may become internally stabilized sulfenyl-amide derivatives (Saurin, et al. 2004).

It was conceived that the cysteine and/or disulfide bonds of protein molecules in the invented additives undergo an unfolding/folding and regrouping process with fresh thiol and disulfide bond formation that re-generate the enzymatic activities plus the ragged tethering reaction of proteins with hydrogel polymers in the self-healing concrete curing processes. These regenerated free thiol groups in the special loci of the protein gene sequence, initially non-enzymatically, could be engineered chemically through re-activating its subunits of proteins with self-assembling action and controlling cross-linking degree and interpenetrating intensity of crysteine moieties by a polymeric chain reaction like tissue growth on the bone surface, resulting in the enhanced self-healing capacities of the concrete. In the above folding/unfolding reaction, the favorable reaction temperature of conducting the pre- or post-treatment on aggregates or sand materials of utilizing the multifunctional coatings and chemical additives is higher than 50° C., more preferred more than 80° C. Aggregation and/or aggregates of SPI can occur in either physical and/or chemical adsorption by covalent bonds interchanged by oxidation of free thiols (RSH), converted from least oxidated to most oxidized, including disulfides (RSSR), as well as sulfenic (RSOH), sulfinic (RSO₂H), and sulfonic (RSO₃H) acids.

Under neutral and base conditions, these transient reactions are favorable, dependent upon the pKa and aqueous solvent temperature condition. The oxidative reaction of SPI is supposed to behave dynamically with a varied hydrolyzed surface and reactivity. RSSR is very hydrophobic and sulfonic acid (RSO₃H) are highly hydrophilic, having strong hydrogen bonds. As schematic in the equation 1a, adapted from the step 3 in FIG. 1a of u.s. patent publication of 2022/0064521, free thiol and disulfide functional group are highly hydrophobic, that should be included as part of functional groups of the hydrophobic & dispersive components, in contrast, when the thiols and disulfide groups are oxidized, it is gelled into firmed network of dispersive components in a response to the oxidation status of thiol and disulfide bonds converted into sulfenic or sulfonic acids.

$$R S H {⇔}^{[ O ]} {R S O}^{-} + {H}_{2} O {⇔}^{[ O ]} {R SO}_{2} H {⇔}_{[ O ]} {R SO}_{3} H . \qquad ( 3 )$$

and disulfide interchange:

$${R}_{1} {SS R}_{1} + {R}_{2} {SS R}_{2} {⇒}^{HS} {R}_{1} {SS R}_{2} + {R}_{2} {SS R}_{1} . \qquad ( 4 )$$

where R1, R2, R, a functional group containing thiol —S—, H is proton ion.

The interaction of SPI with hydrogel and the sand aggregates are dynamically controlled by the equation (3) and (4) besides the cationic ion interaction, resulting in highly hydrophilic in nature.

Practically, the hardening of the plant-based proteins such as soy protein might be partially attributed to the oxidation reaction and disulfide formation in mesoporous silica prepared (Wang, et al. 2007). Under neutral and base condition, sulfenic acid from plant-based protein might react itself with silica to generate a mesoporous matrix composite. Micro-cracks with widths typically in the range of 0.05 to 0.1 (mm) have been observed to be self-healed completely, especially under repetitive dry/wet cycle's condition. The mechanism of this autogenous healing is mainly due to secondary hydration of non- or partially reacted cement particles.

Manipulating the thermal/hydraulic degradation and stability of the protein components can potentially grant the self-healing concrete with a desirable durability. Thermal degraded proteins might re-generate themselves into multi-layered nano-fibric precursors or random coil periodicity in response to the environmental conditions. As stated previously, collagen-peptides containing special proteins grant the bone exceptional mechanical strength and recovery capabilities. To enhance the biobased material's performance, recombinant collagen polypeptide has been engineered by synthesizing the collagen amino add materials with synthetic polymeric materials (Fushimi, et al. 2020 and Bera, et al. 2021).

So far, the effect of heating on denaturing of soy proteins was found that breakup of soy disuflide bonds is theoretically possible with strong polar solvents of DMSO (Zhang, et al. 2019). Study on controlled self-assembly of plant-based proteins into high performance multifunctional nanostructure films shows that after the SPI treated with acetic acid under a low pH value of 2.0, it can form a patterned SPI film with excellent stretching strength useful as food packaging materials (Kamada, et al. 2021). Clearly, the structure and protein molecules can be manipulated in this case, however, at neutral pH of the solvents, the solvents has more impact on both the hydrogen transfer reactions and chain transfer rate.

The ratio of chain transfer to propagation rate may be dominant factor. Another unknown question in term of the protein's morphological structure is whether the proteins encapsulated in the chemical additives are not only a simple enzymatic catalyst for growing the CaCO₃ biomineral's rocks, but also, serve as a gap filling agent of non-enzymatic proteins with a twisted DNA rope type of microstructure.

Since the thiol and disulfide bonds are inherently very reactive in plant-based soy proteins, more than often, the disulfide bonds of cysteine may cause them to lose their enzymatic activity toward a more stabilized structure. Study on engineered introduction of sulfhydryl groups and disulfide bonds, and their effects on the structural stability and heat induced gelation demonstrates that soy protein glycinin can increase its hardness by introducing cysteine residues using protein engineering (Adachi, et al. 2004). Furthermore, a grafting reaction of polymers, such as isocyanate functional groups, with free thiol functionalities of soy proteins, should potentially reinforce the strength of the soy protein isolates in the interface. In addition, the following reaction schemes for thiol and disulfide bonds may occur under the base and thermal condition as proposed here under the aqeuous solution:

$$R - S - S - R + ( - OH ) \to R - S - ( OH ) + R - {S}^{-} \qquad ( 5 )$$

$$3 R - {S}^{-} + {Fe}^{3 +} {⟺}^{[ H ] / [ O ]} {( R - S )}_{3} - {Fe}^{0} \qquad ( 6 )$$

$$R - {S}^{-} + {Ca}^{2 +} {⟺}^{[ H ] / [ O ]} R - S - {Ca}^{1 +} \qquad ( 7 )$$

$$R - S - {Ca}^{1 +} {+}^{- 1} S - H \to R - S - Ca - S - R \qquad ( 8 )$$

$$R - {S}^{-} + {H}^{+} {⟺}^{[ H ] / [ O ]} R - S - H \qquad ( 9 )$$

$$R - S - O - H + H - O - Si - R {⟶}_{- H 2 O} R - S - 0 - Si - R + {H}_{2} O . \qquad ( 10 )$$

Here, the reaction scheme of equation (5) is a slow process that determines the disulfide bond break-up. The reaction scheme of (6) is cross-linked through F³⁺ as the central hub of cross-linking, the driver can be a simple ionic adsorption without enzymatic involvement. Dipolar properties under the base condition has been recognized with iron nanoparticles to enhance the protein's fibric morphologies under base conditions. These reaction schemes demonstrate that an enclusion of enzymatic biomaterials might not necessary. Also, reaction scheme (10) demonstrates that a potential cross-linking between sulfide and silicon is possible with a hybrid binding, resulting in a rubberic type of flexible interface across the concrete sand aggregates and multifunctional coating additives through the covalent bonds as shown in schematic FIG. 1a. The behavior of concrete products will perform according to engineered materials like elastic-plastic composite materials besides the proposed bonding mechanisms present in u.s. patent application of Ser. No. 17/492,565.

To have a better description of the disclosed invention, FIG. 1b is used to interprete the conceived concept on the interaction among the mineral components, 11s of soy protein isolate (SPI) and organic polymeric components, in which, 11 s of SPI containing of the activated free thiol and/or disulfide bonds is interacted with mimeral surface and formation of —Si—O—S— bonds, and other hybrid metal frame interaction. Under the neutral and base conditions, both thiol group and disulfide bonds are hydrophobic, however, it can become hydrophilic by redox/oxidation reactions and increase its hydrophobicity and solubility in solvent or water. Also, the thiol group in one chain of SPI can be reacted with another chain of SPI to have interchangable reaction, resulting in potential mutants to the SPI chains. Potentially, stiffness and strength of SPI with mineral and other organic polymers will increase. The binding contribution from different classified interactions can be varied, dependent upon the interaction originated from the electronical double layer, solubility of solvents, acid-base interaction of the hydro dual SPI domains of described core layers of invented components.

Durability vs. Cracking of Concrete Products: Study shows that if the width of concrete crack is less than 50 (micron), a self-healing based upon CSH bonds shown in equations 2 and 3 can potentially mitigate the risk of the crack with a closed gap in a 100(%) recovery rate, however, if the width of the crack is less than 150 (micron) the crack width can be 100% self-sealed after re-cured for 3 days in water tanker, its width reduced from 220 (micron) to 160 (micron) after recurring for 7 days, 33 days is needed to fully heal the crack in width of 160 (micron), primarily attributed to swelling effect, expansion effect, and re-crystallization by geo-materials crack self-healing behavior (Tae-Hoshn & T. Kishi, 2010). Large crack in width more than 150 (micron) need special strategic approaches to heal the cracks (Yang, et al., 2009). ACI 224 committee states that a crack of 180 (mm) or more in width can cause deterioration of concrete structural members related to durability. The published allowable crack width in ACI 224R-01 (2008) table shows that the permitted crack width is strongly dependent upon concrete application scenario. In water-retaining structure, it only allows a crack of less than 100 (micron) in width, however, in dry air operation, it allows the crack less than 410 (micron) in width.

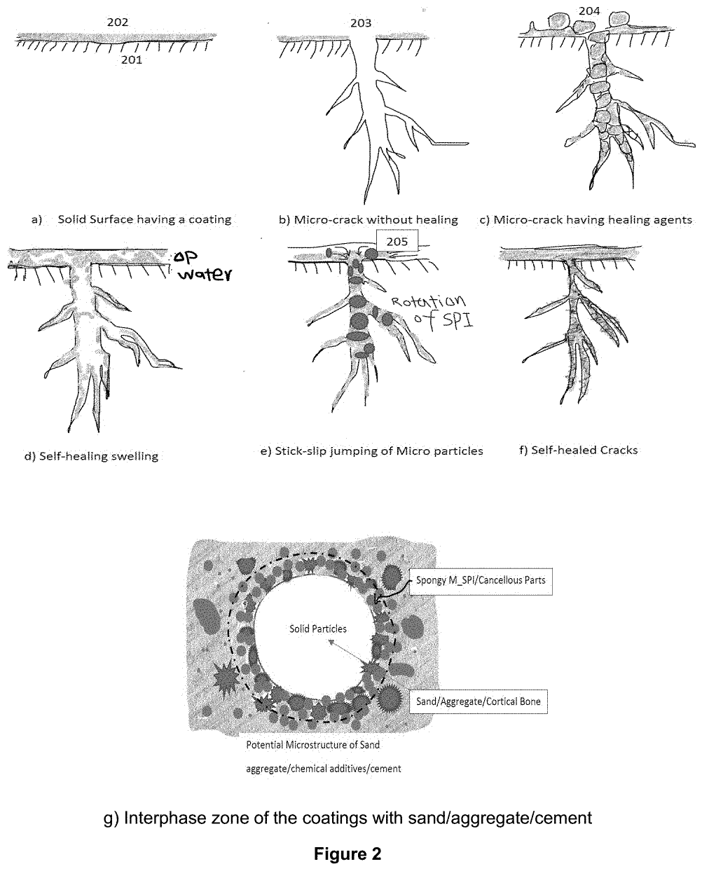

As shown in FIG. 2 (a), the solid surface of 201 is coated with a regular coating (202) on its surface. If stress within the solid surface is over the tensile strength of solid concrete, a crack of 203 will generate like a suspended upside-down tree trunk. A crack or fissure will open on the surface of cement structure as shown in FIG. 2 (b). if the chemical solution is used, the disclosed chemical additives or coatings are swollen and filled the gaps and crack of the upside-down tree trunk as shown in FIG. 2(c) in the case of cracks in width more than 160 (micron). The movement of the swollen particles and hydrogel polymers can be in a rotational or translational mode in response to the changed moisture content and solution temperature as shown in FIG. 2(e) by condensation or evaporation, versus visa.

The hydrogel polymers and SPI core materials will be potentially swollen first once it is accessible to water or mineral oil. Both hydrogel polymers and SPI particles could jump, hop, or fall themselves into the bottom of the crack or fissure valleys as shown in FIG. 2(d) in a stick-slip movement characterized by paired pinning-depinning events at the contact line. The encapsulated SPI could absorb moisture content and evaporate water out of the channels where motion was temporarily impeded but not permanently stopped. The solid of SPI components might also accumulate at the contact line in FIG. 2(e), resulting in a momentary localized solidification and temporary pinning (sticking) to the channel, leading to a complex dynamic behavior of interfacial bonding lines in a randomized stitching and finger printing pattern of cement interface bonding networks instead of a simple mobile movement of liquid fluids. Finally, the crack will be filled with new additives and minor impurities or debris particles that grant the crack with desirable recovery strength as shown in FIG. 2(f).

The applicants believe that the disclosed self-healing mechanisms of stitching and stick-slip bonds promote the self-activated concrete recovery capability. Mostly, as the chemical additives are added into cement matrix, it inhibits the hydration of cement reaction with sands or cementitious materials. In the rapid set cement products, the cement added with calcium oxide creates extensive heat as water is added in the cement mix in 20 minutes due to the exothermic reaction of cationic calcium with hydroxy anionic groups, leading to a fast gelling of cement components. The drawback of these fast-curing cement recipe is that the cured products will have low early age strength and poor post durable strength due to introduced structural defects before the mixed components are condensed.

In contrast, the applicants believe that α-helix coiled and β-sheet proteins from SPI are potentially embedded in cement matrices, tethered on the interphase zones of the sand and aggregates that will bring the viscoelastic spring-dashpot connection to the cement matrix. The viscoelastic composites, comprised of protein's helix coiling tails and β-sheet as building block, are proposed in FIG. 2 (g) in a spongy form surrounding the solid surface of cements, sands, and aggregates in a randomized distributed pattern. Inspired by bone fracture recovery, the SPI proteins can be considered as a collagen (long chain rod types of proteins) and clotting agents in bone structure, and the spongy form of SPI as cancellous type of structure in the integrated hydraulic-cement concrete structure. For long-term durability, the SPI and sweet rice components or their modification might and would be decomposed if the environmental condition is appropriate, leading to more CSH types of bonds. This serves as potential latent self-healing agents for concrete products without a need for repairments.

In summary, the proposed mechanisms are aimed at addressing the cracking issues related with the early strength and durability of hydraulic-cement concrete structure. Conceptual proofs of the proposed mechanism and benefits and advantages of components in the disclosed coatings are described in detail further.

Micro/nanotextured dual phobic domains: of the disclosed chemical composition and emulsion coating as shown in FIGS. 1a and 1b and 2, randomly distributed micro/nanotextured domain materials can be created by incorporating nano-textured dual phobic dot domains in powder, granular particles, or nanofibers on the solid surface. Instead of having a smooth surface, the coatings have an uneven and rough surface. Spherical inorganic mineral fillers or organic nanosized or micro-sized filler materials are potentially textured as the raw dot domains by simple self-assembly on the solid surface.

One of the identified cost-effective chemical additives is the petroleum paraffin. Others, such as soy protein isolate (SPI), are also preferred candidates as nanotextured domain materials. Morphologically textured ridge, concave, convex, and valley's features of coatings could be useful to construct the disclosed coating materials with micro-tips and bumps generated by the waxy spheres and/or dots to create an enhanced hydrophobicity and anti-blocking capability on the coated sand or aggregate or cement paste.

Another benefit with waxy materials is that wax is a cost-effective as hydrophobic domain materials and easy to be emulsified into coatings or solution chemicals. It has a diverse class of organic compounds that are lipophilic, malleable solids near ambient temperatures, including higher alkanes and lipids, melting to give low viscous liquids. Waxes are insoluble in water but soluble in organic and nonpolar solvents. Natural waxes of different types are produced by environmentally friendly plants. For example, Carnauba wax, also called Brazil wax and Palm wax, originally from the leaves of the Palm, is consisting mostly of aliphatic easters (40 wt. %), diesters of 4-hydroxycinnamic acid (21.0 wt. %), w-hydroxycarboxylic acids (13.0 wt. %), and fatty alcohols (12.0 wt. %). The compounds are predominantly derived from acids and alcohols in the C26-C30 range. Distinctive for Carnauba wax is the high content of diesters as well as methoxy-cinnamic acid.

Paraffin waxes are hydrocarbons, mixtures of alkanes usually in a homologous series of chain lengths. They are mixtures of saturated n- and iso-alkanes, naphthene, and alkyl- and naphthene-substituted aromatic compounds. A typical alkane paraffin wax chemical composition comprises hydrocarbons with the general formula CₙH₂ₙ₊₂ and C₃₂H₆₄. The degree of branching has an important influence on the properties. Microcrystalline wax is a lesser produced petroleum-based wax that contains higher percentage of iso-paraffinic (branched) hydrocarbons and naphthenic hydrocarbons. The candle and paraffin wax are commercially available in the commodity market.

Synthetic waxes are primarily derived by polymerizing ethylene. Alpha olefins are chemically reactive because they contain a double bond which is on the first carbon. The newest synthetic paraffins are hydro-treated alpha olefins which remove the double bonds, making a high melt, narrow cut, and hard paraffin wax. The wax is a very hydrophobic material. It has melting points in general above 35° C. or more. More specifically, the melting points of the wax are above 55° C. It has a measured water contact angle between 108 and 116 (degree) in angle (Mdsalih, et al. 2012). The percent wax quantities added into the mixture of designate recipes should be in a range from 0.01% to 15.0%, more preferred less than 5.0%. Other typical synthesis waxes include reactive wax such as ethylene stearamide, bis-ethylene stearamide, and their blends with other wax or solid lubricant materials that have lubricants and slippery characters.

Besides wax, other nano particles, such as polylactic polymers, SPI, nanofillers, lipids, sweet rice, and other bio-derivatives, might be used as macro/nanotextured materials mixed with wax to achieve desirable hydrophobicity and hydrophilicity. Hydro-dual phobic domain materials are referred to the materials that can be described as a material that behaves as hydrophobic, also hydrophilic with dual phobilicity. It can be a two system by a synergistic blend or one system chemically modifying a solid surface with multifunctional attributes. For example, a silane coupling surface treatment will allow the surface of modified carbon to become either hydrophilic or hydrophobic, leading to a hydro-dual phobic. As the modifying surface is contact with water, it will tend to expose itself with hydrophilic attributions. As it is attached with non-polar solvent, it will tend to expose its wax and alkyl functional groups on the surrounding environments. As such, the coated molecular components can be adapted in a smart manner to the aqueous solvent or air with appropriate fitness to the systems.

Different from waxy particle materials, soy protein isolate (SPI) containing a multifunctional moiety on its surface provide extensive reactivity and interaction with the other materials. One typical character is that the surface of bio-polymer particles such as soy protein isolate and sweet rice in powder can be chemically grafted with isocyanate polymeric functional groups or other functional cross-linking agents to achieve desirable hydrophobic and hydrophilic domain differently. From the peptide molecular structure of soy protein isolate (SPI). Alternatively, hydrogel polymer of hydrolyzed polyacrylate sodium acrylamide (HPAM) polymer in powder can be copolymerized with soy protein isolate through isocyanate as cross-linking agent. Other alternative proteins can be included as soy protein concentrates (70%), and soy flour (50% Protein) in powder to obtain hydro-dual phobic materials. That is, both of SPI and HPAM in powder, or granular particles can be cross-linked together to achieve a synergistic effect. The applicants believe that the copolymers from the SPI and HPAM chemical reaction through functional group of polyurethane and amide are unique that the viscosity of the mixed components are potentially enhanced as mixed components are added into the solutions due to the introduced multifunctional reactive sites on the surface of HPAM polymers.

Another benefit of utilizing the SPI is that SPI is in a porous network structure. Potentially, the hydroxyl, amide, and amine functional groups located on the surface or inside of the SPI particles are easily interacted with each other to physically generate the hydrogen and ionic bonds among the HPAM and SPI gel particles, leading to a gel polymer with enhanced viscosity of the mixed components.

Since SPI is made from de-natured soy protein flakes that have been washed in either alcohol or water to remove sugars and dietary fibers, a typical SPI nutrient component in 1-once plain powder based upon a USDA national nutrient database release (2004) has a component as total fat: 2(%); saturated fat: 0.0%; total carbohydrate 1(%); protein: 46.0%; cholesterol: 0(%); sodium 12.0(%); dietary fiber: 6.0(%); calcium: 5.0(%); Potassium: 1.0(%); Phosphorus: 22.0(%); folate: 13.0(%). Major components of soy protein isolate (SPI) are made of soybean products, which is abundant, inexpensive, renewable, bio-degradable, and aromatic. This provides rich ingredient as cement admixture type of products. Less costly soy protein concentrate (70%) is also a good raw material for copolymerizing them with HPAM. There are at least three methods for processing soybean into SPI: 1) The aqueous proteins; 2) the acid processes; 3) Heat denaturation/water wash method.

Through denaturation, soybean is isolated, containing primary amine (—NH₂—), secondary amine (—NH—), and acid carboxylic functional group (—COOH—). These functional groups provide extensive networking connection joint points with polyamide I and II bonds. In one perspective, the disclosed recipe provides a chemical composition comprising SPI plus polymers or pre-polymer's blends from 0 to 90(%) of the reactive isocyanate, a polyol, a polypeptide, or oxide epoxy resin. The dose level of polypeptide is ranged from about 10.0% to 90% (wt./wt.).

The organic poly-isocyanate can be selected from the group containing of polymeric diisocyanate (p−MDI), 2,4-methylene diphenyl diisocyanate. Under certain conditions, these poly-isocyanate polymers have one or two or tri-functional reactive groups reacted with the polypeptide bonds originated from SPI. The term “Protein” and “Polypeptide” are used synonymously and refer to polymers containing amino acids that are jointed together.

For example, peptide bonds or other bonds may contain naturally occurring amino acids or modified amino acids. The polypeptides can be isolated from natural sources or synthesized using standard chemistries or by chemical modification technology through grafting, including cyclization, disulfide, demethylation, deamination formation of covalent cross-links, formation of pyroglutamate, formylation, gamma-carboxylation, glycosylation. The term “isolated” refers to materials that removed from its natural environment if it is naturally occurring.

Potential bonds between and among the SPI and isocyanate might include the amide and carboxylic ester, and imide bonds with a cross-linking of SPI and isocyanate. Potentially, the HPAM can be incorporated into the SPI molecular chains and network structure through the multi-component's reactions. The applicants believe that the increased viscosity of modified HPAM with SPI cross-linked with isocyanate or epoxy polymers is potentially originated from the attribution of SPI's salt tolerance of its strong bonds with cationic ions such as sodium, calcium, and magnesium, and ferric chloride.

In comparison of polypeptide bonds vs. other chemical bonds, the polypeptides are very strong so that they can resist the heating temperature as high as 130° C. in the processing of denature and defat soybean materials. Procedures for generating a core layer of 100 emulsion particles in FIG. 1a are involved in first charging the lubricants such as mineral oil into a reactive tanker. Subsequently, SPI and/or HPAM can be added into the tanker or container. Then, cross-linking agents of p−MDI will be added into the reactor. Heating the mixed components in a reactor allows the solvent/lubricants to reflux in the condenser within a defined time (say at least 5 minutes at 60° C.). Besides the functional group of isocyanate (—NCO) from p−MDI, other crosslinking agent such as oxide epoxy, amine, aldehyde, carboxylic acid, silane coupling agents can be used to modify the SPI surface or to crosslink the SPI with HPAM.

The blended or reacted SPI_HPAM and isocyanate/lubricant system serves as the core layer of emulsion in the emulsion structural design of 100 in FIG. 1a. Then, the core layers that have the excellent power of tailoring the viscosity of the formed films with nanotextured patterns that are encapsulated with emulsifier/surfactant in the 1^{st} phase polymerization of mineral oil. The reaction temperature can be as low as ambient; however, preferred reaction temperature can be as high as 130° C., or less, preferred 60° C., or less. After the p−MDI is fully reacted with SPI or HPAM, shell layer materials such as emulsifiers can be added in the mixed components and optimized further.

Alternatively, the left-over hydrogel polymer from reacted core layer can be used as shell layers as suspending agent. More hydrogel polymer can also be added to generate a special shell layer with special electron charges on the shell layers.

Furthermore, the SPI belongs to an attractive building block material that can be obtained from natural sources, making them suitable for the fabrication of biodegradable materials. Proteins possess a propensity toward molecular self-organization and self-assembly with remarkable performance that can be used to create special nano-textured domain patterns. The generation of protein-based film through controlled assembly in the past has mainly focused on the use of synthetic peptides, natural animal derived proteins, such as silk, bovine albumin, fibrinogen, β-lactoglobulin, hemoglobin, and lysozyme or through protein engineering. preparation of porous structure derived from protein interactions with other coatings and polymer materials has been reviewed (Wei, Q., et al., 2014). However, fabrication of nano-textured pattern from plant-based proteins such as soy protein isolate (SPI) for used in concrete mix in combination with super absorbent polymer to achieve the synergistic effect as both strength enhancer and cracking healing agents with multi-layered hydrogel agents have not been found or disclosed in the public domains.

Furthermore, porous textured pattern from SPI can also be fabricated by a reaction of the Glucono-O-lactone-induced soybean protein isolate (SPI) via A Maillard reaction on the surface of cement matrix and sand surface although the concentration of soluble soybean polysaccharide (SSPS) can significantly affect the formation of textured pattern (Lan et al. 2019). Sulfhydryl group content has been increased in both denatured SPI and SPI gel that can be attributed to as major contributor toward the enhanced stiffness of protein structure. Recently, nano-microscale patterning has been fabricated by using plant-based proteins. Upon exposure to elevated temperature, the proteins unfold and partially hydrolyze, making them more available to form new intermolecular interactions, slowly lowering the temperature of solution facilitated the formation of self-assembly textured pattern on the coatings (Kamali, et al., 2021). The preferred relative dose level of SSPS to SPI is ranged from a ratio of 0.1/99.9 to 30/70 by weight percentage.

Key soy plant proteins are kinds of mainly comprising of 7s glycoprotein accounting for 20-50% of total seed proteins. It is a trimer consisting of three major subunits. The 7s globin is usually devoid of disulfide bonds. β-conglycinin forms a transparent, soft, but rather elastic gel in 100° C. heating and can be denatured at 80 to 90° C. The denatured temperature is started around 60-70° C. In one perspective, it is consisting of a lot of amine types of functionals, it is highly hydrophobic. On the other hand, it has considerable percentage of polar and charged residents, which leads to good water solubility and facilitates associates with bioactive compounds through electrostatic attraction and hydrogen bonds. X-ray crystallinity and CD study show that β-conglycinin is comprising of 5-10 in helix structure, 33-35% of β-sheet, 58(%) randomized structure. Soy protein gel with high 11s/7s ratio shows higher extent of macro-phase separation and coarser network with large pores (Wu, C., et al. 2016).

In addition, strong interaction of glutamic acids and proteins was observed as the ratio of Ca/Si of CSH bonds increased from 0.7 to 1.5, attributed to the strong hydrogen bonds between —O—Si—O— from silicon and —OCO— carboxylic functional group from β-sheet of proteins and more specially through the Ca²⁺ bridging by chelating functional connection of protein molecules with SSPS or silicon ionic⁻ group. The decreased interphase stiffness of cement paste suggests that an intercalation might occur between CSH bonds and super molecules of proteins (Kamali et al, 2018).

In addition, bio derivative's sweet rice is another great candidate as the core materials of the emulsion. Sweet rice is rich in amylopectin, not amylose like starch. It is also called as glutinous rice, which means sticky after being cooked. Like proteins, it is believed that it should be one of excellent bio-derivatives if incorporated into the emulsion.

Emulsifier/surfactants: An emulsifier is a surfactant chemical. It can be cationic, anionic, zwitterionic, amphiphilic having linear long chain, branched with di-functional, tri-functional, multi-functional star's structures, consisting of a water-loving hydrophilic head and an oil-loving hydrophobic tail. The hydrophilic head is directional to the aqueous phase and the hydrophobic tail to the oil phase. The emulsifier positions itself at the oil/water or air/water interface and, by reducing the surface tension, has a stabilizing effect on the emulsion. It can interact with other components and ingredients. In this way, various functionalization can be obtained by interaction with protein or carbohydrates to generate connected clusters both chemically and physically.

Typically, emulsifiers include stearic acid oxide ethylene ester, sorbitol fatty acid ester, glyceryl stearate acid ester, octadecanoic acid ester, combination of these esters, fatty amine chemical additives and compounds, alkylphenol ethoxylates such as DOW Tergential^{NP} series of surfactants, glycol-mono-dodecyl ether, ethylated amines and fatty acid amides. For examples, SPAN 60 polysorbitan 60 (MS) and PEG100 glyceryl stearate MS are two typical emulsifiers used in cosmetics industries. Typical emulsifiers are branched as polyoxide-ethylene parts, groups found in the molecules such as monolaurate 20, monopaiminate 40, monostearate 80, etc., with HLB from 4.0 to 20.0, preferred from 10 to 17.0.

The dosage level of added emulsifiers in the emulsion can be ranged from 0.001% to 5.0%, more specifically less than 3.0% (wt./wt.) over the total weight percentage of coatings. The emulsifiers are water insoluble, only partially water soluble, dispersible. It is only dissolved in hot water. SPI and wax or other polyhydroxy component's materials such as sweet rice flour can be included as core materials in the micelle structure. In contrast, the emulsifiers can only be used as shell or intermediate shell materials in the micelle structure.

The emulsifiers in the disclosed additives are critical components. It has its hydrophilic heads toward the outside water loving phase and/create strong interaction with water solvent. Meanwhile, it has its hydrophobic long chain tail portion toward the waxy or SPI sphere as core materials for the micelle. SPI sphere or SPI_isocyanate sphere, SPI_isocyanate_HPAM cross-linked spheres are potentially sealed into the micelles. In addition, the made and amine from the HPAM and SPI might be critical for tailoring the final emulsion performance due to its electrophoretic functional performance although the reaction mechanism might not be understood. The applicants believe that the interaction among these chemicals makes the chemical additives blended into the water very complicated with unprecedent unknown attributes.

Cross-linking Agents: To enhance the stiffness of the core layer or shell layer of the micelles, selected cross-linking agents can be used to manufacture the micelles and hydrogel polymer structure. Preferred cross-linking agent's reaction schemes was discussed in previous sections with p+MDI isocyanate functional resin polymer as an example. The purpose of p−MDI reaction with SPI is to enhance the hydrophobicity of SPI, potentially with extended hydrophobic chains to tailor the viscosity of the final emulsion and textured dual phobic domain patterns. Alternatively, reaction of crosslinked agents can be chemically cross-linked with non-reversible connections in nature or reversible with hydrogen bonds, pending upon the blended component's condition. Also, polyurethane dispersive can be incorporated into the coatings that have a UV curable moiety in its molecular chains. Alternatively, chemicals, containing epoxy, amine, amide, carbonyl, aldehyde, hexamine, and hydroxyl, amine functional groups of polymers can also be used. The preferred dosage level of cross-linking agents to the whole recipes of the coatings should be less than 10.0% by weight percentage. The ratio of SPI or copolymers of SPI+HPAM or SPI plus sweet rice plus HPAM to isocyanate should be ranged from 0.0000/100.00 to 40/60.

Antimicrobial Agent: Since soy protein isolate (SPI) and sweet rice flour are bio-derivatives, they tend to decompose themselves in the ambient condition. Microbial and fungus might potentially grow if they are used in water and aqueous based recipes during storage or transportation. As a result, antimicrobial agent is needed in the recipe, preventing biomaterials from bacteria or micro-fermentation. Common preservative additives include glutaraldehyde, formaldehyde, hexamine, benzyl ammonium chloride, methylisothiazolinone, 2-phenoxy ethanol, copper sulfate, copper sulfate oxide powder, fatty amine, etc. Dosage level of added antimicrobial agents is ranged from 1.0% or preferred less than 0.10% over the total weight percentage of the whole coatings. The ratio of antimicrobial materials to the SPI or sweet rice or their combination should be in a range of from 0.01/99.9999 to 5/95 by weight percentage. The antimicrobial agent can be added as a partial replacement of bio-derivatives used in the coatings by weight percentage.

Hydrogel Polymer: In cement paste and concrete recipe, hydrogel polymers serve as a multifunctional material. They are suspending agents as shell layers to encapsulate the core layer spheres from exposed to the out-layer environment before the special condition is met. Also, it is water reducing agent that can hold water in its matrix for desirable time and enhance the workability of cement paste during construction operation. It can also be a strength enhancer for promoting the early age strength of cement mix and autogenous self-healing for enhanced durability of concrete with reduced maintenance cost.

As shown in FIG. 1a, the emulsion coating particle of 100 is suspended in an aqueous solvent, more specially water/mineral oil mixture, the hydrogel polymers added on the shell layer in powder or liquid are functionalized as a shell layer placed on the core sphere of SPI or its modified materials, potentially encapsulating the core layer materials intact from the out-shell layers via adjusting emulsifiers to generate a stabilized dynamic shell/core structure. It serves as lubricant/slippery agent. It also serves as super absorbent agents and can potentially hold more than 10 times of water by weight percentage in its network structure. The dosage level of hydrogel polymer added in the aqueous solution is ranged from 0.00001% to 2.000(%) by weight percentage to the total weight of coatings. The coatings can be added in water ranged from 0.2 to 2.0 gallon of coatings per thousand gallons of water. The hydrated viscosity of mixed aqueous solution can be ranged from 3 (cps) to 5000 (cps), pending upon the dosage level and desirable performance.

Common practices in current manufacturing technologies disclosed are to use hydrogel polymers such as polyethylene glycol, polyacrylate and polyacrylamide polymers and/or their copolymers added into the aqueous solution, in which, the use of additional surfactants is involved. Powder polymers are conventionally used in these applications due to the higher polymer concentration available in the form as compared to the solution polymers with reduced shipping cost. Hydrogel polymers are commercially available in the market. For examples, there are several brands of SNF products, such as FLOPAM DR 600 and DR 7000, that can be incorporated directly into the aqueous solution. Both polymers are anionic polyacrylamide polymers. Alternatively, FTZ2620, FTZ610, and LX641 polyacrylate sodium acrylamide polymers, manufactured by Shenyang JuFang Technology, Ltd., are also useful polymers as alternatives as friction reducer polymers and coating ingredients. Other polyacrylate and acrylamide polymers with cationic and nonionic molecular structure, are also potential candidates as hydrogel polymers. The structure of hydrolyzed polyacrylate sodium acrylamide can be linear or branched with dendrimers having hyperbranched polyester amide structure, mixed cationic and anionic polymers are also potential, other water-soluble polymers, such as polyvinyl alcohol (PVOH) and polyethylene glycol, are also potential candidates as substitute polymers of HPAM. The dose level of these hydrogel polymer is ranged in a ratio of hydrogel polymer to the toral weight of coatings from 0.00001/99.99999 to 40/60 by weight percentage.

Lubricant: The synthesis processes of the HPAM polymers are involved in an inverted emulsion. Mineral oil or saturated hydrocarbon (Kerosene) is, in general, used as a key solvent for preparing the HPAM friction reducer emulsion. As a result, HPAM hydrogel polymer is dispersible in the lubricant. Lubricants or oils are comprising of the derivatives from petroleum crude oil, containing saturated hydrocarbon and alkyl groups. Alternatively, the lubricants can also be originated from the bio-derivative resource such as corn, soybean, sunflower, linseed oil containing the long chain alkyl components. The lubricants can also be synthetic oil chemicals made of reactive ester or hydroxyl functional alkyl chains or saturated hydrocarbon coupled with silane coupling agent or having silicon functional groups.

A broad definition of lubricants could be found in an URL link (https://en.wiki.pedia.org/wiki/lubricant). It is defined as a substance, usually organic, introduced to reduce friction between surfaces in mutual contact, which ultimately reduces the heat generated when the surface move. The dosage level applied in the chemical compositions for lubricants is added in a range from 1.0 to 90(%). A typical mineral oil that can be used is a white mineral oil labelled as 70 Crystal Plus white mineral oils, manufactured by STE Oil Company, TX, USA. It is a series of derivatives if petroleum crude oils. Alternatively, soybean oil and linseed oil or synthesis silicon oil can also be used as lubricants. Other examples of lubricants include ethylene bis-stearic acid, amide, oxy stearic acid, amide, stearic acid, stearic acid coupling agents, such as an amino-silane type, an epoxy-silane type and a vinyl-silane type and a titanate coupling agent.

Water: Water is assumed to be a key component for preparing the emulsion as media and dilute agent to hydrate and adjust the coating into appropriate viscosity and pH value. The viscosity of the final coatings can be in a range of from 3 to 5000 (cps), preferred from 5 to 100 (cps). pH value from 6.0 to 9.0, preferred around 6.8 to 7.6. The concentration of the final coating's products can be in a range from 40.0(%) to 0.0001(%) over the total weight percentage of coatings, preferred concentration is less than 15.0(%), more preferred less than 10(%), or 5.0(%).

Procedures for preparing the chemical components and solution disclosed herein related to the recipes for a multifunctional coating, comprising of a multi-layered or hybrid shell and core structure having a desirable synergistic effect to the cement paste and sand coating. The applicants believe that the added components following a special procedure form a mixed and undefined multi-layer and a micro-micelle structure that can deliver special multifunctional performance in a response to the special product's performance request. The coating chemical components can be described as that a phase transition material such as petroleum wax, and SPI granular particle, biomaterials, and/or granular materials, organic or inorganic derivative and particle materials, sized in diameter from 0.00001 (micron) to 1000 (micron), could be dissolved or dispersed in the mineral oil by heating and re-condensed and crystallized back into solid bump and particles as the mixed component's temperature is below the melting temperature of mixed components.

The non-polar lubricant solvents such as mineral oil and alkyl group are saturated carbon and unsaturated hydrocarbons in the range of from C8 to C18. Also, included in the recipes are saturated carbons in the range of C12 to C26 in the range and mostly alkanes, cycloalkanes, and various aromatic hydrocarbons. It can be classified as paraffin, naphthenic, and aromatic. The preferred heating temperature for the mixed chemicals can be as high as 140° F., then, the surfactants or emulsifiers can be added into the mixed solution, resulting in a uniform emulsion with multi-layered shell/core structure.

Subsequently, a hydrogel polymer and cross-linking agents are added into the solution. The micelle structure disclosed here is just demonstration only. The actual micelle structure might be a hybrid one with an ambiguous intermediate layer or interface instead of a clear sjell and core's structure. The SPI or wax particles as the core sphere of micelles are encapsulated within the emulsifier molecules. The emulsifier micelles are hybridized with hydrogel HPAM polymers extended toward the water phases. The emulsifier molecules play essential roles in dispersing the wax or SPI or other micro-nanotextured particles and fiber materials in the hydrogel polymers and solutions temporally. Meanwhile, it also allows the wax or other textured particles to migrate and suspended on the top of the coating film layer. As a result, the hydrophobic coating and bumpy dots and domains can be generated via a porous interpenetrated network.

After being blended for 5 (minutes), the mixed components can be charged with polar solvents such as water into the mixture. Brookfield viscosity of the mixed materials can be determined at a spindle rotation speed of 6, 12, 30, 60 (RPM). Then, the coating materials are sealed in the package for late use.

The manufactured coating can be either used to directly spray on the sand or aggregate surface as regular coatings to mitigate the risk of sand dustiness or directly blended into cement matrices as paste ingredients. It can also be added into the cement mix after being diluted with water and add the coatings as aqueous solution as chemical admixture in the blending of cementing operation.

Concrete Mix: As shown in FIG. 1a of 101, Cement, sand, aggregates (stone), and water are mixed to form concrete. The range of aggregate sizes, from fine sand particles to small to large stones, allows denser packing and minimal air entrapment, leading to greater strength. The water to cement ratio, W/C, is the weight of mix water in the concrete divided by the weight of cement in the concrete. The preferred design range of W/C is ranged from 0.20 to 0.72. It is one of the most important parameters that should be controlled in the casting of concrete products. Less water makes the concrete less workable although it makes concrete have increased compressive strength. In contrast, more water makes the concrete weaker.

To resolve the dilemma on balancing the workability and concrete composite performance, chemical admixture has been recognized as important components of concrete used to improve its performance since ancient time. As a matter of fact, milk was used by Romains, eggs during the Middle Ages in Europe, sticky rice was identified as secret ingredients discovered by Chinese Scientist for building the Great Wall in China 2000 year ago (Yang, et al. 2010). The American concrete Institute (ACI) defines chemical admixtures as “A material other than water, aggregates, hydraulic cement, and fiber reinforcer used as an ingredient of a cementitious mixture to modify its freshly mixed, setting, or hardened properties and that is added to the batch before or during its mixing”. Evidently, the disclosed coatings meet the above specification and performance standard.

Mechanical Performance and Components of Concrete: According to English dictionary, concrete is a hard, compact building material formed when a mixture of cement, sand, gravel, and water dried: used for making bridges, road surfaces, etc. The performance of the compacted grains sintered under ambient temperature could be predicted with a simple mixture law. American Concrete Institute (ACI) have developed a convenient table as reference guidance for user/engineer design to make choice on targeted compressive strength of their cement products, then, what kinds of mix proportion (cement, sand, aggregates, and water). A sample mix design is exemplified here per ACI building code: chapter 1. That is, a minimum compressive strength of f_{c}=4000 (PSI) at 28 days requested. Application field: footings, piers, and foundation walls; Air content: 6.0%+/−1.5%, target water/cement ratio: 0.40 as preferred recipe requirement.

All our mix recipes are based upon the above suggestion from the above recommended w/c ratio; however, it is not limited to the above. Numerous factors have been in consideration to adjust based upon specifical requirements of raw material's properties, engineering applications, and ASTM C standard and ACI code requirements besides the disclosed product's performance.

Portland Cement: Of these concrete materials, Portland cement has been considered as one important invention. It can be considered as a gluing agent for sand and aggregates. Via hydration or/and pozzolan reaction, it forms stiff and strong ionic bond strength with excellent compressive strength. 28 days of curing schedule have been adapted as a global standard to determine the cement compressive strength (unconfined compressive strength). Within 14 days of cement curing, the cement test blocks are expected to have around 90% of its maximum compressive strength. ASTM 1157 standard defines the types of cements, also ASTM C219 defines what is the hydraulic cement—a cement that sets and hardens by chemical interaction with water and that can do so under water. It is classified as:
Portland Cement:

Type I: Normal, general purpose

Type II: Moderate sulfate, low heat of hydration

Type II (MH): moderate heat of hydration and moderate sulfate resistance

Type III—High early strength

Type V—high sulfate resistance
Blended Hydraulic Cement (ASTM C595)

ggbf/slag

Fly Ash

Silica Fume

Calcined shale

Other Pozzolans

Limestone

ASTM C1157 defines performance-based cement as:

GU—general use

HE—High early strength

MS—Moderate sulfate resistance

HS—High sulfate resistance

MH—Moderate heat of hydration

LH—Low heat of hydration

ASTM C1157 is a performance-based standard. If the products can achieve the properties, the PLC can have any amount of limestone in its components. ASTM C91 defines the Masonry cement standard: It is primarily used in Masonry and plastering construction, consisting of a mixture of Portland or blended hydraulic cement and plasticizing materials such as limestone, hydrated or hydraulic limestone together with other materials introduced to enhance one or more properties such as setting time, and workability.

ASTM C1329 defines mortar cement standard, it is classified as: Type N, Type S, Types M. It is like masonry cement in use; however, this specification includes a flexible bond strength requirement. A general use (Type I/II) cement was purchased from local building supplier distributor used as it is. It has a density of 3.15 (g/cm³). Also, a white Portland lime cement was also used for preparing concrete blocks and evaluating its possible used as architecture stone and construction wall sheathing. The recommended dosage level of cement's materials is ranged from 5.0(%) to 90.0(%) by volume fraction of the cement, fine sand, and aggregates. Lime (CaO) or Calcium hydroxide can be added to accelerate the hydrated reaction as partial replacement of cement, preferred dosage is ranged from 0 to 20% over the total Portland cement by weight percentage.

Aggregates and Sand Materials: Large sized aggregates are preferred to have a high compressive strength. On the other hand, small sized sand can be packed denser that can ultimately hold heavy compressive loads with tight packing and low porosity. The shearing resistant capability will be increased with small sized sand or aggregates. Therefore, laboratory test and onsite field tests are required to make sure that the manufactured concrete products meet the engineered design requirements, however, in this disclosure, the chemical additives applied in all demonstrated examples are illustration only. No specifical engineered parameters are prescribed in the disclosure. Playground sands with very fine size without dust were used in all testing samples. In term of aggregates, all-purpose sands were purchased from home depots used as it is. The nominal coarse aggregate size is ranged from ¾″ to 1½″. The total quantities of regular fine sand plus aggregates are ranged from 5(%) to 95(%) by volume fraction.

Water: In term of water, purified water without Ca²⁺ and Magnesium²⁺ ion is preferred. The ratio of water to cement was varied from 0.20 to 0.72, depending upon the final mix and products desired, however, 0.40 is a standard W/C used most in the tested samples. The preferred W/C level should be 0.45 or less, more preferred less than 0.4, 0.38, 0.36, 0.30.

Cementitious Materials: In term of cementitious materials, the claimed cementitious materials are defined as any inorganic geomaterials, such as special sand, Sodium silica, micro silica, silica gel geopolymer, swollen clays, kaolin clays in powder, etc., that promote the Pozzolan reactions plus the cement. W/Cm ratio is the weight of mix water in the concrete divided by the weight of the cementitious material, where the cementitious material is a combination of cements and Pozzolans. The blend ratio of chemical additives to cementitious materials is ranged less than 30.0%, more likely, less than 5.0% over the total cementitious materials by weight percentage. Frac sand or proppant materials also called quartz sand, containing up to 99.80(%) of SiO₂ is an excellent candidate for cementitious materials, having particles size of 0.038 (mm) to 2.0 (mm), defined as 100 mesh and 40/70 mesh, 30/50, 20/40, 16/12, was selected in the disclosure to determine whether these materials can be used as direct replacement of fly ash, micro silica gel, titanic dioxide, silica sand, or other geo-polymeric materials. Since these materials use less energy to be mined, a replacement of fly ash with frac sand provides excellent options for reducing the global CO₂ emission.

Workability: Once the samples were mixed with disclosed chemical additives, the pot life or working window for all recipes are around 20 to 120 (minutes). No issues have been detected in term of water holding power of the added additives. Based upon the leftover residuals, the materials are reusable within 24 hours with significant coalescence and sintering to each other.

Mix: The sand or aggregates can be sprayed or pre-blended with the chemical additives before added into the mix with cement. Alternatively, all components of sand, cement, and aggregates can be pre-weighed before blended with water and chemicals. In which, the chemicals are always pre-blended with partial water to dilute chemical further before added into the powder mix to achieve the enhanced distribution. Most of often, about 40 to 50% of added water has been used to pre-blend with chemical additives to give a better distribution of chemicals with other components. Alternatively, the chemical additives are first blended with the portion of dilute water and charged into the mixer first. Then, sand, and aggregate are added 2^{nd}. After the cement is added, mix timer is registered. After 1-2 (minutes), the rest of water is added into the mixer. A high shearing during mixing is preferred. It seems that a well sheared mix and blending can create much better compressive strength and flexible tensile. The mixing time is around 3 to 5.0 (minutes). Preferred to have a shearing and relative fast blending for about 1.0-2.0 (minutes) or so. to achieve the compatibility of coatings with sand/aggregate system. Most of time, a mix and blending operation can be as long as 10 (minutes) before using the batch mixed materials.

Dust Suppression: In the construction fields, respirable dust is a big safety concern, especially dust from microcrystalline silica due to its high risk of triggering silicosis diseases. The chemical composition and technical solution disclosed are well positioned for suppressing the dustiness of cements, fine sands, and aggregates via spraying or blended with the disclosed chemicals blended in a weight percentage of from 0.1 to 3.0% based upon the total granular solid weight.

Reinforcement: Chopped fiber glass having a length in 12 (mm) and a diameter of 0.40 (mm) was used to blend with limestone Portland cement. The chemical additives seem to have an excellent mixing capability with fiber glass. Certainly, other reinforcement elements can be added and blended with the chemical additives to achieve the desirable performance. The dosage level of reinforced fiber element added in the concrete mix is in a range less than 5.0(%) by volume fraction to the total cementitious materials Plus fiber Reinforcement, more specifically less than 2.5(%).

Coloring: The multifunctional coatings and chemical additives present in white emulsion. It demonstrates much less influence on coloring to the original sands or aggregate, and cement raw materials. Coloring match test can be conducted following ASTM E 308 standard method or follow a simple Hunter L,a,b, alternatively, L*, a*, b* (CIELAB). In CIELAB, L* as light vs. dark, a* red vs. green, b* yellow vs. blue. Automatic color meter can be used to determine the L*, a*, and b* of interested concrete and coated sand or aggregate's coloring.

Performance Test: Cement materials are very brittle. Like the ceramics, it requires special qualification test for special applications following recognized testing standard and protocol. Tensile failure is generally attributed to the unstable extension of a critical tensile crack (Li, 2007). ASTM C39 standard was selected in the disclosed test for all samples, in which cylindrical samples were casted, then, unconfined compressive strength (UCS) was determined following the standard testing protocol. Alternatively, ASTM C109 could be used to conduct preliminary screen test. For the tensile failure, ASTM C496 standard was followed to determine the splitting tensile strength with maximum force of the Diametral tension test method. other performance parameters such as water permeability, density, porosity also determined for the fabricated samples disclosed in the examples. Various advantages of the chemical additives and recipes used for enhancing early age strength and promoting the self-healing of concrete durability will be discussed further in explanatory examples 1 to 24 and 25 to 31.

### EXPLANATORY EXAMPLES

Example 1. Chemical Additives and Solution Recipes and Composition Chemical Additive composition solution was prepared following the following procedures: Pre-blended 1.60 (g) of FTZ620, a hydrolyzed polyacrylate sodium acrylamide polymer in powder, with 0.8 (g) of sweet rice, purchased from available open market, then, 27.26 (g) of 70 T mineral oil was charged into a 1000 (mL) of glass beaker and stied with magnetic stirred bar. 3.21 (g) candle wax was added into the beaker and the mixture was stirred and heated to 140° F. or above. After the candle wax was totally dissolved in the mineral oil within 5 (minutes), 4.18 (g) of polysorbitan 60 MS NF and 0.25 (g) of PEG100 glyceryl stearate was charged into the mixture and blended for another 5 (minutes), then, the pre-blended FTZ620 and sweet rice were charged into the heated beaker for another two to five minutes. After the mixed components have a solution temperature over 150° F., then, charged 220 (g) purified water, the solution temperature dropped, continuously blended the components until the solution temperature was reduced to the room temperature. The leftover of purified water (122.80 g) was added into the beaker. The samples showed a color of white emulsion. The products ID was labelled as 3-100-1a, 3-100b. A second batch following the same procedure was used to obtain the emulsion labelled as 4-178-1a. The components and procedures are listed in Table 2.

Combined both of 3-100-1a and 3-100-1b together, the viscosity of the mixed solution was determined with a Brookfield viscometer (USS-DVT4 digital rotary viscometer) at the following spindle Rod NO 1 at a rotation rate of 6, 12, 30, and 60 (RPM). The measured viscosity of the coatings prepared following example 1 is listed in Table 3.

In addition, the measured pH value of the above solution was 6.90. Color of the solution was white cloudy. The solid content of the solution was 9.04(%). Then, the sample was stored for later use.

Example 2. To a 1000 (mL) of beaker, 38.96 (g) of 70 T mineral oil was first charged into the beaker, then, 2.89 (g) of soy protein isolate (SPI) having a 90% of protein content, was charged into the beaker, 3.85 (g) oil based polymeric p−MDI solution (50% Concentration) was added to conduct a preliminary polymerization reaction to modify the SPI surface. A magnetic stir bar was used to blend the mixed components, simultaneously, the mixed components were heated until the solution temperature reached 140° F. or above. A mixture of pre-blended of 2.40 (g) of FTZ 620, a hydrolyzed polyacrylate sodium polyacrylamide polymer in powder with 1.20 (gram) of sweet rice in powder, purchased from open market, was charged into the heated mixture in the beaker. The mixture temperature was continuously increased to 150° F. or so. Then, 6.27 (g) of polysorbitan 60 MS NF, PEG100 glyceryl stearate surfactants were charged into the mixed components for at least another 5 (minutes). Then, the whole mixture components were cooled down to room temperature slowly. Then, 544.05 (g) of purified water was charged to dilute the solution to target viscosity. The obtained solution was labeled as sample of ID: PSMI_3-136. A summary of the components and procedures for preparing the chemical additives is listed in table 4, the measured viscosity in table 5.

Example 3 (Preparation of Control Concrete Sample): 732 (gram) of Portland cement (I/II GU Type), manufactured by TXI, was weighed, held in a container, then, 300 (gram) of purified water was first charged into a Hobart mixer. 984 (gram) of fine sand (max size in length <0.50 mm), and 984 (g) of coarse aggregate sand (max. size in length <8.0 mm) purchased from Home Depot, were added into the mixer. The weighed Portland cement in the container was transferred into the mixer. The whole mixer components were stirred first slowly, then, increasing the blend rate slowly, finally with a maximum speed setting rate of 7, blended for about 3-5 (minutes).

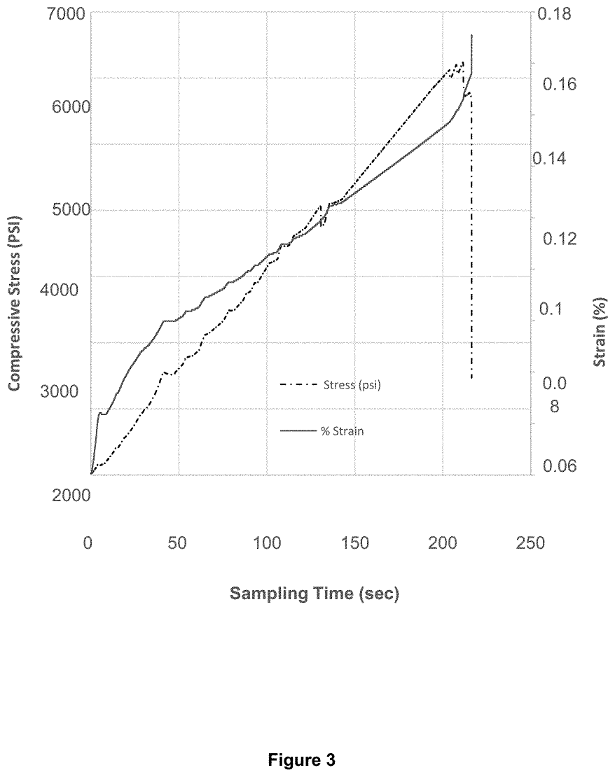

The final water/cement ratio of the blended components was 0.410. The formed slump of cement paste was smooth and created a good cone that could establish a cement block successfully. The mixed components were casted into concrete testing specimen prepared by different sized PVC pipes with different cylindrical size of 3″×6″, 1″×2″, 2″×4″ within 45-75 minutes. The casted samples were immediately sealed with aluminum foils over 24 hr. before placed in water tanks for 7 days, then, left in air for 365 days, then, placed in water for another 100 days, exposed to air again for 38 days before submitted for testing on unconfined compression test following ASTM C39 and Brazilian Splitting tension test following ASTM C 496. The sample was labelled as 4-168-1, 4-168-2, and 4-179-2c-1. A typical plot of compressive stress as a function of displacement (4-179-2c-1) is shown in FIG. 3.

TABLE 2
Chemical Additives Used for Modifying the Surface of Cement Mortar
and Concrete Aggregates

| | | 3-100-1a & 3-100-1b | | |
|---|---|---|---|---|
| | Sample ID: | Quantities | | |
| Items | Components: | (g) | % w/w | Note |
| 1 | 70 T Mineral oil | 27.26 | 6.82 | |
| 2 | Candie Wax | 3.21 | 6.80 | |
| 3 | Polysorbotan 60 MS NF | 4.18 | 1.05 | |
| 4 | PEG100 Glyceryl stearate | 0.25 | 0.06 | |
| 5 | FTZ 620 | 1.6 | 0.40 | |
| 6 | Sweet Rice | 0.8 | 0.20 | |
| 7 | Water | 362.7 | 90.68 | |
| | Sum: | 400 | 100.00 | |

| | |
|---|---|
| | Procedures: |
| 1 | Pre-blend FTZ620 (5) and sweet rice (6) |
| 2 | Charge (1) to a 1000 mL of beaker, charge (2) and stir (1) + (2) |
| 3 | Heat the candle wax (2) to 140° F. and allow the candle wax |
| | totally dissolved within minutes |
| 4 | Charge (3) + (4) together blend for 5 (minutes) |
| 5 | charge the pre-blended (5) + (6) together and continoulsy keep |
| | the temperature above 140° F. |
| 6 | Charge the first batch of the water {-220 (g)} and |
| 7 | slowly cool down the components and wait for tire emulsion to |
| | cool down |
| 8 | Charge the rest of the water (7) to fully cool down the mixture |

TABLE 3
Measured Viscosity Of Chemical Additive Solutions Prepared by
Example 1

| Rotation Speed | Viscosity | Percentage of Efficiency |
|---|---|---|
| RPM | (CPS) | (%) |
| 6 | 530 | 10.2 |
| 12 | 340 | 14.5 |
| 30 | 241 | 24 1 |
| 60 | 172 | 34.4 |

Of the three prepared casting samples, the tested samples for compressive strength had average actual dimension in length: 3.06″ in diameter, Height: 5.17″, and Length/Diameter ratio: 1.90, actual breaking load: 36610 (lbs), ultimate compressive stress: 4995 (PSI) after 500 days and adjusted compressive strength 4921 (PSI). The modulus of elasticity of the tested samples was 437579 (PSI). The splitting tension strength: 1298(PSI). The average density of the tested sample was 2.276 (g/cm³). The porosity of the tested samples was 0.141 if the particle density is assumed to be 2.65 (g/cm³).

Example 4: Preparation of Concrete Cylindrical Samples with Chemical Additives in Example 1 Incorporated: 732 (gram) of Portland cement (I/II GU Type), manufactured by TXI, was weighed, held in a container, then, about 220 (g) of 280.2 (gram) of purified water was first blended with 21.98 (gram) of chemical solution and/or additives from example 1, then, used the leftover water to rinse the wall of the container that held the chemical solution from example 1. Finally, all the 21.98 (g) chemical solution was blended with water and charged into a Hobart mixer. 984 (gram) of fine sand (max size in length <0.50 mm), and 984 (g) of coarse aggregate sand (max. size in length <10.0 mm) purchased from Home Depot, were added into the mixer. The weighed Portland cement in the container was transferred into the mixer. Then, the whole mixer components were stirred first slowly, then, adding speed, finally with a maximum speed setting rate of 7, blended for about 3-5 (minutes). The measured pH value of the chemical solution is 7.5 and the solution density is 0.99 (g/cm³).

The final water/cement ratio of the blended components was 0.410. The formed slump of cement paste was smooth and created a good cone. The mixed components were casted into concrete testing specimen molds prepared by different sized PVC pipes with different cylindrical size of 3″×6″, 1″×2″, 2″×4″ as form frame for casted specimen samples. To make the slump uniformly distributed into the test tube, a ramping rode was used to densify the mixed cement components for 25 times for each prepared sample. Then, the casted samples were immediately sealed with aluminum foils over 24 hr. before placed in water tanks for 7 days, then, left in air for 365 days, then, placed in water for another 100 days, exposed to air again for 38 days before submitted for testing compression following ASTM C39 and Brazilian Splitting tension test following ASTM C 496.

Of the average two of the prepared casting samples (4-179-2C-7, 4-179-2C-10), the tested samples for compressive strength had average actual dimension in length: 3.08″ in diameter, height: 5.99″, and length/diameter ratio: 1.99, actual breaking load: 50705 (lbs), ultimate stress: 6924 (PSI) and adjusted tension: 6895 (PSI) after 500 days. The modulus of elasticity of the tested samples was 437579 (PSI). The splitting tensile strength of the tested samples was 1338 (PSI). The average density of the tested sample was 2.297 (g/cm³). The porosity of the tested samples was 0.1333 if the particle density assumed to be 2.65 (g/cm³).

Example 5: Concrete Samples Prepared with Chemical Additives of Example 2 Incorporated: 730 (gram) of Portland cement (I/II GU Type), manufactured by TXI, was weighed, held in a container, then, about 220 (g) of 300 (gram) of purified water was first blended with 21.98 (gram) of chemical solution and/or additives from example 2, then, used the leftover water to rinse the wall of the container that held the chemical solution from example 2. Finally, all the 21.98 (g) chemical solution was blended with water and charged into a Hobart mixer. 984 (gram) of river fine sand (max size in length <0.50 mm) and 984 (g) of coarse aggregate sand (max. size in length <10.0 mm) purchased from Home Depot, were added into the mixer. The weighed Portland cement in the container was transferred into the mixer. Then, the whole mixer components were stirred first slowly, then, adding speed, finally with a maximum speed setting rate of 7, blended for about 3-5 (minutes).

The final water/cement ratio of the blended components was 0.410. The formed slump of cement paste was smooth and created a good cone. The mixed components were casted into concrete testing specimen molds prepared by different sized PVC pipes with different cylindrical size of 3″×6″, 1″×2″, 2″×4″ for casted specimen samples. To make the slump uniformly distributed into the test tube, a ramping rode was used to densify the mixed cement components for at least 25 times for each prepared sample. Then, the casted samples were immediately sealed with aluminum foils over 24 hr. before placed in water tanks for 7 days, then, left in air for 365 days, then, placed in water for another 100 days, exposed to air again for 38 days before submitted for testing compression following ASTM C39 and Brazilian Splitting tension test following ASTM C496

Of the average four of prepared casting samples (4-179-1c-1, 4-179-1c-2, 4-179-1c-4, 4-168-3), the tested samples for compressive strength had average actual dimension in length: 3.07″ in diameter, height: 5.81″, and actual breaking load: 56914 (lbs), ultimate compressive stress: 7738 (PSI) and adjusted compressive strength 7640 (PSI). The modulus of elasticity of the tested samples was 44525 (PSI). The Brazilian splitting tension is 1453 (PSI). The average density of the tested sample was 2.280 (g/cm³). The porosity of the tested samples was 0.140 if the particle density was assumed to be 2.65 (g/cm³).

TABLE 4
Chemical Additives used for Modifying the surface of Cement and
other concrete components

| | | 3-136-1 and 4-173-1 | | |
|---|---|---|---|---|
| Sample ID: | | Quantities | | |
| Items | Components | (g) | % w/w | Note: |
| 1 | 70 T Mineral oil | 38.96 | 6.49 | 3-136-1 and |
| 2 | Soy Protein isolate | 2.89 | 0.48 | 4-173-1 |
| 3 | Oil Based p-MDI solution | 3.85 | 0.54 | have the |
| 4 | FTZ 510/620 in powder | 2.4 | 0.40 | same recipe |
| 5 | Sweet Rice | 1.2 | 0.20 | different |
| 6 | Polysorbatan 60 MS NF | 6.27 | 1.05 | hatch |
| 7 | PEG100 Glyceryl stearate | 0.38 | 0.06 | |
| 8 | Water | 544.05 | 90.68 | |
| | Sum: | 600 | 100.00 | |

| | |
|---|---|
| | Procedures: |
| 1 | To a 1000 mL of beaker, charge (1) and (2) + (3) |
| 2 | Stir (1) + (2) + (3) mixed components under magnetic stir bar |
| 3 | Heat the mixture temperature to 140° F., then, charge (4) + (5), |
| 4 | Continuously increase the temperature to 150° F. or above |
| 5 | Charge (6) and (7) and blended for another 5 (minutes) |
| 6 | Cool dosn the mixture and reduce the temperature to room |
| | temperature |
| 7 | Add (8) and measure the viscosity of the final products |

Example 6: Assessment of Mechanical Performance of Tested Examples 3, 4, 5: Of the tested samples, the ultimate compressive strength (UCS) was calculated by the maximum breaking force divided by the area of compressed specimen per ASTM C39 for cylindrical samples. Plot of compressive stress as function of strain in (in/in) in control concrete cylindrical samples is shown in FIG. 3. After an initial linear portion lasts up to 1500 (PSI) stress load, the curve became non-linear with slightly large strain between 1500 (PSI) and 4000 (PSI) with a small, registered stress increased. The non-linearity is believed to be primarily a function of the coalescence of micro-cracks at the paste-aggregate interface. The ultimate stress was reached at 6000 (PSI). The testing results met the expected performance value as anticipated. The applicants believe that at a stress of 6000 (PSI), a large crack network was formed with the concrete. The strain was 0.10(%) at 4000 (PSI) and 0.15(%) at 6000 (PSI) that fitted the expected average values of regular concrete product performance.

At 4000 (PSI), the first crack in concrete was initialized, while at 6000 (PSI), extended cracking networks were generated with a significant failure of the tested samples. It seems that there were some of autogenous recoveries in the tested samples based upon the special treatment condition of tested samples. Since all the samples were placed in water tanker for 7 days before placed in air for 365 days. The samples were only fully cured under the best Pozzolan condition for 7 days. Therefore, it had a 4000 (PSI) of preliminary UCS. From 4000 (PSI) to 6000 (PSI), the achieved 2000 (PSI) strength might come from the post autogenous self-healing of natural cement recovery after left in water tanker for over 100 days after one year in the air.

TABLE 5
Measured Viscosity of Chemical Additives and Solutions Prepared by
Example 2

| Rotation Speed | Viscosity | Percentage of Efficiency |
|---|---|---|
| RPM | (CPS) | (%) |
| 6 | 424 | 42 5 |
| 12 | 352.4 | 70.7 |
| 30 | 199.8 | 99.9 |
| 60 | 100 | 99.9 |

In contrast, a plot of compressive stress as a function of strains of the examples 4, 6 shows sharp difference from the stress and strain curve of example 3 control. Concrete blended with chemical additives in examples 4 and 5 showed great advantages of its resistance to products strain failure. None of the samples failed at around 4000 (PSI). It has a full self-healing at the stress level of 4000 (PSI). The tested sample from example 5 will sustain the stress up to a strain (%) larger than 1.6(%), which is 10 times more than that from control sample from example 3. The breakup strain in SPI sample was more than 2.3(%), which is 15.0 times more than control sample from example 3.

The high strain failure resistance fits the characteristic behavior of viscoelastic materials. Practically speaking, the UCS developed in examples 5 can serve as a building block of high strength concrete materials. Further statistic study with one-way ANOVA of the tested samples listed in Table 6 suggests that at a 95% confident interval, the samples of example 5 incorporated with example 2 recipe significantly outperforms the ultimate compressive strength of control sample of example 3 statistically. In contrast, the samples of example 4 prepared with example 1 recipe shows somewhat enhancement in comparison of its UCS with control example, but not statistically significant.

Based upon the classification of products specification listed in table 1, products delivered by utilizing the recipe of exam 1 can be used for residential and commercial markets, of exam 2 in a high strength building project.

TABLE 6
One Way ANOVA of Measured Ultimate Compressive Stress (UCS) on the Tested Cylindrical Samples Per
ASTM C39

| Sample ID | Description | Mears (PSI) | StDev (PSI) | COV(%)) | Stat. [symbol] [symbol] = 0.05 |
|---|---|---|---|---|---|
| Exem 3 | 3 [symbol] × 6 [symbol] Cylindrical tube Cement Samples | 4996 | 1121 | 22.4 | 0 |
| Exem 2 | 3 [symbol] × 5 [symbol] Cylindrical tube Cement Samples | 6924 | 1875 | 27.1 | = |
| | incorporated with example 1 chemical additives | | | | |
| Exem 5 | 3 [symbol] × 6 [symbol] cyclindrical tube Cement Samples | 7738 | 534 | 6.9 | + |
| | incorporated with example 2 cherrical additives | | | | |

Note:
0 = baseline test value;
= stasistically equivalent,
+ statistically enhanced on its value. [symbol]
indicates data missing or illegible when filed

Besides the compressive strength, the modulus of resilience is also important parameter, it defines the amount of strain energy per unit volume (i.e., strain energy density) that a material can absorb without permanent deformation resulting in failure of the structure. It can be expressed as equation 3:

$$Modulus of Resillence ( MOR ) = \frac{Yield {Stress}^{2}}{2 Modulus of elasticity} \qquad ( 3 )$$

Toughness is another important material's property; it is defined as the ability of a material to absorb energy and plastically deform without fracturing. That is, the amount of energy per unit volume that a material can absorb before rupturing. This measurement of toughness is different from that used for fracture toughness later in the application, which describes load bearing capabilities of materials with flaws. It is also defined as a material's resistance to fracture when stressed.

Table 7 lists the calculated modulus of resilience and toughness of each tested sample, also, the relative comparison for each tested sample. Cylindrical sample materials of example 4 had its yield compressive strength increased by 84%, modulus of resilience increased by 42 times more than regular standard concrete, toughness increased by 9 times. More specifically, example 5, the compressive strength increased by 200(%), the MOR 52 times, relative toughness 15 times.

TABLE 7
Measured Performance Character with Selected Concrete Testing Speciemen

| | | Yield Stress | Relative CS | Modulus | Modulus of | Relative | | Relative |
|---|---|---|---|---|---|---|---|---|
| RUN ID | Sample ID | (PSI) | (%) | PSI | Resilience PSI | MOR | Tougness | Toughness |
| Exam 3 | 4-179-2c-1 | 4067 | 1.00 | 543521 | 15 | 1 | 461 | 1.00 |
| Exam 4 | 4-179-1c-4 | 7550 | 1.86 | 44585 | 639 | 42 | 4283 | 9.28 |
| Exam 5 | 4-168-3 | 8415 | 2.07 | 45127 | 785 | 52 | 6854 | 14.85 |

Note:
Modulus of Resillience = compressive stress ² / (2 MOE)

As a result, the added chemical additives significantly reduce the brittleness of the prescribed concrete materials and increased its elasticity and plasticizing capabilities before the materials are broken catastrophically in both the samples 4 and 5. The applicants believe that just as disclosed in the proposed self-healing mechanisms, Soy protein's viscoelastic properties with its α-helix coiled and β-sheet conglycinin components were successfully hybridized with the brittleness of concrete.

Example 7: Assessment of the Tested Sample's Fracture Cracking Resistance: Concrete cylindrical samples were prepared with a casting size of 2″×4″. The procedure for preparing the testing samples like examples 4 and 5 is comprised of weighing 352 (gram) of Portland cement (Type I/II GU), fine sand of 678 (gram), gravel of aggregates of 1205 (gram), tap water of 141 (gram), 22.0 gram of chemical additives from example 1 or 2 was blended with half of tap water. Then, the water containing the chemical additives was poured into a mixer, all cement was first added, then, the fine sand and the gravel of aggregates were added and blended for 2 minutes, then, all leftover water and chemical additives or solution added into the mixer and blended for 3-4 minutes with enough shearing of the mixed components. Then, the mixed components were molded into the 2″×4″ PVC pipeline. All samples were sealed into aluminum foils and air-dried at room temperature for 24 hr. before emerging in water tankers until the specimen were ready for testing. All samples were immersed in water tanker for over 365 days. Then, all samples were dried for at least one day before being tested with a special modified fracture testing procedure to obtain its critical stress intensity factor (SIF) as an alternative approach for determining the sample's self-healing capabilities.

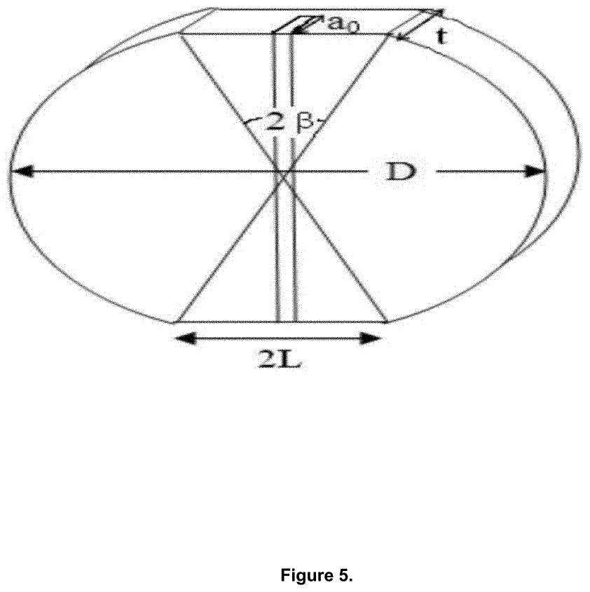

As shown in FIG. 5, the pre-sized samples were submitted for a modified Brazilian splitting tension test by carrying with diametrically opposite concentrated loads on a disc specimen. Both fracture toughness (K_{IC}) and tensile strength were assessed with the modified Brazilian tensile geometrical configuration as shown in FIG. 5. The test is comprised of making a notched sample having a groove with a length of a₀ in depth opened through one face of the disc along the loading axis. The critical fracture stress intensity factor (SIF) can be calculated using the following equation (4) based upon reference (Singh and Pathan 1988):

$${K}_{IC} = 1.264 F \frac{\sqrt[2]{{a}_{0}}}{tD} \qquad ( 4 )$$

where K_{IC} is the critical strength intensity factor (SIP) of the tested sample, F is the force placed on the one flattens face of the modified Brazilian disc sample, a₀ is the depth of notched in z axis, t the thickness of disc and D is the diameter of disc.

The calculated fracture critical stress intensity factor (SIF) of specimen prepared with the recipes of examples 2 and 3 is listed in table 8. It seems that the K_{IC} is a function of angle β. In both samples of 4-179-1T and 2T, at β=30 (degree), the K_{IC} has a maximum value of 5.967 (MPa m^{1/2}) for soy protein isolate and sweet rice encapsulated hydrogel emulsion and 6.802 (MPa m^{1/2}) for wax and sweet rice encapsulated hydrogel emulsion. The fracture toughness shows great variation in the tested samples due to variation of sample's notch size, density. Statistically, the difference of the fracture toughness are minor of the sample prepared with the recipe of example 1 vs. example 2 as listed in Table 8.

In addition to the fracture toughness, the Brazilian tensile strength of the tested samples was also determined by using equation 5 with a correction factor of tested sample (Yue, et al., 2006).

$${σ}_{t} = {Y}_{c} \frac{2 {P}_{max}}{π Dt} \qquad ( 5 )$$

where Y_{c}=0.2621 (t/D)+1, D is the diameter of the disc, t the thickness of the disc, Pₘₐₓ is the maximum breaking force placed on the flatten surface of the tested samples, σₜ is the tensile strength calculated based upon the Brazilian test method.

The Brazilian tensile strength (σₜ) for the sample prepared from example 5 had a tensile strength of 9.891 (MPa) with soy protein isolate and sweet rice incorporated in its recipe (example 2). In contrast, Brazilian splitting tensile strength (BSTS) of example 1 recipe is only 5.275 (MPa). As such, the BSTS prepared with example 2 recipe is 187(%) better than that of the prepared with example 1 recipe as listed in Table 9. Potential explanation is that non-covalent hydrogen bonds in the SPI/SR recipe are mainly accounted for enhanced performance of example 5.

TABLE 8
Modified Dia [symbol] al Compressive Test for Determining the Critical Stress Intensity Factor (S [symbol] F [symbol] )
Based upon the Modified Braz [symbol] an Test Method

| | | | | | | | | Pre-cut | | | | | |
|---|---|---|---|---|---|---|---|---|---|---|---|---|---|
| | | | | | | | Thick ( [symbol] ) | crack | | | Area | Density | K [symbol] (Mpa |
| Items | RUN ID | Type CA | Wt (g) | H (mm) | D (mm) | L (mm) | (mm) | (a) (mm) | F ( [symbol] ) | β | (mm²) | (g/cm³) | m [symbol] ) |
| 1 | 4-179-1T3 | | 121.5 | 46.5 | 52 | 26.5 | 12 | 12 | 26.89 | 30.7 | 2015.8 | 2.274 | 5.967 |
| 2 | 4-179-1T2 | | 136.5 | 48 | 52 | 31 | 13 | 12 | 28.3 | 36.6 | 2003.1 | 2.198 | 5.797 |
| 3 | 4-179-1T3 | Exam 2 | 111.8 | 45 | 52 | 24.5 | 12 | 3.5 | 19.32 | 28.1 | 2010.6 | 2.270 | 2.315 |
| 4 | 4-179-1T4 | Recipes | 123.4 | 48 | 52 | 25 | 6 | 2.5 | 25.05 | 28.8 | 2044.6 | 2.414 | 5.074 |
| 5 | 4-179-2T1 | | 117.16 | 46 | 52 | 26.5 | 8 | 7.5 | 25.85 | 30.7 | 2009.2 | 2.200 | 6.802 |
| 6 | 4-179-2T2 | | 104.5 | 45 | 52 | 23 | 11.5 | 3 | 21.13 | 26.3 | 2020.7 | 2.248 | 2.446 |
| 7 | 4-179-2T3 | Exam 1 | 109.6 | 47.5 | 52 | 25 | 12 | 3 | 28.65 | 28.8 | 2038.3 | 2.151 | 3.179 |
| 8 | 4-179-2T4 | Recipes | 141.6 | 47 | 52 | 30 | 12.5 | 2.5 | 25.71 | 35.3 | 1996.2 | 2.364 | 2.500 |

[symbol]

indicates data missing or illegible when filed

TABLE 9
Measured Br [symbol] azilian Tens [symbol] e Strength ( [symbol] ) with Modified Brizalian Test Configuration of the Samples as shown in Figure 5

| | | | | H | D | L | Thickness | Maximum | | Area | Density | BD Tensile | Ave. [symbol] |
|---|---|---|---|---|---|---|---|---|---|---|---|---|---|
| Items | Notebook ID | Type CA | Wt (g) | (mm) | (mm) | (mm) | (mm) | Force (KN) | β | (mm³) | (g/cm³) | (MPa) | (Mpa) |
| 1 | 4-179-1T2-1 | Exam 2 | 87.1 | 47 | 52 | 18 | 18 | 21.94 | 20.3 | 2067.8 | 2.340 | 8.79 | |
| 2 | 4-179-1T2-2 | recipe | 194.7 | 47 | 52 | 20 | 40 | 30.48 | 22.6 | 2058.9 | 2.354 | 10.99 [symbol] | 9.891 |
| 3 | 2-179-2T2-5 | | 86 | 48 | 52 | 18 | 18 | 9.70 | 20.3 | 2076.8 | 2.301 | 4.04 | |
| 4 | 4-179-2T2-6 | | 75.2 | 48 | 52 | 15 | 15 | 8.95 | 16.8 | 2087.0 | 2.402 | 4.47 | |
| 5 | 2-179-2T2-2 | Exam 1 | 133.1 | 48 | 52 | 23 | 23 | 19.40 | 26.3 | 2525.5 | 2.291 | 6.32 [symbol] | |
| 6 | 4-179-2T2-3 | recipe | 176.9 | 48 | 52 | 30 | 29 | 25.10 | 35.3 | 2694.5 | 2.264 | [symbol] .27 [symbol] | 5.275 |

[symbol]

indicates data missing or illegible when filed

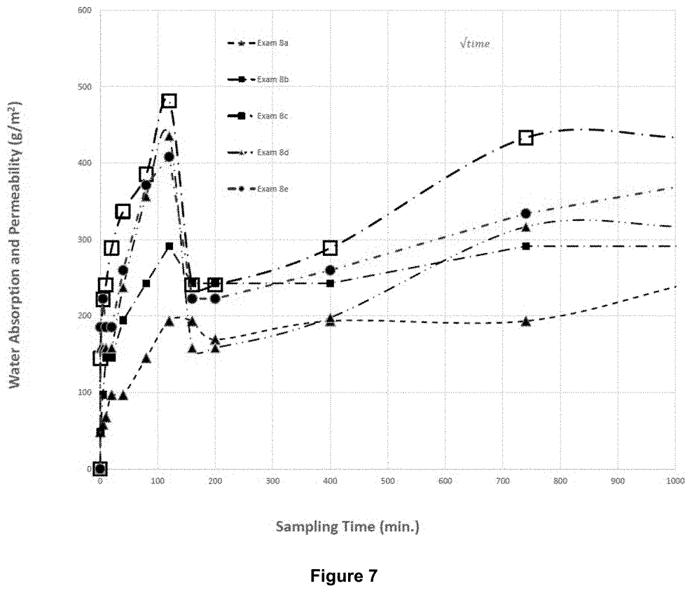

Example 8: Water Permeability of Selected Examples: The permeability is an important parameter useful for characterizing the performance of concrete products (Yang, 2019). A highly permeable concrete material, in general, implies that the concrete is highly shrinkable with low compressive strength and shortened life for the structural applications. Therefore, the samples tested in exam 7 were also submitted to water absorption and permeability test, in which 2″×2″ disc specimens were coated with wax on all surface except that only the bottom surface was immersed into water tanker in 1-2 mm distance in depth contacted with water surface. The water quantities absorbed or penetrated in the tested samples were determined by taking the sample out at special interval of 0.5, 5, 10, 20, 40, 60, 120, . . . 1000 (min.) measured with a balance having an accuracy of 0.001 (g). As shown FIG. 7, three stages of water gain seem self-evident that: 1) diffusion following the Lucas Washburn equation; 2) transition with swelling of the cement matrix; 3) water absorption of the cement following the first order of water absorption linearly.

In the initial diffusion process, the square root of sampling time should be proportional to the absorbed water quantities per square meter that can be expressed as equation (6).

$$l = {( \frac{r cos ( θ )}{2} )}^{1 / 2} {( \frac{γ}{μ} )}^{1 / 2} {t}^{1 / 2} \qquad ( 6 )$$

where L is the water molecular penetration distance from the cement surface into the porous body in porous micro-tubing structure, r is the radius of micro-capillary, μ the viscosity of solution, θ the contact angle of solid cement to liquid in the micro-capillary tube, t is the time for liquid water penetrating itself into the porous media of cement, γ⁻ the surface tension of liquid.

For long-term water absorption, the fitting model can be expressed as L is proportional to the sampling time as equation (7):

l=at+b (7)

Since the liquid mass can be expressed as, m=L s ρ, a permeability K can be obtained from equations (8) and (9) and simplified into the following two fitting model equations:

P₁=K₁\sqrt{t}+B₁ (8)

P₂=K₂t+B₂ (9)

Where P₁ is micro-capillary pressure driving permeability mass gained, K₁ is a fitting constant for permeability rate, B1 is the interception of diffusion related permeability, P₂ is the long-term diffusion rate, K₂ is the long-term diffusion constant, B₂ is the constant for long-term diffusion of tested samples.

TABLE 10
Measured Water Absorption & Permeability on the Surface of the Cement Samples

| | | | Water Absoprtion & Permeability on the Surface of Samples (g)/m² | | | | |
|---|---|---|---|---|---|---|---|
| | | | Exam 8a | Exam 8b | Exam 8c | Exam 8d | Exam 8e |
| | | | Notebook ID (2020-RB1-210-) | | | | |
| | | | 1T2-1 | 1T2-2 | 2T2-1 | 2T2-2 | 2T2-3 |
| | | | Surface Area (m²) | | | | |
| Time (min.) | [symbol] | Model fitting | 0.002067 | 0.0020589 | 0.0020768 | 0.002525 | 0.002694 |
| 0 | 0 | | 0 | 0 | 0 | 0 | 0 |
| 0.5 | 0.71 | | 48.4 | 48.6 | 144.5 | 158.4 | 185.6 |
| 5 | 2.24 | | 58.1 | 97.1 | 221.5 | 158.4 | 222.7 |
| 10 | 3.16 | | 67.7 | 145.7 | 240.8 | 158.4 | 185.6 |
| 20 | 4.47 | | 96.8 | 145.7 | 288.9 | 158.4 | 185.6 |
| 40 | 6.32 | | 96.8 | 194.3 | 337.1 | 237.6 | 259.8 |
| 80 | 8.94 | | 145.1 | 242.8 | 385.2 | 356.4 | 371.2 |
| 120 | 10.95 | | 193.5 | 291.4 | 481.5 | 435.6 | 408.2 |
| 160 | 12.65 | | 193.5 | 242.8 | 240.8 | 158.4 | 222.7 |
| 200 | 14.14 | | 169.3 | 242.8 | 240.8 | 158.4 | 222.7 |
| 400 | 20.00 | | 193.5 | 242.8 | 288.9 | 198.0 | 259.8 |
| 740 | 27.20 | | 193.5 | 291.4 | 433.4 | 316.8 | 334.1 |
| 1020 | 31.94 | | 241.9 | 291.4 | 433.4 | 316.8 | 371.2 |
| k1 | from | | 13.727 | 25.584 | 37.528 | | |
| b1 | 0 to 80 | P₂ = k₁ | 22.391 | 30.428 | 92.558 | | |
| r² | (min.} | sqrt(time) + b₁ | 0.9107 | 0.9408 | 0.8509 | | |
| k2 | from 100 | | 0.0595 | 0.0672 | 0.2573 | 0.2116 | 0.1822 |
| b2 | to 1020 | | 168.39 | 228.41 | 197.78 | 123.06 | 190.27 |
| r² | (min.) | P₂ = k₂ (time) + B₂ | 0.6842 | 0.867 | 0.9236 | 0.9236 | 0.9972 |

| | | | |
|---|---|---|---|
| Date: | Self-healingTest & | 8/3/2021 | 8/3/2021 |
| | permeabily after pre-crack: | [symbol] | [symbol] |

[symbol]

indicates data missing or illegible when filed

In the transition stage, a sharp increase of water mass gain occurred after 80 (minutes) of the water soaking test. The mechanisms of the absorption mass increase were unknown, potentially due to inertia and porous structural influence or it might be due to a swelling of cement micro-capillary tubes after being soaked long enough. As a result, the data from 75 (minutes) to 100 (minutes) was excluded from the modelling equation. After 120 (minutes), the mass gain from the samples immersed in water tank follows the 1^{st} order of reaction instead of the Lucas Washburn diffusion process. The common consent is that there should be more autogenous self-healing reaction occurring in exam 8b. The interaction of the chemical additives originated from exam 8b and carbon dioxide or calcium ion was stronger than from exam 8a.

As shown in FIG. 7, if the co-relationship (r²) listed in Table 10 as a criterion for determining whether the samples follow special wicking processes, it seemed that the samples of made of example 2 recipe as core and hydrogel polymer as shell (exam 8a, 8b, and 8c) follows the Lucas-Washburn diffusion more closely than exam 8d, 8e in the initial stage of permeability test. In contrast, samples made of exam 8d, 8e are hydrophobic in the initial stage, resistant to wetting out the cement matrix materials. It follows the 1^{st} order reaction model of more closely.

Example 9: Assessment of Self-healing of Pre-cracked Samples: Self-healing capability is critical for enhancing the durability of concrete products. Of the 5 samples from example 8, exam 8a and exam 8c were selected and pre-cracked at a special proof load. The samples after being cracked were defined as exam 9a and exam 9b. Other samples of exam 8b, 8d, and 8e were fully broken up with Brazilian test standard and their maximum tensile Strength was determined. The results of BSTS of the tested samples were listed in Table 8. In this disclosure, the self-healing capabilities of these pre-cracked samples are assessed by determining the water permeability and Brazilian Splitting Tensile Strength (BSTS) of both samples.

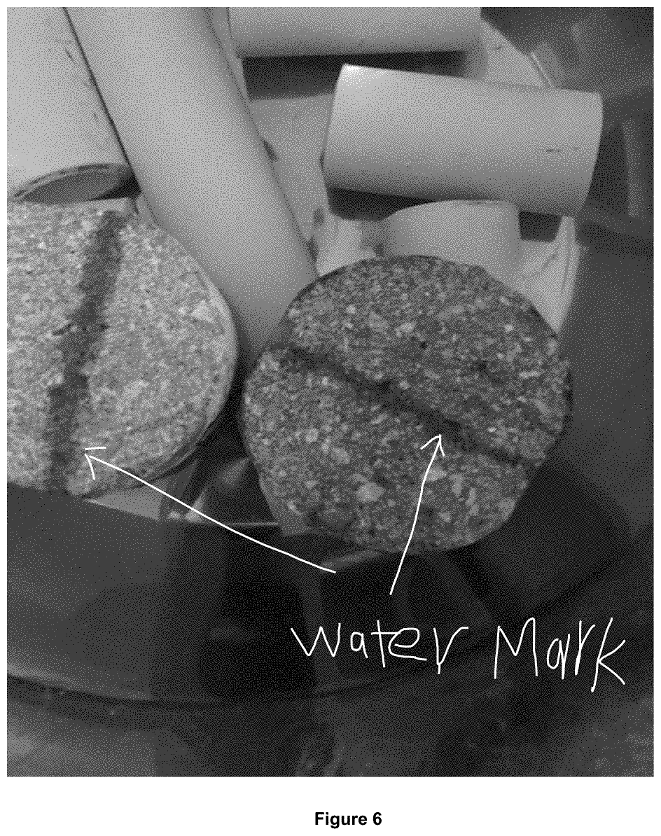

Self-healing Capabilities Determined by Water Permeability: As shown in FIG. 6, water lines from its seeping out of the immersed water tanker of the exam 9a and 9b clearly demonstrated that the significant cracks present here along the whole section cross the sample surface perpendicular to the flatten edge sections after being pre-cracked. Water permeability test was conducted in both two samples. It is showed that the samples after being pre-cracked were filling water in its micro-capillary tubes much quickly. Within 10 (minutes), diffusion controlled wicking processes dominate the process. The Lucas Washburn equation can be used to obtain a linear plot of permeable water quantities vs. \sqrt{time}. Within 120 (minutes), the samples were soaked with water cross its microstructure.

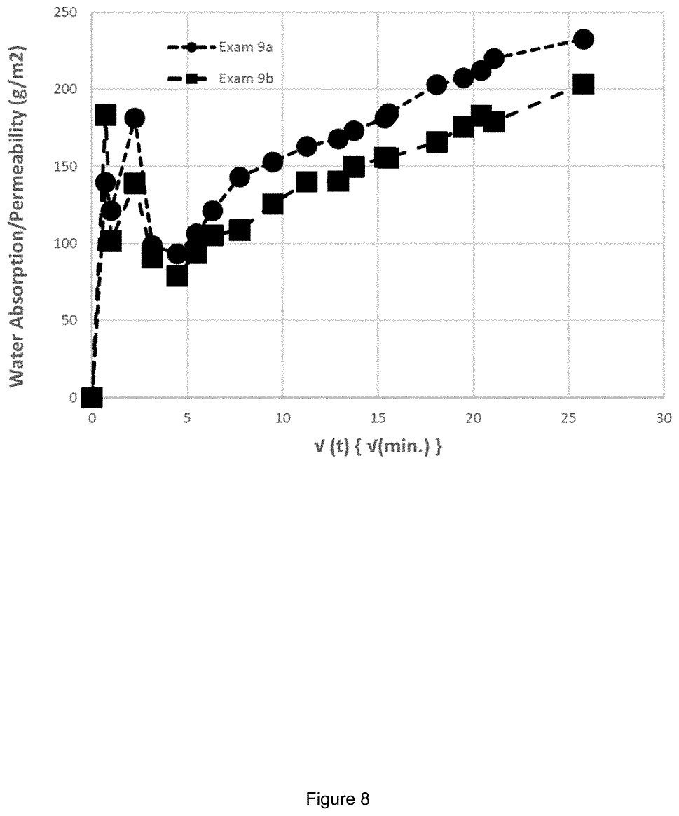

As showed in FIG. 8, if the initial wicking process was considered as key water permeability for controlling the self-healing processes, the water dissolved with CO₂ and cationic ion such as calcium will be much easily penetrated the micro-capillary tubes in exam 9a than exam 9b samples. The test results of water permeabilities on both samples of exam 9a and 9b after pre-cracking are listed in Table 11.

In the initial stage of water perm, the pre-cracked samples of examples:
a. P(exam 9a)=120.59 K1+6.5.
b. P(exam 9b)=152.74 K1+65.7.

The pre-crack % can be calculated following equation (10):

$$Precrack \% = \frac{Pre - cut crack in width}{Crack size in width before break\_up} = ( \frac{K 1 ( after )}{K 1 ( before )} ) \times 100 \qquad ( 10 )$$

where K1 (before) is the rate of water permeability of tested sample before pre-cracking; K1(After) is the rate of water permeability of the tested sample after the pre-cracking test.
a. K1(exam. 8a)=13.73 (Table 10); K1(exam 9a)=120.59 (see Table 11)
b. Pre-cracking (%)(exam 9a)=(120.59/13.73)=878
c. K1(exam. 8c)=37.54 (Table 10); K1(exam 9b)=152.73 (See Table 11)
d. Pre-cracking (%) (exam 9b)=406

Interestingly, although % increase of water permeability from exam 9a is two times more than exam 9b, it still had less water permeability in the whole of total than exam 9b since:
K1 (perm of exam 9a)=120.59 (g/m² min),
K1 (perm of exam 9b)=152.73 (g/m² min.).

The above results clearly demonstrate that before being cracked, the concrete block coated with soy protein is much more water resistant than with waxy due to its tightened microstructure with less porosity.

Table 13 lists the water permeability test results after both specimens were placed in a water tanker for self-healing of 30 days at room temperature. After water soaking treatment, both was placed in the outdoor condition for over 15 days before measuring their water permeability by simple gravimetric method again. The applicants believe that the pre-cracked specimens of Exam. 9a and exam. 9b underwent an extensive hydration within the water tanker for self-healing its cracks. Both soy protein and sweet rice and hydrogel polymers play crucial roles in enhancing the recovery of damaged interphase zone cross the cement and sand/aggregates.

TABLE 11
Measured Water Permeability of Pre-cracked Specimen Before
Self-Healing (August 5th, 2021)

| | Example 9a | Example 9b |
|---|---|---|
| Notebook ID | 2020-RB1-214-1T2-1 | 2020-RB1-214-2T2-1 |
| Time (min.) | Measured Specimen Weight (g) in Water Container | |
| 0 | 167.9 | 120.9 |
| 0.5 | 168.131 | 121.414 |
| 5 | 168.403 | 121.796 |
| 10 | 158.736 | 121.962 |
| 20 | 168.65 | 121.932 |
| 40 | 158.721 | 122.018 |
| 80 | 158.739 | 121.977 |
| 120 | 158.757 | 122.115 |
| | Surface Area Measured on Each Specimen (mm²) | |
| | 2050 | 2058 |
| Time (min.) | Calc. Water Absorption and Permeability (g/m²) | |
| 0 | 0 | 0 |
| 0.5 | 112 | 249 |
| 5 | 244 | 433 |
| 10 | 406 | 514 |
| 20 | 364 | 499 |
| 40 | 399 | 541 |
| 120 | 407 | 521 |

Model Fitting with Lucas Washburn Equation

| | | |
|---|---|---|
| K1: | 120.59 | 152.73 |
| B1: | 5.5 | 65.7 |
| r²: | 0.9803 | 0.924 |

TABLE 12
Measured Brizailian Tensile Strength ( [symbol] ) to Achieve the Pre-crack with Partial Failure without
Total break-up of the Tested Samples

| | | | | | | | Thick- | Maximum | | | | BD | Pre- |
|---|---|---|---|---|---|---|---|---|---|---|---|---|---|
| | | Type | | H | D | w | ness | Force | | Area | Density | Tensile | crack |
| Items | Notebook ID | CA | Wt (g) | (mm) | (mm) | (mm) | (mm) | (KN) | β | (mm²) | (g/cm³) | (MPA) | % ( [symbol] ) |
| Exam 9a (exam 8a) | 4-173-1T2-1 | Exam 2 | 167.8 | 48 | 52 | 22 | 35 | 18.31 | 25.0 | 2060.0 | 2.327 | 6.24 | 878.0 |
| Exam 9b (exam 8c) | 4-173-2T2-1 | Exam 1 | 120.9 | 48 | 52 | 20 | 25 | 25.09 | 22.6 | 2068.9 | 2.337 | 9.40 | 404.9 |

Note: [symbol]
Calculated pre-crack percentage. [symbol]
indicates data missing or illegible when filed

Quantitatively, the calculated permeability parameter K1 as listed in Table 13 is equivalent to 6.401 (g/m² min.) for exam 9a and 5.529 (g/m² min.) for exam. 9b. Since K1 is proportional to the porosity of porous media (Yang, 2019), the closed channels can be considered as % self-healing efficiency (SHE) of the tested samples estimated as:

SHE(exam. 9a)=(1−6.401/13.73)×100+100=151.6(%) for soy-based recipe.

SHE(exam. 9b)=(1−5.529/37.54)×100+100=185.3(%) for wax/sweet rice-based recipe.

Based upon the above analysis, it is self-evident that after the cracked samples placed in water tanker for one month, both samples of exam 9a and 9b are sealed with less porosity and with tightened microstructure.

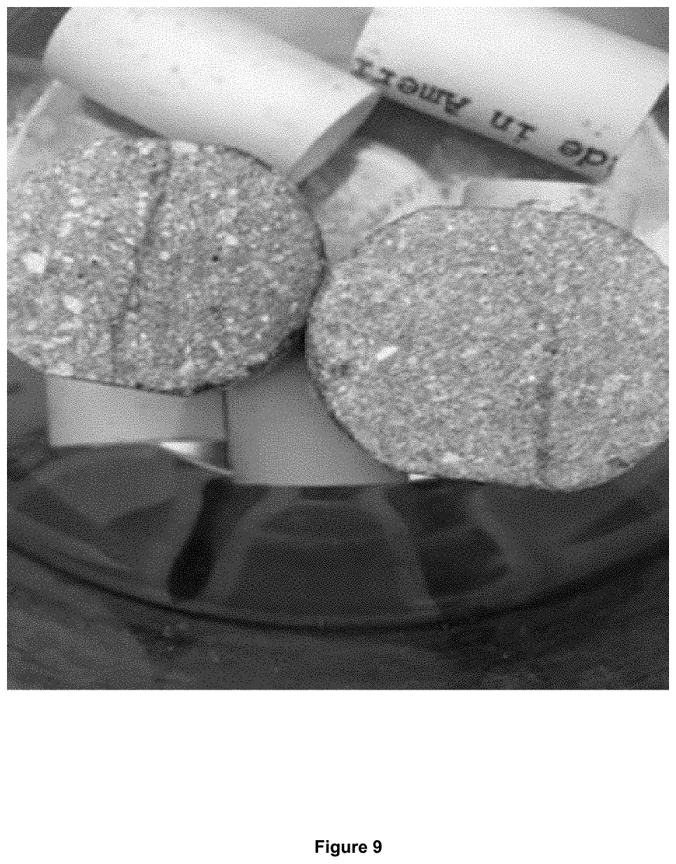

An imaging photo of the tested specimens (exam 9a and exam 9b) is shown in FIG. 9 after both were soaked in water tanker for over one hour to run the water permeability study. The water marks along the cracking line on the surface of both specimens are much smaller and less intensive than these of pre-cracked identical specimens shown in FIG. 6 before water self-healing in water tanker. Evidently, the ingress and pathways of water to penetrate itself through opened micro-cracked channels are effectively blocked by the self-activated bonding interface across the cement and sand/aggregates.

In conclusion, both the SPI/SR/PU recipe (example 2) and Wax/SR/PU recipe (example 1) provides more than 150(%) self-healing capability to the cracked samples if water permeabilities are used as the tools of assessment. The cracks pre-cracked in the samples of exam 9a and 9b were fully closed with tightened microstructure of tested samples.

Self-Healing Capabilities Determined by Brazilian Splitting Tensile Strength (BSTS): In term of mechanical property of self-healing, Table 14 summarizes the calculated average tensile strength of cracked samples after being placed in water tanker for recovery within one month (30 days). The tested results have the following Brazilian splitting tensile strength (BSTS): BSTS (exam. 9a)=8.75 (MPa) and BSTS(exam. 9b)=6.01 (MPa).

Although not totally understood, it is believed that the soy protein and sweet rice components and its interaction with other chemical additives in the formulated recipe is a critical factor that enhances the performance of final concrete products. A self-healing efficiency (SHE) (δ) based upon the Brazilian splitting tensile strength (BSTS) can be defined as shown in equation (11):

$${δ}_{m} = \frac{{σ}_{after healing}}{{σ}_{virgin}} \times 100 ( \% ) \qquad ( 11 )$$

where δₘ is the self-healing efficiency (SHE) per mechanical property; σ_{after healing} is the tensile strength of the tested samples after 28 days healing in water tanker; σ_{virgin} is the tensile strength of the tested samples before being cracked of the virgin samples.

If the BSTS data listed in Table 9 is used as the virgin tensile strength for exam 9a and 9b, the self-healing efficiency for both samples can be calculated using equation (11) as:

δₘ (exam 9a)=8.75 (Mpa)/9.891 (Mpa)=88.5(%)

δₘ (exam 9b)=6.01 (Map)/5.275 (MPa)=114.0(%)

The summarized SHE for both exam 9a and 9b are listed in Table 14.

Example 10: Charactering Hydro Nano/Textured and/or Dual Phobic Dot Domains of Coated Thin Film on the solid Surface: Droplet dosage level of selected coatings from example 1 was spread on a glass plate with thin layer coatings. After dried at room temperature of 78° F. for over one week or so, the coated thin film coatings were characterized by a sessile droplet method, in which a droplet of purified bottle water was first pumped into a micro-syringe, then, the mass of the water microdroplet was measured with a micro-balance (0.001 (g)). The mass of the droplet was used as a controllable variable in the test. The size of the water droplet can be calculated if the water droplet is assumed to be a perfect spherical shape. In addition, the static contact of the droplet (θ) toward the solid surface interface was determined by taking instant photos with iPhone image. Then, the contact angle of the droplets was determined by analyzing the droplet shape of images. In addition, once the droplet was placed on the coating surface, it was tilted with an angle of (α) that can be registered by an angle meter synchronized with the glass flatten plate movement. The tilt angle is also called as a pinning angle that is the droplet breakup transition angle sticked on the glass plate surface or rolled out of the glass plate surface.

TABLE 13
Water Permeability of Specimens after Being Self-Healed for One
Month

| | | Exam 9a | Exam 9b |
|---|---|---|---|
| Time (min.) | vtime | Water Permeability (g/m²) | |
| 0 | 0 | 0 | 0 |
| 0.5 | 0.71 | 139.8 | 183.5 |
| 1 | 1.00 | 121.4 | 101.6 |
| 5 | 2.24 | 181.4 | 139.2 |
| 10 | 3.16 | 98.7 | 91.0 |
| 20 | 4.47 | 93.4 | 79.0 |
| 30 | 5.48 | 106.4 | 93.9 |
| 40 | 6.32 | 121.4 | 105.5 |
| 60 | 7.75 | 143.2 | 108.8 |
| 90 | 9.49 | 152.9 | 125.7 |
| 127 | 11.27 | 163.0 | 140.1 |
| 167 | 12.92 | 167.9 | 140.6 |
| 189 | 13.75 | 173.2 | 149.7 |
| 236 | 15.36 | 181.4 | 156.0 |
| 242 | 15.56 | 184.3 | 155.5 |
| 327 | 18.08 | 203.2 | 166.1 |
| 380 | 19.49 | 207.5 | 175.8 |
| 417 | 20.42 | 212.4 | 183.0 |
| 445 | 21.10 | 220.1 | 179.1 |
| 665 | 25.79 | 232.7 | 203.7 |

Fitting Parameters with Washburn Lucas Model

| | | |
|---|---|---|
| K1: | 6.401 | 5.529 |
| K2: | 82.44 | 67.8 |
| r²: | 0.959 | 0.973 |

TABLE 14
Measured Brazilian Splitting Tensile Strength (BSTS) Ultimate Compressive Strength
After Self-Healing in Water Tanks for One Month

| | Notebook | | | H | D | w | Thickness | Maximum | | Area | Density | BD Tensile | |
|---|---|---|---|---|---|---|---|---|---|---|---|---|---|
| Titems | ID | Type CA | Wt (g) | (mm) | (mm) | (mm) | (mm) | Force (KN) | β | (mm [symbol] ) | (g/cm³) | (MPa) | (SHE) δ-(%) |
| Exam 9a | NB232-1 | Exam 2 | 167.6 | 48 | 52 | 22 | 35 | 25.7 | 25 | 2060 | 2.327 | 8.75 | 88.5 |
| Exam 9b | NB232_2 | Exam 1 | 120.9 | 48 | 52 | 20 | 25 | 16.04 | 22.6 | 2068.9 | 2.337 | 6.01 | 114 |

[symbol]

indicates data missing or illegible when filed

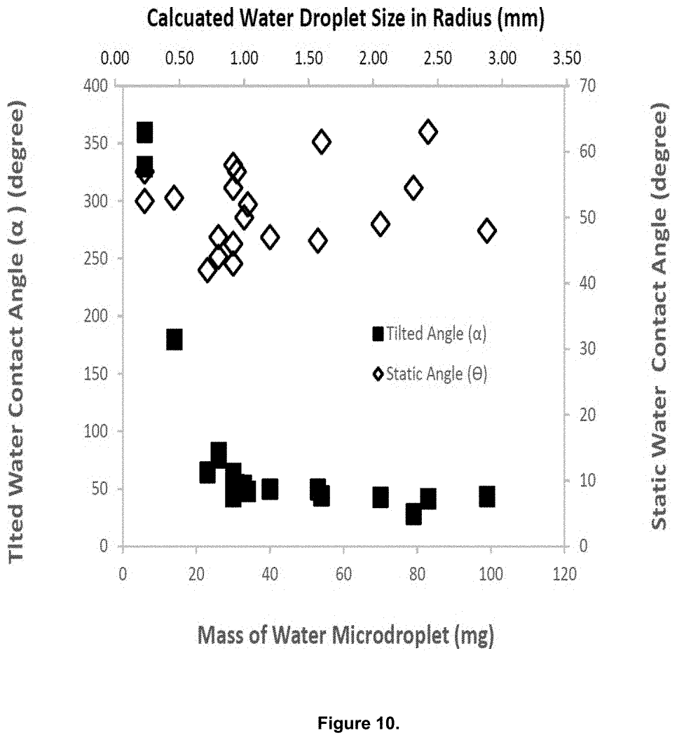

Both the measured static contact angle and tilted angle are listed in Table 15. A plot of static angles and tilted angles as a function of droplet mass is shown in FIG. 10. Of the 20 measured contact angles, an average static contact angle of the coatings is 51 (degree). Standard deviation of static contact angle is about 6 (degree). The variation of static contact is independent upon the size of water microdroplets based upon the plot of FIG. 10. The coating is either hydrophilic or hydrophobic based upon current industrial definition, kinds of in-between as an intermediate. However, as the tilted angle is plotted as a function of water microdroplet mass, it is a function of water microdroplet mass and scale in dimension.

As the water droplet is less than 30 (mg), equivalent to a spherical size in radium about 1.0 (mm), the tilted contact angle is dramatically increased without breakup or pinning at a water droplet radius in size of less than 0.5 (micron). The coatings show a super hydrophobicity with contact angle larger than 130 (degree). The specifical surface area exposed to the air becomes significantly increased. The coatings tend to provide more hydrophobic textured porous surface to the water droplet, leading to super hydrophobic. However, it does not allow the micro-droplet off the coating surface. This is fundamentally different from the mechanisms of Lotus leaf types wetting phenomena. In that case, the coating surface is super hydrophobic as the contact angle is larger than 90 (degree). Say 130 (degree).

The driver for microdroplet off the leaf surface is the low surface energy bubble in the leaf microstructure. As such, microdroplet will instantly roll off the coated solid surface in the lotus leaf. However, in the disclosed coatings, as the water microdroplet size is less than 0.50 (micron), tilted angle of microdroplet is 180 or more, the water microdroplet will not roll off the glass plates. In contrast, it suspended itself on the leaf or glass plate as the size of water droplet in radius is smaller than that of 1.0 (mm). The coatings behave in a superior hydrophilic manner absorbed on the leaf although it has a tilted contact angle of more than 180 (degree).

On other hand, as the microdroplet size is increased beyond 30 (mg) with a particle size of more than 1.00 (mm) in radius, It has breakup and pining contact angles around 45-50 (degree). It will perform just like regular static contact angle and rolling off the glass plate. The coatings will not hold excessive water. The coatings have a superiority of slipperiness. It behaves in a superior hydrophobic manner based upon the current wettability definition; however, it is hydrophilic in nature.

Structurally in micro/nano scales, different from lotus leaf, the coating used the conceived water or nonpolar solvent under its porous network as intimate contact interface. The water and non-polar solvent were settled in the nano/textured pockets or valley instead of entrapped air bubbles in the lotus leaf. The soy proteins or modified soy proteins and wax serves as hydrophobic domains with nanotextured ridges and porous frame for the coatings. A reorientation of the SPI and sweet rice functional groups or switching could potentially turn the coatings from hydrophobic into hydrophilic, versus visa, in response to the environmental condition.

As such, depending upon the microdroplet size and dimension, the SPI and sweet rice components serve as a hydro-phobic dual dot domain material in response to make an adaption of its wetting to environmental condition. As shown in FIG. 2(g), the tine micro voids around the interphase zone of sand/aggregate and cement matrix could potentially reduce the impact force placed on concrete to achieve the instant high early age compressive strength. The coatings can be defined as a coated surface having its static contact angle larger than 30 (degree) and less than 90 (degree) and a tilted angle larger than 20 (degree). Preferred tilt angle is larger than 45 (degree) as slippery coatings and water microdroplet size of from 0.01 (mm) to 5.00 (mm) in radius.

To assess how the added chemical additives on the concrete performance, a series of experimental mix and concrete blocks were prepared using general cement, fine sand, aggregate, chemical additives, mixed with water at targeted water cement ratio, were carried out with different curing time by days of 1, 3, 7, 14, 28 days, 2 months, and 3 months. Different cement and replacement of fly ash with silica quartz, or frac sands used in hydraulic fracking operation, were also explored. Benefits of these cement combination are explained in brief in examples 11 to 18.

Example 11: Miscellaneous Hydraulic-Cement Concrete Products with Disclosed Chemical Additives as Key Ingredients: 730 (gram) of Portland cement (I/II GU Type), manufactured by TXI, was weighed, held in a container, then, about 300 (gram) of purified water was first charged into a Hobart mixer. 984 (gram) of fine sand (max size in length <0.50 mm), and 984 (g) of coarse aggregate (max. size in length <10.0 mm) purchased from Home Depot, were subsequently added into the mixer. The weighed Portland cement in the container was transferred into the mixer. Then, the whole mixer components were stirred first slowly, then, adding speed of blending, finally with a maximum speed setting rate of 7, blended for about 3-5 (minutes).

The final water/cement ratio of the blended components was 0.41. The formed slump of cement paste was smooth and created a good cone. The mixed components were casted into concrete testing specimen molds prepared by different sized PVC pipes with different cylindrical size of 1″×2″, 1.5″×3″ as frame for casted specimen samples. Total numbers of samples prepared were 32. To make the slump uniformly distributed into the test tube, a ramping rode was used to densify the mixed cement components for 25 times for each prepared sample. Then, the casted samples were immediately sealed with aluminum foils over 24 hr. then, left in water for 1 days, 7 days, 14 days, and 28 days before submitted for testing.

TABLE 15
Measured Static Contact Angle (θ) and Tilted Contact Angle (α)
(pinning Angle) from the coating Film on a Flat Glass Plate

| | | Droplet | Static | Tilted | |
|---|---|---|---|---|---|
| Test | | Wt | Angle (θ) | Angle (α) | |
| RUN | Sample ID | (mg) | Degree | Degree | Note (Tilted) |
| 1 | NB225-1 | 6 | 53 | 360 | Suspended/upside- |
| 2 | NB225-2 | 53 | 47 | 50 | down |
| 3 | NB225-3 | 40 | 47 | 50 | |
| 4 | NB225-4 | 79 | 55 | 28 | |
| 5 | NB225-5 | 99 | 48 | 44 | |
| 6 | NB225-6 | 30 | 55 | 64 | |
| 7 | NB225-7 | 54 | 62 | 44 | |
| 8 | NB225-3 | 31 | 57 | 54 | |
| 9 | NB225-9 | 6 | 57 | 330 | Suspended/upside- |
| 10 | NB225-10 | 26 | 44 | 77 | down |
| 11 | NB225-11 | 23 | 42 | 65 | |
| 12 | NB225-12 | 14 | 53 | 180 | Suspended/upside- |
| 13 | NB225-13 | 26 | 47 | 82 | down |
| 14 | NB225-14 | 30 | 43 | 53 | |
| 15 | NB225-15 | 30 | 46 | 48 | |
| 16 | NB225-16 | 83 | 63 | 41 | |
| 17 | NB225-17 | 70 | 49 | 43 | |
| 18 | NB225-18 | 30 | 58 | 44 | |
| 19 | NB225-19 | 33 | 50 | 53 | |
| 20 | NB225-20 | 34 | 52 | 48 | |
| | Ave. | 40 | 51 | 88 | |
| | Stdeva.: | 25.5 | 6.0 | 93 | |
| | COV (%): | 64.0 | 12 | 106 | |

A micro Instron lab test machine was used to determine the total force of the tested sample at a fixed displacement rate of 35 (PSI)/sec. The unconfined ultimate compressive strength (UCS) was determined calculated from equations 12:

$${σ}_{UCS} = \frac{{F}_{t}}{A} \qquad ( 12 )$$

where Fₜ is the total force of being placed on the top surface of tested cylindrical sample; A is the surface area of the cross-section; σ_{ucs} the ultimate compressive strength (UCS) of cylindrical samples as it broken up.

The tested sample had a notebook ID of 90A-1. All the tested samples had a diameter of 1″ in size and roughly 2″ in length. The mean of ultimate compressive strength (UCS) from three individual testing samples is reported as follows: 1904 (PSI) at 1 day, 4572 (PSI) @ 7 days; 3358 (PSI) @ 14 days; 4823 (PSI) @ 28 days.

In addition, the tensile strength of the samples was also determined by breaking at least three of individual samples with Brazilian tensile test protocol and calculated following the equation 3 with only Brazilian disc without notched groove geometry only. The mean of testing results is listed here: 344 (PSI) @ 1 day; 726 (PSI) @ 7 days, 936 (PSI) @ 14 days, 1084 (PSI) @ 28 days.

Example 12. 730 (gram) of Portland cement (I/II GU Type), manufactured by TXI, was weighed, held in a container, then, 21.98 (g) of 3-100-1 chemical additives were blended with 150 (gram) of water, then, adding about 150 (gram) of purified water was charged into a Hobart mixer. 984 (gram) of fine sand (max size in length <0.50 mm), and 984 (g) of coarse aggregate sand (max. size in length <10.0 mm) purchased from Home Depot, were subsequently added into the mixer. The weighed Portland cement in the container was transferred into the mixer. Then, the whole mixer components were stirred first slowly, then, adding speed, finally with a maximum speed setting rate of 7, blended for about 3-5 (minutes).

The final water/cement ratio of the blended components was 0.41. The formed slump of cement paste was smooth and created a good cone. The mixed components were casted into concrete testing specimen molds prepared by different sized PVC pipes with different cylindrical size of 1″×2″, 1.5″×3″ as form frame for casted specimen samples. Total numbers of samples prepared were 32. To make the slump uniformly distributed into the test tube, a ramping rode was used to densify the mixed cement components for 25 times for each prepared sample. Then, the casted samples were immediately sealed with aluminum foils over 24 hr. before placed in water tanks for 7 days, then, left in water for 1 days, 7 days, 14 days, and 28 days before submitted for testing.

The measured mean of ultimate compressive strength is 4198 (PSI) @ 1 days; 4687 (PSI) @ 7 days; 3632 (PSI) @ 14 days; 3754 (PSI) @ 48 days. The measured Brazilian splitting tensile strength is 999 (PSI) @ 1 days; 909 (PSI) @ 7 days; 962 (PSI) @ 14 days; and 668 (PSI) @ 28 days, 437 (PSI) @ 70 days. The density of the samples is 2.414 (g/cm³) and the porosity is 0.089.

Example 13: 730 (gram) of Portland cement (I/II GU Type), manufactured by TXI, was weighed, held in a container, then, about 300 (gram) of purified water was first charged into a Hobart mixer. 984 (gram) of fine sand (max size in length <0.50 mm), and 984 (g) of coarse aggregate sand (max. size in length <10.0 mm) purchased from Home Depot, were subsequently added into the mixer. The weighed Portland cement in the container was transferred into the mixer. Then, the whole mixer components were stirred first slowly, then, adding speed, finally with a maximum speed setting rate of 7, blended for about 3-5 (minutes).

The final water/cement ratio of the blended components was 0.41. The formed slump of cement paste was smooth and created a good cone. The mixed components were casted into concrete testing specimen molds prepared by different sized PVC pipes with different cylindrical size of 1″×2″, 1.5″×3″. Total numbers of samples prepared were 32. To make the slump uniformly distributed into the test tube, a ramping rode was used to densify the mixed cement components for 25 times for each prepared sample. Then, the casted samples were immediately sealed with aluminum foils over 24 hr. before left in water for 3 days, 38 days, 45 days, 52 days before submitted for testing.

The measured mean of ultimate compressive strength is 3279 (PSI) @ 3 days; 3851 (PSI) @ 38 days; 3088 (PSI) @ 45 days; 5055 (PSI) @ 52 days. The measured Brazilian splitting tensile strength is 971 (PSI) @ 3 days; 1439 (PSI) @ 38 days; 900 (PSI) @ 45 days; and 1000 @ 52 days. The density of the samples is 2.356 (g/cm³) and the porosity is 0.111.

Example 14: 730 (gram) of Portland cement (I/II GU Type), manufactured by TXI, was weighed, held in a container, then, about 150 (g) of 280 (gram) of purified water was first blended with 21.98 (gram) of chemical solution and/or additives from example 1, then, used the left-over water to rinse the wall of the container that held the chemical solution from example 1. Finally, all the 21.98 (g) chemical solution will be blended with water and charged into a Hobart mixer. 519.3 (gram) of fine sand (max size in length <0.50 mm), and 563.9 (g) of coarse aggregate sand (max. size in length <10.0 mm) purchased from Home Depot, were added into the mixer, first, then, 276.7 (g) standard frac sand of 40/70, and 608.1 (gram) of 100 mesh frac sand, donated from High Roller Corporate's mill, were added into the mixer. The weighed Portland cement in the container was transferred into the mixer. Then, the whole mixer components were stirred first slowly, then, adding speed, finally with a maximum speed setting rate of 7, blended for about 3-5 (minutes).

The final water/cement ratio of the blended components was 0.41. The formed slump of cement paste was smooth and created a good cone. The mixed components were casted into concrete testing specimen molds prepared by different sized PVC pipes with different cylindrical size of 1″×2″, 1.5″×3″. Total numbers of samples prepared were 32. To make the slump uniformly distributed into the test tube, a ramping rode was used to densify the mixed cement components for 25 times for each prepared sample. Then, the casted samples were immediately sealed with aluminum foils over 24 hr. before placed in water tanks for 7 days, then, left in water for 1 days, 7 days, 14 days, and 28 days before submitted for testing.

The average value of ultimate compressive strength of three tested samples is 3962 (PSI) @ 3 days; 4091 (PSI) @ 35 days; 4098 (PSI) @ 45 days; 4325 (PSI) @ 52 days. The average Brazilian tensile strength of the tested three individual samples is 714 (PSI) @ 3 days; 1100 (PSI) @ 38 days; 1204 (PSI) @ 45 days; and 708 (PSI) @ 52 days. The average density of the samples is 2.273 (g/cm³). The porosity of the tested sample is 0.142.

Example 15: 453 (gram) of Portland limestone cement (Type I), manufactured by TXI, was weighed, held in a container, then, 10 (gram) of white lime (CaO), then, about 100 (g) of 153 (gram) of purified water was first blended with 37.0 (gram) of chemical solution and/or additives from example 1, then, used the left-over water to rinse the wall of the container that held the chemical solution from example 1. Finally, all the 37.0 (g) chemical solution will be blended with water and charged into a Hobart mixer. 609 (gram) of frac sand of 40/70, 617 (g) 100 mesh of frac sand, and 200 mesh of super fine sands, donated from Covia Corporation, were added into the mixer, were added into the mixer. The weighed Portland cement in the container was transferred into the mixer. Then, the whole mixer components were stirred first slowly, then, adding speed, finally with a maximum speed setting rate of 7, blended for about 3-5 (minutes).

The final water/cement ratio of the blended components was 0.41. The formed slump of cement paste was smooth and created a good cone. The mixed components were casted into concrete testing specimen molds prepared by different sized PVC pipes with different cylindrical size of 1″×2″, 1.5″×3″. Total numbers of samples prepared were 24. To make the slump uniformly distributed into the test tube, a ramping rode was used to densify the mixed cement components for 25 times for each prepared sample. Then, the casted samples were immediately sealed with aluminum foils over 24 hr. before placed in water tanks for 7 days, then, left in water for 1 days, 7 days, 14 days, and 28 days before submitted for testing.

The average value of ultimate compressive strength of three tested samples is 2447 (PSI) @ 1 days; 4498 (PSI) @ 7 days; 2977 (PSI) @ 14 days; 3050 (PSI) @ 28 days. The average Brazilian tensile strength of the tested samples is 919 (PSI) @ 1 day; 1000 (PSI) @ 7 day; 2050 (PSI) @ 14 days; 2405 (PSI) @ 28 days. The density of the samples is 2.172 (g/cm³). The porosity is 0.180.

Example 16: 731 (gram) of Portland cement (I/II GU Type), manufactured by TXI, was weighed, held in a container, then, 38 (gram) of lime (CaO), manufactured by Chemstar. About 150 (g) of 192 (gram) of purified water was first blended with 9.42 (gram) of chemical solution and/or additives from example 1, then, used the left-over water to rinse the wall of the container that held the chemical solution from example 1. Finally, all 9.42 (g) chemical solution will be blended with water and charged into a Hobart mixer. Then, 527 (g) standard frac sand of 40/70, and 269 (gram) of 100 mesh frac sand, and 192 (g) of 200 mesh quartz sand, donated from Covia Corporation, were added into the mixer. Finally, 40 (gram) of chopped fiberglass having a cutting length <12 (mm) and a size of 20 (micron) in diameter was added into the blended mixing components to make the final blended components. Then, the whole mixer components were stirred first slowly, then, adding speed, finally with a maximum speed setting rate of 7, blended for about 3-5 (minutes).

The final water/cement ratio of the blended components was 0.26. The mixed components were casted into concrete testing specimen molds prepared by different sized PVC pipes with different cylindrical size of 1″×2″, 1.5″×3″. Total numbers of samples prepared were 32. To make the slump uniformly distributed into the test tube, a ramping rode was used to densify the mixed cement components for 25 times for each prepared sample. Then, the casted samples were immediately sealed with aluminum foils over 24 hr. before placed in water tanks for 7 days, then, left in water for 1 days, 7 days, 14 days, and 28 days before submitted for testing.

The means of the ultimate compressive strength of the three individual testing samples for different curing time is 2258 (PSI) @ 1 day; 3179 (PSI) @ 7 days; 3168 (PSI) @ 14 days; 3900 (PSI) @ 28 days. The average Brazilian tensile (BD) strength of the tested samples is 1565 (PSI) @ 1 day; 2492 (PSI) @ 7 days; 2504 (PSI) @ 14 days; 2208 (PSI) @ 28 days. The porosity of the samples is 0.177. The density of the samples is 2.18 (g/cm³).

Example 17: 432 (gram) of Portland cement (I GU Type), manufactured by TXI, was weighed, held in a container, then, 93 (gram) of lime (CaO), manufactured by Chemstar. About 150 (g) of 278 (gram) of purified water was first blended with 37 (gram) of chemical solution and/or additives from example 1, then, used the left-over water to rinse the wall of the container that held the chemical solution from example 1. Finally, all 37 (g) chemical solution was blended with water and charged into a Hobart mixer. Then, 581 (g) standard frac sand of 40/70, and 589 (gram) of 100 mesh frac sand, and 593 (g) of 200 mesh quartz sand, donated from Covia Corporation, were added into the mixer. Finally, the whole mixer components were stirred first slowly, then, adding speed, finally with a maximum speed setting rate of 7, blended for about 3-5 (minutes).

The final water/cement ratio of the blended components was 0.59. The mixed components were casted into concrete testing specimen molds prepared by different sized PVC pipes with different cylindrical size of 1″×2″, 1.5″×3″. Total numbers of samples prepared were 32. To make the slump uniformly distributed into the test tube, a ramping rode was used to densify the mixed cement components for 25 times for each prepared sample. Then, the casted samples were immediately sealed with aluminum foils over 24 hr. before placed in water tanks for 7 days, then, left in water for 1 days, 7 days, 14 days, and 28 days before submitted for testing.

The means of the ultimate compressive strength of the three individual testing samples for different curing time is 1310 (PSI) @ 1 day; 1809 (PSI) @ 7 days; 2151 (PSI) @ 14 days; 1827 (PSI) @ 28 days. The average Brazilian tensile (BD) strength of the tested samples is 427 (PSI) @ 1 day; 1695 (PSI) @ 7 days; 1500 (PSI) @ 14 days; 2165 (PSI) @ 28 days. The porosity of the samples is 0.185. The density of the samples is 2.161 (g/cm³).

Example 18: A mortar recipe was prepared by the following components: 1880.8 (gram) of Portland cement (I/II GU Type), manufactured by TXI, was weighed, held in a container, then, about 50 (g) of 112 (gram) of purified water was first blended with 3.1 (gram) of chemical solution and/or additives from example 1, then, used the left-over water to rinse the wall of the container that held the chemical solution from example 1. Finally, all 3.1 (g) chemical solution+the rest of purified water were blended and charged into a Hobart mixer. Then, 282.1 (g) of 200 mesh quartz sand, donated from Covia Corporation, were added into the mixer. Finally, the whole mixer components were stirred first slowly, then, adding speed, finally with a maximum speed setting rate of 7, blended for about 3-5 (minutes) before transferred to make testing samples.

The final water/cement ratio of the blended components was 0.61. The mixed components were casted into concrete testing specimen molds prepared by different sized PVC pipes with different cylindrical size of 1″×2″, 1.5″×3″. Total numbers of samples prepared were 32. To make the slump uniformly distributed into the test tube, a ramping rode was used to densify the mixed cement components for 25 times for each prepared sample. Then, the casted samples were immediately sealed with aluminum foils over 24 hr. before placed in water tanks for 7 days, then, left in water for 1 days, 7 days, 14 days, and 28 days before submitted for testing.

The average value of ultimate compressive strength (UCS) of the tested samples is 499 (PSI) @ 1 day; 1612 (PSI) @ 7 days; 1927 (PSI) @ 14 days; 4246 (PSI) @ 28 days. The mean of Brazilian tensile strength from three individual test sample is 367 (PSI) @ 1 day, 1443 (PSI) @ 7 days, 1705 (PSI) @ 14 days, 2208 (PSI) @ 28 days.

An overview of these test results as listed in Table 16 shows that the ultimate compressive strength (UCS) of all tested samples is higher than that of the required minimum 1750 (PSI) in compressive test per ACI building code Table 1, and higher than that of 600 (PSI) in splitting tensile strength requirement per ACI standard. The UCS originated from example 17 is the lowest one obtained due to high W/C=0.59 and added excessive 4.0% lime in the Portland Lime Cement. It still has a value of UCS equivalent to 1827 (PSI) @ 28 days. The Brazilian splitting tensile of example 17 sample is 1215 (PSI) @ 28 days. It is two times more than required 600 (PSI) @ 28 days per Mortar or Masonry specification. The highest average ultimate compressive strength (UCS) listed in Table 16 is 7738 (PSI) @ 500 (days) after one and half year from example 5 and average Brazilian tensile strength 1458 (PSI). The products were prepared with example 2 recipe as special chemical additives at 0.097(%) active ingredient to the total solid of concrete materials (cement+sand+aggregates). 100 mesh, 40/70, and 30/50 frac sand from North White sand were used to prepare samples for products as wall sheathing also show an excellent UCS of 050 (PSI) @ 28 days per specification with its splitting tensile strength of 2475 (PSI) at 28 days.

About 2.0% chopped glass fibers were added in example 16 in Portland lime Cement/North white frac sand mix to demonstrate the potentials of chemical additives used for Architectural types of building and construction. In the selected example 18, mortar and Masonry types of application were explored with silica sand as Pozzolan reactive components in Portland cement and chemical additives as special agents for enhancing its workability. The UCS @ 28 days in example 18 reached more than 4000 (PSI) that met the structural concrete requirement larger than 2500 minimum (PSI). Also, the Brazilian splitting tensile strength was 2208 (SPI), much higher than required 600 (PSI).

TABLE 16
Summary of Concrete Tested Sample Performance by incorporating Bioinspired Chemical Additives/Solution

| | | | | | Exam 5 | | | |
|---|---|---|---|---|---|---|---|---|
| | | | Exam 3 | | 4-168-3,4- | | | |
| Description | | | 4-168-1,4-168- | Exam 4 | 179-1c-1,4- | | | |
| | NoteBook ID | | 2,4-l79-2c-1 | 4-179-2 [symbol] -10 | 179-1c-2,1- | Exam 11 | Exam 12 | Exam 13 |
| items | Mix Components | Unit | (ctrl.) | [symbol] -179-2C-7 | 179-1c-4 | 90A | 90B | 97A-1 |
| | Cement (Type) | | [symbol] | [symbol] | [symbol] | [symbol] | [symbol] | [symbol] |
| 1 | Cement Wt (g) | g | 732 | 752 | 730 | 732 | 732 | 732 |
| 2 | Lime | g | 0 | 0 | 0 | 0 | 0 | 0 |
| 3 | Fine Sand | g | 984 | 984 | 984 | 984 | 984 | 984 |
| 4 | Aggregate [symbol] Purpose) | g | 984 | 984 | 984 | 984 | 984 | 984 |
| | Cementitious Materials | | | | | | | |
| 5 | F [symbol] 40/70 | g | 0 | 0 | 0 | 0 | 0 | 0 |
| 6 | 100 Mesh | g | 0 | 0 | 0 | 0 | 0 | 0 |
| 7 | 200 Mesh | g | 0 | 0 | 0 | 0 | 0 | 0 |
| 8 | Fume Silica Gel | g | 0 | 0 | 0 | 0 | 0 | 0 |
| 9 | Solvent | | | | | | | |
| | Water | g | 300 | 280.2 | 300 | 300 | 300 | 300 |
| | Chemical Additives | g | NA | 3-100-1 | 3-136-1 | NA | 3-100-1 | NA |
| 10 | Additives Quan [symbol] ties | g | 0 | 21.96 | 21.96 | 0 | 2156 | 0 |
| | REinforcing Element | | | | | | | |
| 11 | Chopped Fiber Glass | g | 0 | | | | | |
| Total Wt | | g | 3000 | 3002 | 3020 | 3000 | 3000 | 3030 |
| | Calc W/C: | | 0.41 | 0.410 | 0.438 | 0.410 | 0.410 | 0.41 |
| | Calc. Additive/Cement: | | 0.000 | 0.030 | 0.030 | 0 | 0.03 | 0 |
| | Calc. CM/Cement: | | 0 | 0 | 0 | 0 | 0 | 0 |
| | Performance | | | | | | | |
| | Aging Conditions: | | A | A | A | B | B | B |
| | Aging Time | Days | | | | | | |
| | 1 | | | | | 1904 | 4198 | |
| | 3 | | | | | | | 3279 |
| | 7 | | | | | 4572 | 4687 | |
| | 14 | | | | | 3858 | 3632 | |
| | 28 | | | | | 4823 | 3754 | |
| | 38 | | | | | | | 3851 |
| | 45 | | | | | | | 3088 |
| | 52 | | | | | | 4371 | 3055 |
| | 500 | | <995 | 6924 | 7738 | | | |
| | Aging Time | Days | | | | | | |
| | 1 | | | | | 344 | 999 | |
| | 3 | | | | | | | 971 |
| | 7 | | | | | 726 | 909 | |
| | 14 | | | | | 930 | 962 | |
| | 28 | | | | | 1084 | 688 | |
| | 38 | | | | | | | 1439 |
| | 45 | | | | | | | 900 |
| | 52 | | | | | | 437 | 1000 |
| | 500 | | 1159 | 1335 | 1453 | | | |
| | Density | | 2276 | 2.297 | 2.28 | 2.3445 | 2.414 | 2.356 |
| | Porosity (***): | | 0.141 | 0.133 | 0.140 | 0.115 | 0.089 | 0.111 |
| | Toughness: | | | | | | | |
| | | Summary of Concrete Tested Sample Performance by incorporating Bioinspired Chemical Additives/Solution | | | | | | |
| | | Description | | | | | | |
| | | | NoteBook ID | Exam 14 | Exam 15 | Exam 16 | Exam 17 | Exam 18 |
| | | items | Mix Components | 1010 | NB128-1 | NB 159-1 | NB125A | NB 139-3 |
| | | | Cement (Type) | [symbol] | [symbol] | [symbol] | [symbol] | [symbol] |
| | | 1 | Cement Wt (g) | 732 | 453 | 731 | 432 | 1880.8 |
| | | 2 | Lime | 0 | 10 | 38 | 98 | 0 |
| | | 3 | Fine Sand | 519.34 | NA | 0 | 0 | 0 |
| | | 4 | Aggregate [symbol] Purpose) | 563.9 | NA | 0 | 0 | 0 |
| | | | Cementitious Materials | | | | | |
| | | 5 | F [symbol] 40/70 | 276.7 | 609 | 527 | 581 | 0 |
| | | 6 | 100 Mesh | 608.1 | 617 | 289 | 589 | 0 |
| | | 7 | 200 Mesh | 0 | 621 | 192 | 593 | 282.1 |
| | | 8 | Fume Silica Gel | 0 | 0 | 0 | 0 | 0 |
| | | 9 | Solvent | | | | | |
| | | | Water | 280 | 153 | 192 | 277.7 | 112 |
| | | | Chemical Additives | 3-100-1 | 3-100-1 | 3-100-1 | 3-100-1 | 3-100-1 |
| | | 10 | Additives Quan [symbol] ties | 21.96 | 37 | 9.42 | 37 | 3.1 |
| | | | REinforcing Element | | | | | |
| | | 11 | Chopped Fiber Glass | | | 40 | 0 | 0 |
| | | | Total Wt | 3002 | 2500 | 1989 | 2602.7 | 2275 |
| | | | Calc W/C: | 0.410 | 0.40 | 0.26 | 0.59 | 0.061 |
| | | | Calc. Additive/Cement: | 0.030 | 0.082 | 0.013 | 0.000 | 0.002 |
| | | | Calc. CM/Cement: | 1.21 | 0 | 0 | 0 | 0.150 |
| | | | Performance | | | | | |
| | | | Aging Conditions: | B | B | B | B | B |
| | | | Aging Time | | | | | |
| | | | 1 | | 2447 | 2258 | 1310 | 499 |
| | | | 3 | 3962 | | | | |
| | | | 7 | | 2498 | 3179 | 1809 | 1612 |
| | | | 14 | | 2977 | 3168 | 2153 | 1927 |
| | | | 28 | | 3050 | 3900 | 1827 | 4246 |
| | | | 38 | 4081 | | | | |
| | | | 45 | 4098 | | | | |
| | | | 52 | 4329 | | | | |
| | | | 500 | | | | | |
| | | | Aging Time | | | | | |
| | | | 1 | | 919 | 1565 | 427 | 367 |
| | | | 3 | 714 | | | | |
| | | | 7 | | 1000 | 2492 | 1685 | 1443 |
| | | | 14 | | 2050 | 2504 | 1500 | 1705 |
| | | | 28 | | 2405 | 2208 | 1215 | 2208 |
| | | | 38 | 1100 | | | | |
| | | | 45 | 1204 | | | | |
| | | | 52 | 708 | | | | |
| | | | 500 | | | | | |
| | | | Density | 2.275 | 2.275 | 2.18 | 2.161 | 2.31 |
| | | | Porosity (***): | 0.142 | 0.180 | 0.177 | 0.185 | 0.128 |
| | | | Toughness: | | | | | |

Note: [symbol]
Products were targeted for mortar application in construction.
A: 24 hr. air dried, then immersed in water until ready to be tested at room temperature (70 to 80° F.)
B: 24 hr. air dried, then, placed the samples in water tanked for 7 days, left in air until tested. [symbol]
Assume that the solid density of particle is 2.55 (g/cm³) [symbol]
indicates data missing or illegible when filed

In comparison of the mechanical performance of example 15 vs. 16, lime of 10 (gram) was added in example 15, 92 (gram) in example 16. It seems that added excessive lime will increase the 28 day's UCS of example 16, Also, the UCS @ 7 days, however, it would create slight lower UCS @ 1 days in example 16 than example 15. On the other hand, the Brazilian splitting tensile strength @ 28 days in example 16 is less than in example 15.

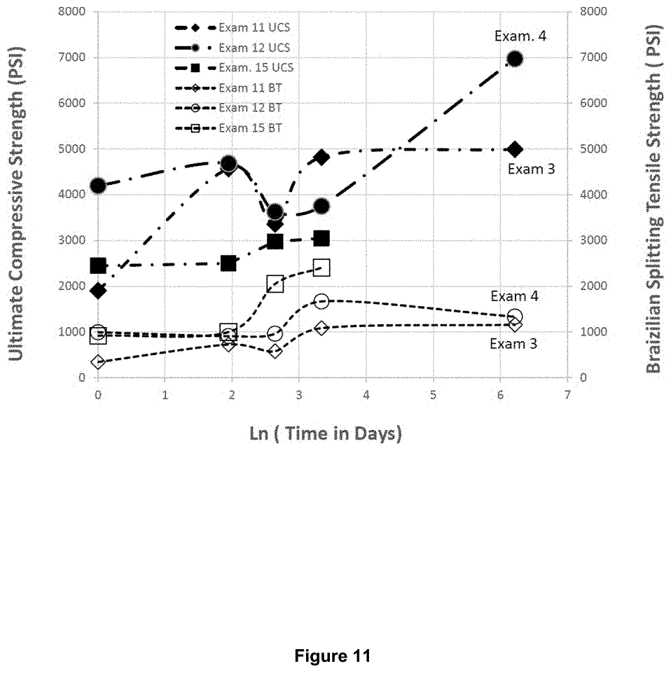

An overview of the mechanical properties of the tested samples on test data from examples 3, 4, 11, 12, 13 as shown in FIG. 11 suggests that the samples blended with chemical additives (exam 4 and exam 12, 13) have many advantages over the control sample (exam. 3 and exam 11). Both UCS and Brazilian splitting tensile strength of the samples from exam. 12 and 13 on the 1st day have a higher value than that of regular concrete control samples (exam 11). A blend of regular Portland cement with the chemical additives from example 1 can double its UCS from 2000 (PSI) to about 4000 (PSI) and BSTS from 500 (PSI) to 1000 (PSI). For the blend of Portland lime Cement with North white sand, the UCS at the early age of 24 hr. is larger than 2500 (PSI). In contrast, for regular cement blend (exam 11), the UCS (filled diamond shape with break dot line in FIG. 11) would not arrive at the same level as exam 12 until tested at 7 days. At 14 days, the sample would lose some strength and level off at 28 days without any change since then at a UCS of 5000 (PSI) as shown in Exam. 3 after 500 days placed in environment.

Although the UCS originated from exam 12 is lower at 28 days than from ctrl sample from exam 11, the UCS from exam. 12 continuously increase until arrive at around 7700 (PSI). As described previously, the increased UCS from exam 4 is different from example 3 in a regular autogenous self-healing of concrete since the strain failure percentage in example 4 is 10 times more than in example 3, which is attributed to the enhanced viscoelasticity or viscous plasticity in the sample of example 4.

Fundamentally, the applicants believe that self-activated non-covalent and hydrophobic dispersive bonds from soy proteins and waxy materials are mainly accounted for the long-term performance enhancement of the disclosed concrete products. The applicants also believe that the water and non-polar solvents potentially serve as stimulating and sensing agents in response to the environmental moisture and temperature cycles to make self-adjustment of polymeric mobility to mitigate the risk of the internal and external shrinkage. Potentially, the Soy protein molecules serve as connection knots and as central points of cross-linking network in the hydrogel polymers as moisture reservoir, which prevents the concrete structure free from the cracking and catastrophic failure. Intuitively, a study on the exothermic hydrated reaction of cement with the other components would provide us more in depth understanding of how the activation energy is related with the behavior of blended components disclosed in detail further as follows.

Example 19: Calorimeter Testing of Hydraulic-Cement Concrete Curing with Insulated Coffee Cups: To a Hobart mixer (5 lit.) charged 549 (gram) of Portland cement (Type I/II GU), then, 738 (gram) of all-purpose sands (aggregate) was added into the mixer, 738 (gram) of fine sands. 16.5 (gram) of chemical additives prepared with example 1 recipe was weighed into a plastic cup. Then, adding 100 (gram) of purified water into the plastics cup containing the chemical additives. The diluted chemical additives were subsequently blended with mixed solid particles for 3 minutes, charged another 120 (gram) into the mixer, and blended for another 2 minutes. Then, the mixed components were used for preparing the test samples. About 392.0 (gram) cement mix was packed and sealed in a coffee cup. The temperature of the mixed cement was measured by inserting a thermometer in the sealed coffee cup. Besides the interior mixed cement temperature, the environmental temperature of the coffee cup was also monitored with a separate thermometer as a function of sampling time.

Example 20: To a Hobart mixer (5 lit.) charged 549 (gram) of Portland cement (Type I/II GU), then, 738 (gram) of all-purpose sands (aggregate) was added into the mixer, 738 (gram) of fine sands was also added into the mixer. 16.5 (gram) of chemical additives prepared with example 2 recipe was weighed into a plastic cup. Then, adding 100 (gram) of purified water into the plastics containing the chemical additives. The diluted chemical additives were blended with mixed solid particles for 3 minutes, charged another 120 (gram) into the mixer, subsequently blended for another 2 minutes. Then, the mixed components were used for preparing the test samples. About 274.5 (gram) cement mix was packed and sealed in a coffee cup. The temperature of the mixed cement was measured by inserting a thermometer in the sealed coffee cup. Besides the interior mixed cement temperature, the environmental temperature of the coffee cup was also monitored with a separate thermometer as a function of sampling time.

Example 21: To a Hobart mixer (5 lit.) charged 549 (gram) of Portland cement (Type I/II GU), then, 738 (gram) of all-purpose sand (aggregate) was added into the mixer, then, 738 (gram) of fine sands was added into the mixer, subsequently, adding 100 (gram) of purified water into the plastics cup containing the chemical additives, blending all mixed solid particles for at least three minutes, charged another 120 (gram) purified into the mixer, finally blended for another 2 minutes. Then, the mixed components were used for preparing the test samples. About 225.4 (gram) cement mix was packed and sealed in a coffee cup. The temperature of the mixed cement was measured by inserting a thermometer in the sealed coffee cup. Besides the interior mixed cement temperature, the environmental temperature of the coffee cup was also monitored as a function of sampling time.

Example 22: To a Hobart mixer (5 lit.) charged 549 (gram) of pre-blended lime Portland Cement following the commercial instruction, then, 738 (gram) of all-purpose sand (aggregate) was added into the mixer, 738 (gram) of fine sands was also added into the mixer, subsequently, adding 100 (gram) of purified water into the plastics cup containing the chemical additives, blending all mixed solid particles for at least three minutes, charged another 120 (gram) purified into the mixer, finally blended for another 2 minutes. Then, the mixed components were used for preparing the test samples. About 225.4 (gram) cement mix was packed and sealed in a coffee cup. The temperature of the mixed cement was measured by inserting a thermometer in the sealed coffee cup. Besides the interior mixed cement temperature, the environmental temperature of the coffee cup was also monitored as a function of sampling time.

Example 23: Determining the Hydraulic-Cement Mix Thermodynamic Reaction: Since reaction of cement components with chemical additives and water are exothermic, it typically can be proceeded in an adiabatic condition. As such, the thermal energy generated can be monitored by measuring the variation of the temperature on the mixed components. Assume that the mass of a cement mix is m, the cup's wall has double thin layers fully vacuumed, the internal energy driven by the reaction of cement components can be calculated by equation 13 as follows¹:

ΔEᵢ=∫₀^{t}αₙnRT(0){T(t)−T(0)}dt (13)

where ΔEᵢ is the differentiation of internal energy of the mixed cement components before and after blended with chemical additives in the coffee cup, αₙ is the number of freedoms divided by 2, n is the molar number, R is the universal gas constant (8.315 J/mol), T(0) is the environmental temperature in Kevin, T(t) is the mixed cement component's temperature measured by thermal coupling probe inserted in the coffee cup at sampling time t. ¹https://en.wikipedia.org/wiki/Adiabatic_process

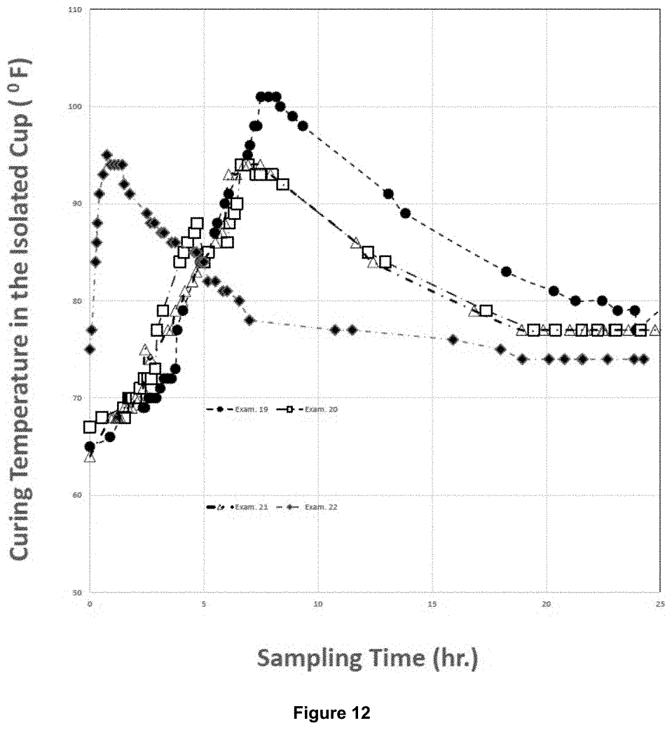

The curing temperature of concrete in an adiabatic calorimeter test is arguably the one variable that has the most significant effect on the rate of hydration. The thermal probe temperatures measured in examples 19, 20, 21, 22 plotted as a function of sampling time in FIG. 12 shows very interesting hydration reaction. Firstly, at around 45 (minutes), there exists a maximum exothermic reaction peak in example 22. In the rapid setting cement from commercial products, Ca(OH)₂ or/and CaO are catalyzer used for accelerating the cement curing. Clearly, the cement components in this mix cured within 1 hour. The curing temperature of the samples of example 22 dramatically increased until reached its maximum temperature of 95° F. within 47 (min.) after mixed with water. It is evident that a carbonation reaction occurred in this test group of CaO with water and create CaCO₃ ionic bonds in the formed matrix. In general, the fast cured samples will have better early age compressive strength, however, it has a poor durability.

Secondly, within the first 4 hour, an advanced exothermic curing reaction occurred in the tested sample of example 20 until it reached the first maximum peak temperature of 88° F. at a curing time of t=4.7 hr. Then, the curing rate flattened out for a short time around the sampling time of 5 hour. The curing reaction rate continuously increased until it reached the 2^{nd} maximum exothermic peak of curing temperature of 95° F. at around 6 (hour) before being slowed down. Then, the hydration processes followed a similar trend to that of virgin cement mix as example 21. Like the inflammation in bone fracture recovery, it was discovered that the thermal transition might be attributed to the soy protein's α-helix coil and β-sheet transition that promotes the protein alignment with non-covalent hydrogel bonds. Exothermic reaction occurred as the soy proteins (example 20) were swollen to promote the intimate contact of its selves with cement matrix elements.

It is believed that below the temperature of 88° F., the intimate contact was positively charged with the hydrogel polymers. At 88° F. or so, the SPI or other encapsulated materials in the core layer were suddenly exposed to the water and mineral oil solvent system. More extensive swelling occurred within the soy proteins, leading to the more intimate contacts of soy protein molecules with cement (—OSiO—) at a temperature range from 88° F. to 95° F. The soy proteins might create the needed clots cross the side walls of crack in width to heal the damage of cement cracks. As the temperature of mixed cements was above 95° F., the curing profiles of following the same trend as regular cement mix as example 21. It is suggested that in the initial 6 hours or so, the soy proteins in the core layer might be intercalated in the valleys of cracks of cements and aggregates although the soy proteins were highly flowable and soluble under the alkali conditions. This thermodynamic data strongly supports the proposed bonding mechanisms occurring in the mixed cement composite bonds; however, this type of thermodynamic behavior has never been reported previously.

Thirdly, slightly different from example 20, the increase of cement temperature of the example 19 was much smaller than that of example 21 (ctrl.) when the mixed component's temperature was below 72 (degree). A sharp increase of the mixed components was observed at the curing time around 3.75 (hr.). The temperature of mixed components changed from 72 to 79° F. or so. within 5 to 10 (min.) that was attributed to the melting of wax and underwent a phase transition. At a temperature of cured components above 79° F., the wax was totally dissolved in the mixed solvent that release newer and fresh surface of sands and aggregates that could be interacted with cement components, leading to extensive hydration in the sample of example 19. The maximum curing temperature arrived at 101° F. around 8 hours. Dominant interaction in the sample of example 18 was mainly involved in the bonding process from non-polar dispersive force contributions. Again, a melting of wax or its combination with polymers to plasticize the cement interface is novel, however, a promotion of compressive strength and Brazilian splitting tensile strength to the cement products has never been reported. Thereof, the applicants discovered that a non-covalent hydrogen bond or/and dispersive bond might be more critical for the enhanced early age compressive strength and long-term durability instead of CSH bonds widely promoted in current cement research community. Assume that the internal energy ΔE (ctrl.) of example 21 (control) was the base of all tested samples, the integration of the relative internal energy per the adiabatic process for each tested sample from examples 19, 20, 21, 22 was calculated with an excel spreadsheet program could be expressed as equation (14). The relative degree of hydration (α) is, in general, taken as the ratio of heat evolved at time t to the total amount of heat available as equation (14)

$$α ( t ) = \frac{Δ {E ( t )}_{i}}{Δ E ( ctrl )} \qquad ( 14 )$$

where the ΔE (ctrl.) is the calculated internal energy of example 21 based upon the equation 14, i in the equation is 18, 19, 20, 21 originated from examples 18, 19, 20, 21, ΔE® (%) is a relative energy percentage obtained from equation (14) based upon the measured temperature profile data shown in FIG. 12.

Assume that 1 (gram) of samples from examples 19, 20, 21, and 22 each was mixed, and the bonding of particles in each sample would have been independent from each other, the bonding contribution defined as dispersive force, non-covalent hydrogen bonds, regular hydration cation bonds, and special CaO ionic bonds could be calculated based upon the calculated relative internal energy from the tested samples listed in table 17.

TABLE 17
Bond Type Contribution Classified Based Upon the Calculated Relative Energy of Example 21 as Base

| | | Relative Exothermic | Unreactive | Calculated Bond | Bond |
|---|---|---|---|---|---|
| Sample ID | Chemical Additives | Energy (%) ΔE* | (%) | Contribution (%) | Classification |
| Exam. 19 | Aqualub (Wax based | 77.2 | 22.8 | 19.30 | Dispersive Force |
| | emulsion) | | | | |
| Exam. 20 | Aqulub 3-100 (SPI) | 54.3 | 45.7 | 13.58 | SPI hydrogen Bonds |
| Exam. 21 | Control | 100 | 0 | 25.00 | C S H Hydration |
| Exam. 22 | Rapid Setting (CaO) | 56.3 | 43.1 | 14.23 | Lime Hydration (Ionic) |

| | | | | |
|---|---|---|---|---|
| Sub Total | 283.4 | 111.6 | 27.90 | non-hydration |

Evidently, based upon the classified bond contribution calculated in Table 16, there would have been about 14.0(%) originated from SPI, 20.0% from dispersive force; and 25.0% from calcium silicate hydrate, and 14.0% from lime hydration reaction. Potentially, there would be still 28.0% of unreactive surface or partition that can be hydrated, or recovered for further self-healing, which would support the proposed bonding mechanisms present in the disclosed state-of-art recipes. Alternatively, an activation energy (Eₐ) could have been determined if a series of experimental test could be conducted with examples 19, 20, 21, 22 recipes separately under different isothermal temperature condition with Arrhenius equation (Poole, et al., 2007). The calculated overall rate of hydrate reaction could be used to determine the cement paste's mobility and molecular phase transition further. The self-healing mechanisms for enhancing the early age and late strength of concrete products are thereby conceptually proved by the disclosed experimentation as illustrated herein.

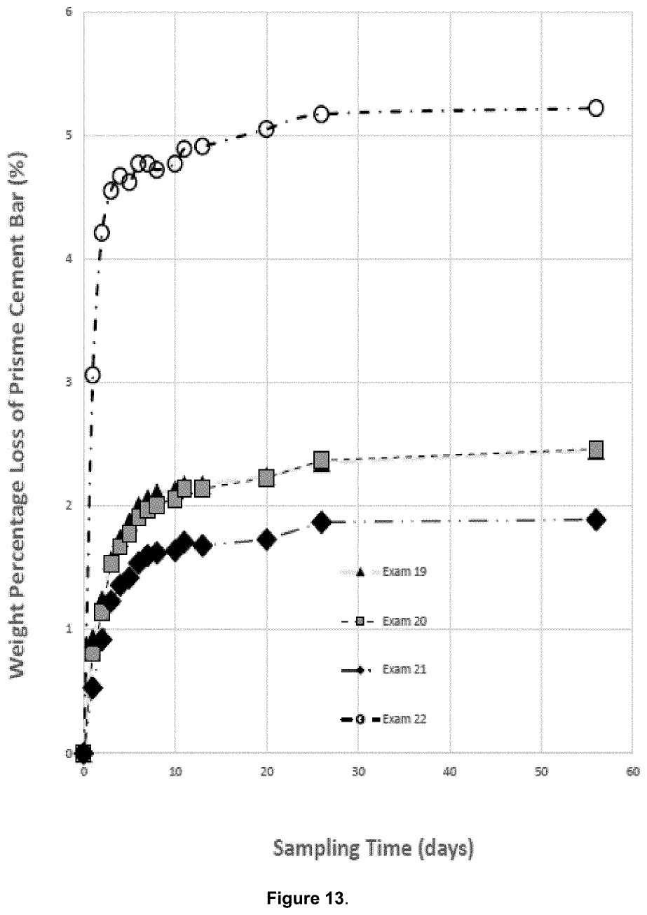

Example 24: Moisture Absorption and Desorption of Tested Concrete Prisms: Of the blended materials from examples 19, 20, 21, 22, two prism bars for each set condition in a dimension of 1″×1″×12″ were prepared in the lab sealed in aluminum foils overnight. After 24 hours, the samples were de-molded and weighed. The aluminum foil was taken off. The samples were exposed all its surface to ambient temperature and submitted to an ambient drying condition for over two months. The weight loss of each prism sample was recorded as a function of sampling time in days. A plot of moisture percent loss as a function of sampling time present in FIG. 13. Evidently, the moisture losses from examples 21 and 22 are identical, about 5.0% above its original weight over the two months, it can be considered as regular normal samples. In contrast, the moisture loss of example 19 is less than 2.0%. It is implied that the waxy layers might be a super protection for the under-layered water molecules. The moisture loss from example 20 was a little bit over 2.0(%). For sure, it is also excellent in term of holding the moisture and water under its multifunctional coating layer.

Example 25: Preparation of white concrete sample as control: A white cristobalite sand material having a wt. of 249.2 (g) was pre-blended with a 200 mesh frac sand of wt. 217.2 (g). Ordinary Portland cement (OPC) of wt. 110.0 (g) was pre-blended with 1.9 (gram) of lime (CaO) in a container, then, water of 21.4 (g) was charged into a 10 Hobart mixer before adding the pre-blended cristobalite and 200 mesh frac sand materials, Finally, added the preblended OPC and lime components into the mixer for 5 minutes. Then, 3×6 test cylindrical test samples were prepared. The tested samples were subjected to color test on its whiteness by a CIELAB coloring meter defined by L*, a*, and b*. The measured average value of L*=85.0, standard deviation (St Dev): 3.48, number of tested samples: 3; a*=−7.27, b*=1.2.

Example 26: Preparation of white concrete sample with multifunctional additives: 100 mesh sand materials weighted at 259.9 (g) was blended with 200 mesh of 218.0 (g), then, 1.90 (g) lime and 101.7 (g) of ordinary Portland Cement (OPC) were added into the Hobart mixer. 2.10 (gram) of solution from example 2 recipes prepared was mixed into 21.0 (gram) of tap water. Then, the powder components were added into the mixer and blended for about 3-5 minutes before the mixed paste materials are casted into 3″ cylindrical PVC test tube. The cast samples were placed outside in the air for 24 hour before immerged into water over 7 days. Then, the samples were cut into 3″×2″ disks to measure the coloring of the concrete surface. The measured CIELAB L*=84.3, a*=−3.8; b*=3.7 of the 10 measurements. Clearly, the whiteness of example 25 is matching to example 26. The influence of coated technical solution from example 2 recipe on the surface qualities of the tested samples is negligible. Both these samples are superiorly white, preferred color as energy saving construction materials as LEED certified products.

Example 27: A cristobalite sand material donated from Commercially available source was measured with its coloring with coloring meter. The measured CIELAB of the samples is L*=82.7, a*=−5.9, b*=0.0, Lightness per ASTM E 308=82.7 per ASTM test standard with a VEYKOLOR PRO.

Example 28: 400.0 (gram) cristobalite sand from example 27 was coated with 4.0 (gram) of the chemical additives prepared with example 2 recipes. The procedure for applying the coatings was to pre-blend the 4.0 (g) of the chemical additives with 6.0 (gram) of water, then, added on the Cristobalite sand. The powder products were dried under the sun before collected into plastic bag sealed for testing. By packing the sealed samples in transparent plastic film, the measured CIELAB value of the tested sample was L*=86.2, a*=−2.6, b*=1.5. lightness per AST E308=86.2.

Example 29: 400.0 (gram) cristobalite sand from example 27 was coated with 7.0 (gram) of the chemical additives prepared with example 2 recipes. The procedure for applying the coatings was to pre-blend the 7.0 (g) of the chemical additives with 10.5 (gram) of water, then, added on the Cristobalite sand. The powder products were dried under the sun before collected into plastic bag sealed for testing. By packing the sealed samples in transparent plastic film, the measured CIELAB value of the tested sample was L*=87.7, a*=4.4, b*=1.5. lightness per AST E308=86.5.

Example 30: 400.0 (gram) semicrystalline cristobalite sand from example 27 was coated with 10.0 (gram) of the chemical additives prepared with example 2 recipes. The procedure for applying the coatings was to pre-blend the 10.0 (g) of the chemical additives with 12.5 (gram) of water, then, added on the Cristobalite sand. The powder products were dried under the sun before collected into plastic bag sealed for testing. By packing the sealed samples in transparent plastic film, the measured CIELAB value of the tested sample was L L*=90.0, a*=−1.1, b*=1.3. lightness per AST E308=90.3.

Example 31: 600.0 (gram) commercially available cristobalite with average sieve size of 13 micron was coated with 21.0 (gram) of the chemical additives prepared with example 2 recipes. The procedure for applying the coatings was to pre-blend the 21.0 (g) of the chemical additives with 26.3 (gram) of water, then, added on the Cristobalite powder aggregates. The coated powder products were dried in the oven at 200 F over night before collected into plastic bag sealed for testing. By packing the sealed samples in transparent plastic film, the measured CIELAB value of the tested sample was L*=93.4, a*=−14.2, b*=0.46. lightness per ASTM E308=94.0.

Example 32: 600.0 (gram) commercially available 200 mesh silica flour was coated with 21.0 (gram) of the chemical additives prepared with example 2 recipes. The procedure for applying the coatings was to pre-blend the 21.0 (g) of the chemical additives with 26.3 (gram) of water, then, added on the 200 mesh silica flour. The coated powder products were dried in the oven at 200 F over night before collected into plastic bag sealed for testing. By packing the sealed samples in transparent plastic film, the measured CIELAB value of the tested sample was L*=87.7, a*=−5.0, b*=3.5. lightness per AST E308=88.0.

TABLE 18
Measured Solid Sample's Surface Color Attributes by CIELAB
System (L*, a*, b*)

| RUN ID | Description | L* | a* | b* |
|---|---|---|---|---|
| Example 25 | OPC Regular Concrete Disk | 85 | −7.27 | 1.2 |
| Example 26 | OPC Concrete plus example 2 | 84 | −4 | 4 |
| | coatings | | | |
| Example 27 | Cristobalite | 83 | −5.9 | 0 |
| Example 28 | Cristobalite + 1.0% coatings from | 86 | −2.6 | 1.5 |
| | example 2 | | | |
| Example 29 | Cristobalite + 1.75% coating from | 88 | −4.4 | 1.5 |
| | example 2 | | | |
| Example 30 | Cristobalite + 2.50% coating from | 90 | −1.1 | 1.3 |
| | example 2 | | | |
| Example 31 | Crystobalite + 3.50% coating from | 93 | −14.2 | 0.46 |
| | example 2 | | | |
| Example 32 | 200 mesh Crystobalite + 3.50% | 88 | −5 | 3.5 |
| | coating from example 2 | | | |

Table 18 summarizes the testing results of sample's coloring attributes from examples 25 to 32 measured by CIELAB system. L* is a parameter that reflects how white the surface of the tested samples under the visualization. For a LEED program sample, the minimum L* is 82. Clearly, all the tested samples are qualified as LEED materials. The enhancement of whiting the surface color of the coated cristobalite samples based upon the data present from examples 27 to 31 seems evident.

Example 33: 190 (gram) of 100 mesh frac sand and 190 (gram) of 200 mesh silica flour powder were mixed, 20 (gram) of lime (CaO) added into the above mixture, ¼″ short fiber glass was also added into the powder mixture. 9.0 (gram) of multifunctional coatings based upon the recipe of example 2 was blended in 183 (gram) of water. 406 (gram) of Ordinary Portland Cement (OPC) was weighed, then, the powder components are mixed with diluted chemical additive solutions in a Hobart mixer for 5 minutes before casting the concrete samples. The small cylindrical samples of 1.5″ IN diameter and 1.5″ in depth were casted in a silicon rubber molder that can hold 24 pocket holes with the casted concrete samples. The samples were placed in a 200° F. of oven for 2 hours before it was cooled down in the air, then, placed in the water tanker for prolong curing reaction. Compressive strength (CS) of the tested samples was determined in accordance to the ASTM C39 test protocol after the samples were cured at 0 (after two hour curing) day, 3 days, and 7 days to assess how the CS will be affected by the 2-hour oven curing for the casted concrete samples.

Example 34: 304 (gram) of 100 mesh frac sand and 304 (gram) of 200 mesh silica flour powder were mixed, 32 (gram) of lime (CaO) added into the above mixture, 17.0 (gram) of ¼″ short fiber glass was also added into the powder mixture. 13.0 (gram) of multifunctional coatings based upon the recipe of example 2 was blended in 289 (gram) of water. 641 (gram) of Ordinary Portland Cement (OPC) was weighed, then, the powder components are mixed with diluted chemical additive solutions in a Hobart mixer for 5 minutes before casting the concrete samples. The small cylindrical samples of 1″×1″×1″ were casted with a silicon rubber molder. The samples were placed in a 170° F. of oven for 2 hours before it was cooled down in the air, then, placed in the water tanker for prolong curing reaction. Compressive strength (CS) of the tested samples was determined according to the ASTM C39 test protocol after the samples were cured at 0 day, 3, days, and 7 days to assess how the CS will be affected by the 2-hour oven curing for the casted concrete samples.

Example 35: 304 (gram) of 100 mesh frac sand and 304 (gram) of 200 mesh silica flour powder were mixed, 16 (gram) of lime (CaO) added into the above mixture plus 16 (gram) of zinc oxides, 17.0 (gram) of ¼″ short fiber glass was also added into the powder mixture. 13.0 (gram) of multifunctional coatings based upon the recipe of example 2 was blended in 289 (gram) of water. 641 (gram) of Ordinary Portland Cement (OPC) was weighed, then, the powder components are mixed with diluted chemical additive solutions in a Hobart mixer for 5 minutes before casting the concrete samples. The small cylindrical samples of 1″×1″×1″ were casted with a silicon rubber molder. The samples were placed in a 200° F. of oven for 2 hours before it was cooled down in the air, then, placed in the water tanker for prolong curing reaction. Compressive strength (CS) of the tested samples was determined with the ASTM C39 test protocol as reference standard after the samples were cured at 0 day, 3, days, and 7 days to assess how the CS will be affected by the 2-hour oven curing for the casted concrete samples.

Example 36: 304 (gram) of 100 mesh frac sand and 304 (gram) of 200 mesh silica flour powder were mixed, 29.8 (gram) of lime added into the above mixture, 17.0 (gram) of ¼″ short fiber glass was also added into the powder mixture. 14.0 (gram) of multifunctional coatings based upon the recipe of example 2 was blended in 289 (gram) of water. 642.3 (gram) of Ordinary Portland Cement (OPC) was weighed, then, the powder components are mixed with diluted chemical additive solutions in a Hobart mixer for 5 minutes before casting the concrete samples. The small cylindrical samples of 1″×1″×1″ were casted with a silicon rubber molder. The samples were air dried cured in outside environment, then, placed in the water tanker for prolong curing reaction. Compressive strength (CS) of the tested samples was determined with ASTM C39 test protocol as reference standard after the samples were cured at 0 day (after 24 hr. in air-dried condition), 3 days, and 7 days to assess how the CS will be affected by the standard casted concrete samples without heating.

TABLE 19
Measured Compressive Strengh (CS) of Concrete Samples Based
Upon Different Recipes (*)

| Run Order | Condition | 0 | 1 | 3 | 7 |
|---|---|---|---|---|---|
| Example 33 | 200° F | 18.2 | 18.2 | 22.4 | 22.6 |
| Example 34 | 170° F | 16.3 | 16.3 | 21.4 | 15.4 |
| Example 35 | 200° F (ZINC OXIDE) | 0 | 4.9 | 34 | 12.2 |
| Example 36 | Ambient temperature | 0 | 18.2 | 39 | 63.25 |

note:
(*) Number of tested sample block n = 6

Table 19 summarizes the test results of compressive strength (cs) determined by the modified ASTM C39. Evidently, the curing temperature is significant in controlling the initial CS of tested samples in examples of 33 and 34. At the 200° F., the samples will have an instant CS without losing its strength after 1 day and 3 days at 22.6 (Mpa). This indicates that potentially, the activated thiol functional group in soy protein might play a critical role in generating the gelling and network structure for the composites, resulting in flexible cross-linking networks from the thiol and disulfide folding/regeneration to stabilize the network structure with chemical crosslinking of covalent bonds, however, when the oven temperature was setting at 170° F. or below, the CS seems subject to large variation within 3 days at 21.4 (MPa). Although it has a high initial CS, it did not perform consistently after 7 days at 15.4 (MPa). The binding might be primarily involved in hydrogen in nature. When zinc oxide is incorporated into the products, the mixed components have much lower CS than others due to changed recipes. On the other hand, for control sample of example 36, the sample had zero CS within two-hour curing time, however, it did not perform like the example of 33 after 24 hour-curing in the air. The amazing thing is that if timing is not a big concern, once the sample of example 36 is placed under water tanker. Its CS value increases consistently within the investigated 7 days.

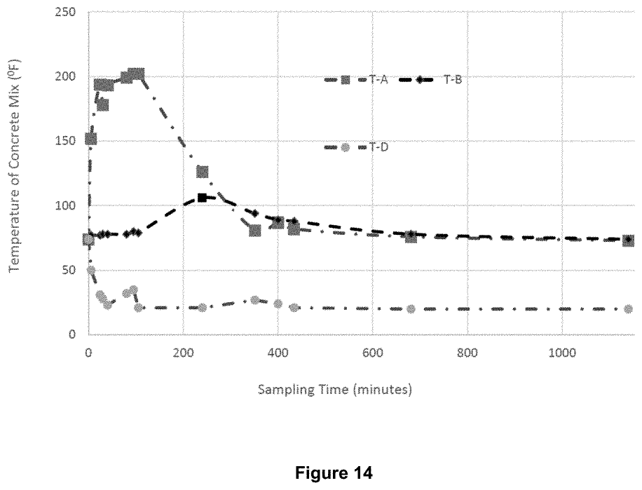

Example 37: 263.9 (gram) of 100 mesh frac sand and 263.9 (gram) of 200 mesh frac sand were blended, then, 29 (gram) of chopped fiber glass in a length of ¼″ was added into the mixer to get fully mixed in a plastic container by adding 557 (gram) of Ordinary Portland Cement (OPC) into the mixed components. 12 (gram) chemical additives from example 2 were first blended with 362 (gram) of tap water, then, the mixed components from both powder and liquid were blended in a Hobart mixer for 5 (minutes) before casting the slurry of mixed components. Of the casted samples, three samples were packed in three separated sealed coffee cups consisting of a vacuum wall in each coffee cup. A thermal coupling probe was placed in each cup to monitor the temperature variation for each cup, then, the samples were placed in an environment: a) T-A under 200° F. for 120 (minute) in a temperature-controlled oven; b) at room temperature; c) in a freezer. The temperature of packed cements and aggregate slurries as a function of sampling time is plotted in FIG. 14 to monitor the curing of the mixed components.

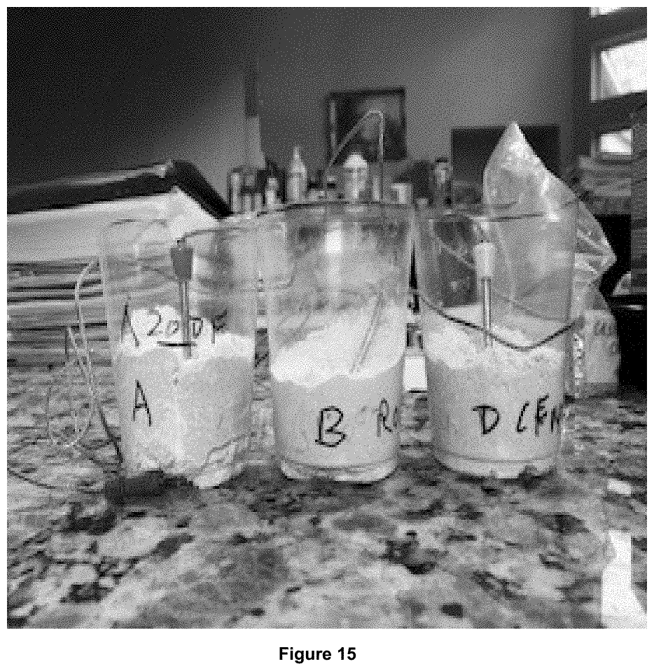

Clearly, the temperature of concrete mixture labelled with T-A had a maximum temperature of 202° F. within two-hour oven heating, while the temperature labelled with T-B maximum exothermic peak temperature at 106° F. after 240 (minutes). The temperature of samples labelled with T-D was constantly below 32° F. once placed in the freezer. After 7 days, all these samples in the coffee cups were taken out and an i-phone photo was taken by placing all the samples on the countertop surface shown in FIG. 15.

By visualization and just feeling the individual concrete sample with hands in the plastic cups, it seems that except that the sample B seems to be a little whiter in color than other two samples, all of them (T-A, T-B, T-D) seem to cure themselves into excellent solid blocks. Conclusively, the added multifunctional coatings and chemical additives can provide consistent and sustainable performance to the coated sand and aggregates for consolidation with cement components regardless of the environmental temperature. Indeed, the multifunctional coatings and chemical additives are very robust. No issue of mixed slurries for freezing and thaw would be expected in actual construction workplace if applied in the future.

Based upon the disclosure present here, it is therefore demonstrated that the objects of the present invention are accomplished by the chemical components and added solution chemicals of matter and methods useful in cementitious construction material's application as special early age strength and long-term durability enhancement agents through self-healing and biomineralization functionalized improvement that can be applied in residential and commercial building, and potential for high rising and high strength building application. By combining the chemical additives with other engineered reinforced materials such as glass fibers, steel bar fibers, and other bio-engineering reinforced elements of materials, its applications and identified benefits for enhancing cement early age strength and durability to mitigate the risk of fracking cracks in concrete structure as a self-activated healing agent, has been disclosed herein. It shows that a selection of the multifunctional coating' and additive's components of disclosed lubricant, micro-nano-textured, dual phobic domain particles and phase transition materials, emulsifiers, hydrogel polymers, and cross-linking agent, and made-up water/polar solvent percentage by weight percentage, processing for blending the above chemical additives with cement components of sand, aggregates, and water mix by weight and/or volume percentage, can be determined by one having ordinary skill in the art without departing from the spirit of the invention herein disclosed and described. It should therefore be appreciated that the present invention is not limited to the specific embodiments described above, but includes variation, modification, and equivalent embodiments defined by the following claims.

We claim:

1. bioinspired self-healing chemical additives and solution comprising of by weight percentage:
a) soy protein isolate (SPI) as micro-nano/textured dot dual phobic domains from 0.001(%) to 40%,
b) mineral oil as liquid lubricant or/and non-polar solvents from 0.01% to 50%,
c) hydrolyzed polyacrylate sodium acrylamide polymer as a hydrogel polymeric suspending agent from 0.001 to 35%,
d) polysorbate as surfactants: 0001 to 20.0%,
e) water: 1.0% to 99.0% as balance agent,
f) the combination of the above by weight percentage, useful as an admixture of hydraulic-cement concrete driven by a self-activated polymer's phase transition of from 10 to 200° F., resulting in more than 3000 (PSI) of early age compression strength, 7000 (PSI) of ultimate compressive strength (UCS), 80.0% of cracking self-healing and self-assembling of incorporated activated protein fibrils, and 9 times more toughness than the virgin concrete, 13 times more of its modulus of resilience, characterized as a hydro dual phobic domain coating via a dynamic tilted contact angle larger than 30 (degree) and static contact angle from 30 and 90 (degree) measured on a thin film solid surface.

2. The chemical components of claim 1, wherein at least one of the chemical components of micro-nano/textured dot and dual domains is one component optionally selected from candle wax, paraffin wax, slick wax, or ethylene streamside synthesis wax, carbamate wax, natural organic and organic synthesized wax that has a melting point of at least 35° C. or above, and/or biomaterial or bio-derivatives of sweet rice flour, soy wax, soy protein isolate particles, soy protein concentrates, or/and its derivatives from SPI functionalized with amine or hydroxyl, carboxyl, and aldehyde ester, amide, and polyamide functionalities, or/and the combination of petroleum based or biobased materials, polylactic acid ester, inorganic silica particles, thereof, the dosage level of these hydrophobic/hydrophilic domain's materials is ranged from 0.01% to 40.00% of the total weight percentage of all components of claim 1.

3. The chemical components of claim 1 wherein one of the lubricants and/or non-polar solvents is optionally selected from liquid lubricant and/or non-polar solvents, comprising of mineral oil, saturated hydrocarbon, alkyl chains of ethylene carbon, liquid paraffin, kerosene, petroleum distillates, and higher alkane, cyclo-alkanes, the alkyl carbon chains from C6 to C20, the dosage levels of the lubricant and/or non-polar solvent from 1% to 50% of the total weight percentage of all components of claim 1.

4. The chemical composition of claim 3, wherein one of the hydrogel polymers is optionally selected from polyacrylate anionic, or cationic, or nonionic polymers or hydrolyzed acrylate sodium acrylamide polymers, the mixed combination of these polymers and their copolymers functionalized with one of functional groups optionally selected from of the amine, hydroxyl and carboxyl, and aldehyde, sulfonate, and cyclic amine and vinyl functional groups, having linear, or/and branched or/and dendrimer's structure, the dosage level of hydrogel polymers ranged from 0.001 to 35% by weight percentage of the total weight of all components of claim 1.

5. The chemical component of claim 4, wherein one of the emulsifiers is optionally selected from linear, di-, tri-, or multi-branched surfactants, with cationic, anionic, amphoteric, nonionic, and zwitterionic surfactants and/or their combination thereof, the total dosage level of optionally selected surfactants and/or emulsifiers ranged from 0.0001% to 20.0% by weight percentage of all components of claim 1.

6. The mixed chemical components of claim 5, wherein the mix of the combined from claim 1 to total combined components of cement, fine sand, aggregates, and cementitious materials is ranged from 0.00001/99.99999 to 10/90 by weight percentage of the total blended components.

7. Chemical composition of claim 6, in which, claim 3 and its combination with claim 4, optionally selected from, wherein it is optionally modified by at least one of cross-linking additive chemicals optionally selected from reactive functional groups of isocyanates, epoxy, unsaturated ethylene double bonds, amide, imide silane, aldehyde, amine, and carboxylic acid, that can cross-link the hydrogel polymers into flexible and elastic network structure, and polyamide amine epichlorohydrin (PAE) into a wet strength polymer network, the cross-linking chemical additives could be added as mixed in the mixer or pre-added; Simultaneously, or post-added; the dosage level of cross-linking chemical additives ranged from 0.0001/99.9999 to 60/40 over the total weight of the total weight of all components of claim 3 and/or claim 4 as the base weight to replace the material of claim 3 or/and claim 4 in the recipe calculation.

8. The chemical composition of claim 7, wherein, it is mixed with one of additives optionally selected from antimicrobial agent compounds, and/or anti-fermentation agents, comprising of glutaraldehyde, sodium bicarbonate, fatty amine, or zwitterionic surfactants, benzyl-c12-16-dimethyl ammonium chloride, biocide 2,2-dibromo-3-Nitripronanone (DBNPA), copper oxide, copper sulfate, the dosage level of the anti-microbial agents are ranged from 0/100 to 5.0/95.0 over the claim 3 additives as base weight to partially replace the material of claim 3.

9. The chemical composition of claim 8, wherein, one of solvents is optionally selected from water or polar solvents added into a container first, then, the composition of claim 3 charged into the container following pre-determined weight percentage, the blended components from lubricant with hydro dual nano/macro dot domain materials of soy protein isolate are stirred and heated to 140° F. or above, alternatively, cross-linking agents of claim 6 or/and antimicrobial agents of claim 7 are added into the mixed components of mineral oil.

10. The chemical composition of claim 9, wherein, the hydrogel polymer of claim 4 and surface emulsifiers of claim 5 are added into the mixed components of claim 8, one of addition methods, optionally selected from either in a sequence or simultaneously after all of components are blended uniformly at a solution temperature of above 140° F. or so.

11. The chemical composition of claim 10, wherein, at least one of solvents is optionally blended with either water or polar solvents added to adjust the viscosity of the mixed components into a hydrated viscosity within a range from 1.0 (cps) to 50,000 (cps), preferred less than 100.0 (cps), more preferred less than 20.0 (cps) by mixing the water or [other] polar solvent with the [other] key ingredients in a ratio from 1.0% to 30.0% over the solvent, more preferred less than 15.0%.

12. The chemical composition of claim 11, wherein, at least one of the key ingredients is optionally selected from nonpolar solvents ranged by weight percentage from 95% or less and the solid content of the mixed components is within a range by weight percentage from 0.05% to 60.0%.

13. The chemical composition of claim 12, wherein, it is diluted into at least one of solutions optionally selected from a dispersive or self-healing agent over water used for cement or cement slurry or blending, where the hydro-dual phobic domains or dot spheres are encapsulated with surfactants, dispersed, or uniformly suspended into the water diluted solution within a range of claim 12 of the cementing water from 0.0001(%) to 95(%) by solid content.

14. The chemical composition of claim 13, wherein, it is added into a container, then, cement or Portland cement materials plus cementitious materials are blended into a mixed component within a range of ratio of claim 12 chemicals to cement+cementitious materials plus sand and plus aggregate by weight percentage from 0.0001% to 5.0%.

15. The chemical composition of claim 14, wherein, fine sand or large particle materials can be optionally selected from sprayed or blended with diluted chemical additives or solution of claim 12 to coat the sand or aggregate surface partially or totally. The dosage level applied to the sand or/and aggregate surface is within a range from 0.05% to 10.0% to reduce or eliminate the microcrystal silica dust concentration in the construction working environment by more than 99.0%.

16. The chemical composition of claim 15, and/or optionally selected from its combination with claims 13, 14, wherein a blend of the above components ranged by percentage of volume fraction in a range from:
a) Cement: 5% to 95%
b) Fine sand particles: 5 to 90%
c) Large sand or aggregates: 0.0001 to 90%
d) Reinforced elements such as glass fibers, steel bar, steel whiskers: less than 5.0%.

17. The chemical composition of claim 16, wherein, its cement or Portland lime cement can be [partially] replaced by at least one of cementitious materials optionally selected from fly ash, micro-silica, silica gel, hydrated clays, micro-granular geo-polymer particles, magnesium oxide, lithium oxide, calcium bicarbonate, calcium oxide, and calcium carbonite for controlling the hydraulic-cement concrete properties, the dosage level ranged from 0.0001(%) to 75(%) by weight percentage of the total weight of claim 16.

18. The chemical composition of claim 17, wherein, the ratio of added water to cement in claim 16 is ranged from 0.20 to 0.80 by weight percentage.

19. The chemical composition of claim 18, wherein, the ratio of the total chemical composition of claim 12 over the weight percentage of cement, sand, and aggregate ranged from 0.0001/99.9999 to 5.0/95.

20. The chemical composition of the blends of claim 19, wherein, the manufactured hydraulic-cement concrete products made of the blends have its early age compressive strength higher than 2500 (PSI) within 24 hours.

21. The chemical composition of claim 20, wherein, the ultimate compressive strength of the manufactured hydraulic-cement concrete for its life span service is higher than 6000 (PSI).

22. The chemical composition of claim 21, wherein, the blended products have thermal transition temperature of from 10° F. to 200° F. that promotes the hydration and early age compressive strength and Brazilian splitting tensile strength.

23. The chemical composition of claim 22, wherein, the blended products after fully cured has a preferred surface whiteness L* value larger than 82, defined by CIELAB measurement standard per LEED energy saving application.

24. The chemical composition of claim 22, wherein, the products prepared from the claim 20 functionalized as self-healing concrete product having a self-healing efficiency more than 80% defined by water permeability and Brazilian splitting tensile strength measured by comparison of pre-cracking testing samples via their virgin products.

25. The chemical composition of claim 24, wherein, the products prepared functionalized as self-healing concrete have 9 times more toughness than its virgin products without added chemical additives of claim 12, reducing the brittleness of the products with enhancing viscoelasticity and viscous plasticity, its relative toughness is ranged from 5 to 100 times of the virgin concrete products.

26. The chemical composition of claim 25, wherein, the products prepared from claim 20 functionalized as hydro dual phobic domains having a modulus of resilience more than 5 times than its virgin original products, preferred more than 9.0 times more.

27. The hydraulic-cement product of claim 26, wherein, it is useful as a self-healing admixture for making concrete structural members for residential, commercial, and high rising building and industrial market, also as cement mortar, and masonry cement additives and solution.

28. The chemical composition of claim 12, wherein, the dried coating on the glass sliding substrate has a dynamic pinning and depinning contact angle of larger than 30 (degree) without rolling down the tiled flatten surface as a hydrophilic coating, a static contact angle between 30 (degree) and 90 (degree) as hydrophobic/hydrophilic coatings, measured by a water microdroplet having a weight of from 0.1 (mg) to 500 (mg).
